(19) United States
(12) Patent Application Publication
(10) Pub. No.: US 2025/0251481 A1
(43) Pub. Date: Aug. 7, 2025

(54) CONFIGURATION FOR POSITIONING MODEL INPUT MEASUREMENTS

(71) Applicant: QUALCOMM Incorporated, San Diego, CA (US)

(72) Inventors: Mohammed Ali Mohammed HIRZALLAH, San Marcos, CA (US); Xiaoxia ZHANG, San Diego, CA (US); Srinivas YERRAMALLI, San Diego, CA (US)

(21) Appl. No.: 18/430,391

(22) Filed: Feb. 1, 2024

(51) Int. Cl. G01S 5/00; G01S 5/02

(52) U.S. Cl. CPC G01S 5/0072; G01S 5/0236; G01S 5/02526

(57) ABSTRACT

A wireless positioning device, such as a user equipment (UE) or a transmission reception point (TRP), may receive a measurement configuration. The wireless positioning device may receive a set of positioning signals. The wireless positioning device may measure the set of positioning signals. The wireless positioning device may reference the measured set of positioning signals based on the measurement configuration. The wireless positioning device may output the referenced measured set of positioning signals to a positioning model. The wireless positioning device may output the referenced measured set of positioning signals to a positioning model by transmitting the referenced measured set of positioning signals to a wireless device including the positioning model, by training the positioning model based on the referenced measured set of positioning signals and a set of labels, or by calculating a positioning output using the positioning model based on the referenced measured set of positioning signals.

### TECHNICAL FIELD

The present disclosure relates generally to communication systems, and more particularly, to a wireless positioning system.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may include a wireless positioning device. The apparatus may include a user equipment (UE), a base station, or a transmission reception point (TRP). The apparatus may receive a measurement configuration. The apparatus may receive a set of positioning signals (e.g., a set of positioning reference signals (PRSs) or a set of sounding reference signals (SRSs). The apparatus may measure the set of positioning signals. The apparatus may reference the measured set of positioning signals based on the measurement configuration. The apparatus may reference the measured set of positioning signals based on a common reference point of one of the measured set of positioning signals, for example a timing reference point, a magnitude/power reference point, and/or a phase reference point. The apparatus may output the referenced measured set of positioning signals to a positioning model. The apparatus may output the referenced measured set of positioning signals to a positioning model by transmitting the referenced measured set of positioning signals to a wireless device including the positioning model, by training the positioning model based on the referenced measured set of positioning signals and a set of labels, or by calculating a positioning output using the positioning model based on the referenced measured set of positioning signals.

In an aspect of the disclosure, a method, a computer-readable medium, and an apparatus are provided. The apparatus may include a location management function (LMF), a set of location servers, or a core network. The apparatus may configure a measurement configuration for a set of positioning signals and a set of positioning models at a wireless positioning device. The apparatus may transmit the measurement configuration. The apparatus may receive a calculated position of a wireless device, or an intermediary measurement that may be used to calculate a position of the wireless device, based on measurements of the set of positioning signals that are referenced based on the measurement configuration. The apparatus may receive a set of positioning signal measurements that are referenced based on the measurement configuration.

In some aspects, the techniques described herein relate to a method of wireless communication at a wireless positioning device, including: receiving a measurement configuration; receiving a set of positioning signals; measuring the set of positioning signals; referencing the measured set of positioning signals based on the measurement configuration; and outputting the referenced measured set of positioning signals to a positioning model.

In some aspects, the techniques described herein relate to a method, where outputting the referenced measured set of positioning signals to the positioning model includes: transmitting the referenced measured set of positioning signals to a wireless device including the positioning model.

In some aspects, the techniques described herein relate to a method, further including: selecting a referencing method from a plurality of referencing methods based on the measured set of positioning signals, where the measurement configuration includes an indicator of the plurality of referencing methods; and transmitting a referencing indicator associated with the selected referencing method.

In some aspects, the techniques described herein relate to a method, where the referencing indicator includes at least one of: a method identifier (ID) associated with the selected referencing method; a condition range ID associated with the selected referencing method; an adaptation decision ID associated with the selected referencing method; a positioning model ID associated with the selected referencing method; or a positioning model input layer ID associated with the selected referencing method.

In some aspects, the techniques described herein relate to a method, where outputting the referenced measured set of positioning signals to the positioning model includes at least one of: training the positioning model based on the referenced measured set of positioning signals and a set of labels; or calculating a positioning output using the positioning model based on the referenced measured set of positioning signals.

In some aspects, the techniques described herein relate to a method, where the measurement configuration includes a referencing indicator, further including: selecting the positioning model from a plurality of positioning models based on the referencing indicator.

In some aspects, the techniques described herein relate to a method, where the measurement configuration includes a referencing indicator, further including: selecting at least one of (a) a condition range from a plurality of condition ranges for a reference point positioning signal of the measured set of positioning signals or (b) an adaptation decision from a plurality of adaptation decisions for the reference point positioning signal of the measured set of positioning signals based on the referencing indicator, where referencing the measured set of positioning signals based on the measurement configuration includes: referencing the measured set of positioning signals based on at least one of the selected condition range or the selected adaptation decision.

In some aspects, the techniques described herein relate to a method, further including: transmitting the calculated positioning output.

In some aspects, the techniques described herein relate to a method, where referencing the measured set of positioning signals based on the measurement configuration includes: selecting a reference point positioning signal from the measured set of positioning signals based on the measurement configuration; and referencing the measured set of positioning signals based on the selected reference point positioning signal.

In some aspects, the techniques described herein relate to a method, where selecting the reference point positioning signal from the measured set of positioning signals based on the measurement configuration includes at least one of: selecting the reference point positioning signal from the measured set of positioning signals in response to the reference point positioning signal satisfying a condition range; or selecting the reference point positioning signal from the measured set of positioning signals in response to the reference point positioning signal satisfying an adaptation decision.

In some aspects, the techniques described herein relate to a method, where the condition range includes at least one of: a first range of line-of-sight (LOS) probabilities, where the measurement configuration includes a first indicator to select the first range of LOS probabilities; a second range of delay spread values, where the measurement configuration includes a second indicator to select the second range of delay spread values; a third range of signal-to-interference plus noise ratios (SINRs), where the measurement configuration includes a third indicator to select the third range of SINRs; a fourth range of reference signal received powers (RSRPs), where the measurement configuration includes a fourth indicator to select the fourth range of RSRPs; or a fifth range of path timing measurements, where the measurement configuration includes a fifth indicator to select the fifth range of path timing measurements.

In some aspects, the techniques described herein relate to a method, where the adaptation decision includes at least one of: a largest line-of-sight (LOS) probability, where the measurement configuration includes a first indicator to select the largest LOS probability; a smallest delay spread, where the measurement configuration includes a second indicator to select the smallest delay spread; a smallest peak width, where the measurement configuration includes a third indicator to select the smallest peak width; a largest calculated signal-to-interference plus noise ratio (SINR), where the measurement configuration includes a fourth indicator to select the largest SINR; a largest reference signal received power (RSRP), where the measurement configuration includes a fifth indicator to select the largest RSRP; an earliest arrival, where the measurement configuration includes a sixth indicator to select the earliest arrival; a largest power, where the measurement configuration includes a seventh indicator to select the largest power; or a largest magnitude, where the measurement configuration includes an eighth indicator to select the largest magnitude.

In some aspects, the techniques described herein relate to a method, where selecting the reference point positioning signal from the measured set of positioning signals based on the measurement configuration further includes: selecting the adaptation decision from a plurality of adaptation decisions in response to the reference point positioning signal satisfying the condition range, where the measurement configuration includes an indicator of the plurality of adaptation decisions.

In some aspects, the techniques described herein relate to a method, further including: transmitting an indicator of supported referencing attributes, where the measurement configuration is based on the supported referencing attributes.

In some aspects, the techniques described herein relate to a method, where the supported referencing attributes include at least one of a timing reference type, a power referencing type, or a phase referencing type.

In some aspects, the techniques described herein relate to a method, where the measurement configuration includes a plurality of sets of referencing attributes, where referencing the measured set of positioning signals based on the measurement configuration includes: selecting a set of referencing attributes from the plurality of sets of referencing attributes; and referencing the measured set of positioning signals based on the selected set of referencing attributes.

In some aspects, the techniques described herein relate to a method, where the set of positioning signals includes a set of positioning reference signals (PRSs) or a set of sounding reference signals (SRSs).

In some aspects, the techniques described herein relate to a method, where the wireless positioning device includes at least one of a user equipment (UE), a base station, or a transmission reception point (TRP).

In some aspects, the techniques described herein relate to a method of wireless communication at a network entity, including: configuring a measurement configuration for a set of positioning signals and a set of positioning models at a wireless positioning device; and transmitting the measurement configuration.

In some aspects, the techniques described herein relate to a method, further including: receiving a set of positioning signal measurements referenced based on the measurement configuration.

In some aspects, the techniques described herein relate to a method, further including: receiving a referencing indicator associated with the set of positioning signal measurements; and calculating a positioning output using a positioning model based on the received set of positioning signal measurements and the referencing indicator, where the set of positioning models includes the positioning model.

In some aspects, the techniques described herein relate to a method, where the referencing indicator includes at least one of: a method identifier (ID) associated with the set of positioning signal measurements; a condition range ID associated with the set of positioning signal measurements; an adaptation decision ID associated with the set of positioning signal measurements; a positioning model ID associated with the set of positioning signal measurements; or a positioning model input layer ID associated with the set of positioning signal measurements.

In some aspects, the techniques described herein relate to a method, where the measurement configuration includes a referencing indicator of a plurality of referencing methods associated with the set of positioning signals and the set of positioning models.

In some aspects, the techniques described herein relate to a method, where the referencing indicator includes at least one of: a method identifier (ID); a condition range ID; an adaptation decision ID; a positioning model ID; or a positioning model input layer ID.

In some aspects, the techniques described herein relate to a method, where the measurement configuration includes a referencing indicator, where the referencing indicator includes at least one of: a method identifier (ID); a condition range ID; an adaptation decision ID; a positioning model ID; or a positioning model input layer ID.

In some aspects, the techniques described herein relate to a method, where the measurement configuration includes at least one of: a first indicator to select a first range of line-of-sight (LOS) probabilities; a second indicator to select a second range of delay spread values; a third indicator to select a third range of signal-to-interference plus noise ratios (SINRs); a fourth indicator to select a fourth range of reference signal received powers (RSRPs); a fifth indicator to select a fifth range of path timing measurements; a sixth indicator to select a largest LOS probability; a seventh indicator to select a smallest delay spread; an eighth indicator to select a smallest peak width; a ninth indicator to select a largest SINR; a tenth indicator to select a largest RSRP; an eleventh indicator to select an earliest arrival; a twelfth indicator to select a largest power; or a thirteenth indicator to select a largest magnitude.

In some aspects, the techniques described herein relate to a method, further including: receiving an indicator of supported referencing attributes, where configuring the measurement configuration for the set of positioning signals and the set of positioning models at the wireless positioning device includes: selecting a set of referencing attributes from the supported referencing attributes; and configuring the measurement configuration based on the selected set of referencing attributes.

In some aspects, the techniques described herein relate to a method, where the supported referencing attributes include at least one of a timing reference type, a power referencing type, or a phase referencing type.

In some aspects, the techniques described herein relate to a method, where the set of positioning signals includes a set of positioning reference signals (PRSs) or a set of sounding reference signals (SRSs).

In some aspects, the techniques described herein relate to a method, where the network entity includes a location management function (LMF).

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of positioning based on positioning signal measurements.

FIG. 5 is a diagram illustrating an example of positioning based on positioning signal measurements.

FIG. 6 is a diagram illustrating an example of measurements of positioning signals received at a wireless device.

FIG. 7A is a diagram illustrating an example of a set of positioning models, where each of the set of positioning models is configured to accept inputs for a particular referencing method to calculate a set of positioning outputs.

FIG. 7B is a diagram illustrating an example of a positioning model configured to accept inputs and a referencing method identifier (ID) to calculate a set of positioning outputs.

FIG. 7C is a diagram illustrating an example of a positioning model and a set of input layers, where each of the set of input layers is configured to accept inputs for a particular referencing method to calculate a set of positioning outputs.

FIG. 7D is a diagram illustrating an example of a positioning model configured to accept inputs for any of a set of referencing methods to calculate a set of positioning outputs.

FIG. 8 is a connection flow diagram illustrating an example of wireless devices configured to dynamically reference positioning signal measurements for positioning models based on measurement configurations.

FIG. 9 is a connection flow diagram illustrating an example of wireless devices configured to dynamically reference positioning signal measurements for positioning models based on measurement configurations.

FIG. 10 is a connection flow diagram illustrating an example of wireless devices configured to dynamically reference positioning signal measurements for positioning models based on measurement configurations.

FIG. 11 is a connection flow diagram illustrating an example of wireless devices configured to dynamically reference positioning signal measurements for positioning models based on measurement configurations.

FIG. 12 is a connection flow diagram illustrating an example of wireless devices configured to dynamically reference positioning signal measurements for positioning models based on measurement configurations.

FIG. 13 is a connection flow diagram illustrating an example of wireless devices configured to dynamically reference positioning signal measurements for positioning models based on measurement configurations.

FIG. 14 is a connection flow diagram illustrating an example of wireless devices configured to dynamically reference positioning signal measurements for positioning models based on measurement configurations.

FIG. 15 is a connection flow diagram illustrating an example of wireless devices configured to dynamically reference positioning signal measurements for positioning models based on measurement configurations.

FIG. 16 is a flowchart of a method of wireless communication.

FIG. 17 is a flowchart of a method of wireless communication.

FIG. 18 is a flowchart of a method of wireless communication.

FIG. 19 is a flowchart of a method of wireless communication.

FIG. 20 is a flowchart of a method of wireless communication.

FIG. 21 is a flowchart of a method of wireless communication.

FIG. 22 is a diagram illustrating an example of a hardware implementation for an example apparatus and/or network entity.

FIG. 23 is a diagram illustrating an example of a hardware implementation for an example network entity.

FIG. 24 is a diagram illustrating an example of a hardware implementation for an example network entity.

### DETAILED DESCRIPTION

The following description is directed to examples for the purposes of describing innovative aspects of this disclosure. However, a person having ordinary skill in the art may recognize that the teachings herein may be applied in a multitude of ways. Some or all of the described examples may be implemented in any device, system or network that is capable of transmitting and receiving radio frequency (RF) signals according to one or more of the Institute of Electrical and Electronics Engineers (IEEE) 2002.11 standards, the IEEE 2002.15 standards, the Bluetooth® standards as defined by the Bluetooth Special Interest Group (SIG), or the Long Term Evolution (LTE), 3G, 4G or 5G (New Radio (NR)) standards promulgated by the 3rd Generation Partnership Project (3GPP), among others. The described examples may be implemented in any device, system or network that is capable of transmitting and receiving RF signals according to one or more of the following technologies or techniques: code division multiple access (CDMA), time division multiple access (TDMA), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO. The described examples also may be implemented using other wireless communication protocols or RF signals suitable for use in one or more of a wireless personal area network (WPAN), a wireless local area network (WLAN), a wireless wide area network (WWAN), a wireless metropolitan area network (WMAN), or an internet of things (IoT) network.

Various aspects relate generally to wireless positioning devices. Some aspects more specifically relate to wireless positioning devices configured to dynamically reference measurements of positioning signals based on a measurement configuration. In some examples, a wireless positioning device, such as a user equipment (UE), a base station, or a transmission reception point (TRP) may receive a measurement configuration. The wireless positioning device may receive a set of positioning signals (e.g., a set of positioning reference signals (PRSs) or a set of sounding reference signals (SRSs). The wireless positioning device may measure the set of positioning signals. The wireless positioning device may reference the measured set of positioning signals based on the measurement configuration. The wireless positioning device may output the referenced measured set of positioning signals to a positioning model. The wireless positioning device may output the referenced measured set of positioning signals to a positioning model by transmitting the referenced measured set of positioning signals to a wireless device including the positioning model, by training the positioning model based on the referenced measured set of positioning signals and a set of labels, or by calculating a positioning output using the positioning model based on the referenced measured set of positioning signals.

In some examples, a network entity, such as a location management function (LMF), may configure a measurement configuration for a set of positioning signals and a set of positioning models at a wireless positioning device. The network entity may transmit the measurement configuration. The network entity may receive a calculated position of a wireless device, or an intermediary measurement that may be used to calculate a position of the wireless device, based on measurements of the set of positioning signals that are referenced based on the measurement configuration. The network entity may receive a set of positioning signal measurements that are referenced based on the measurement configuration.

Positioning models, such as positioning models that are trained using artificial intelligence machine learning (AI/ML), may improve positioning accuracy in problematic environments, for example environments where wireless positioning devices do not have a direct line-of-sight (LOS) path between the devices, or environments with low signal-to-interference plus noise ratio (SINR) conditions. A positioning model may run on a wireless positioning device, such as a UE or a TRP, or on a network entity, such as an LMF.

For positioning models that run on a network entity, a wireless positioning device that measures positioning signals (e.g., PRSs, SRSs) may report measurements of such positioning signals to the network entity. For example, a wireless positioning device may report a channel impulse response (CIR), a power delay profile (PDP), a delay profile (DP), or a subsampled version of the aforementioned measurements, to the network entity. The network entity may use at least a subset of the received measurements as model inputs to a positioning model at the network entity. Because the measurements may be contaminated by drifts and/or changes that are different in the field than during the time of training the positioning model, the wireless positioning devices may be configured to reference the measurements about a common reference point when reporting the measurement data.

Similarly, for positioning models that run on a wireless positioning device, such as a UE or a TRP, the wireless positioning device that measures positioning signals may be configured to reference such measurements to match the positioning model being used. For example, the measured CIR/PDP/DP, or a subsampled version of the aforementioned measurements, may be contaminated by drifts and/or changes that are different in the field than during the time of training the positioning model. The wireless positioning devices may be configured to reference the measurements about a common reference point when using the measurement data with a corresponding positioning model.

For positioning models on a network entity, measurement inputs from a wireless positioning device to the network entity may be contaminated by clock drifts or other timing errors at the wireless positioning device measuring positioning signals. Such wireless positioning devices may be configured to apply common referencing approaches/methods to such measurements before reporting the measurements to the network entity. In some aspects, a wireless positioning device may receive, from the network entity, a configuration that includes different referencing method options for measurements of positioning signals. The wireless positioning device may measure reference signals (RSs) from different devices that transmit positioning signals (e.g., TRPs, UEs) and may apply one of the configured referencing methods to the measurements. The network entity may select the referencing method, or the wireless positioning device may select a referencing method from a plurality of configurations provided by the network entity. The wireless positioning device may report the applied referencing method to the network entity along with the referenced measurements. In some aspects, the referencing method may use one or more of a reference TRP, a reference signal, a reference timing point, a reference power, a reference magnitude point, and/or a reference phase point. Referencing may be applied to a single antenna level, a single TRP level, to multiple TRP levels, and/or to multiple antenna levels.

Particular aspects of the subject matter described in this disclosure can be implemented to realize one or more of the following potential advantages. In some examples, by configuring wireless positioning devices to reference measurements when using measurement data with a corresponding positioning model, the described techniques can be used to dynamically correct drifts and/or changes that are different in the field than during the time of training a positioning model.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer. While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

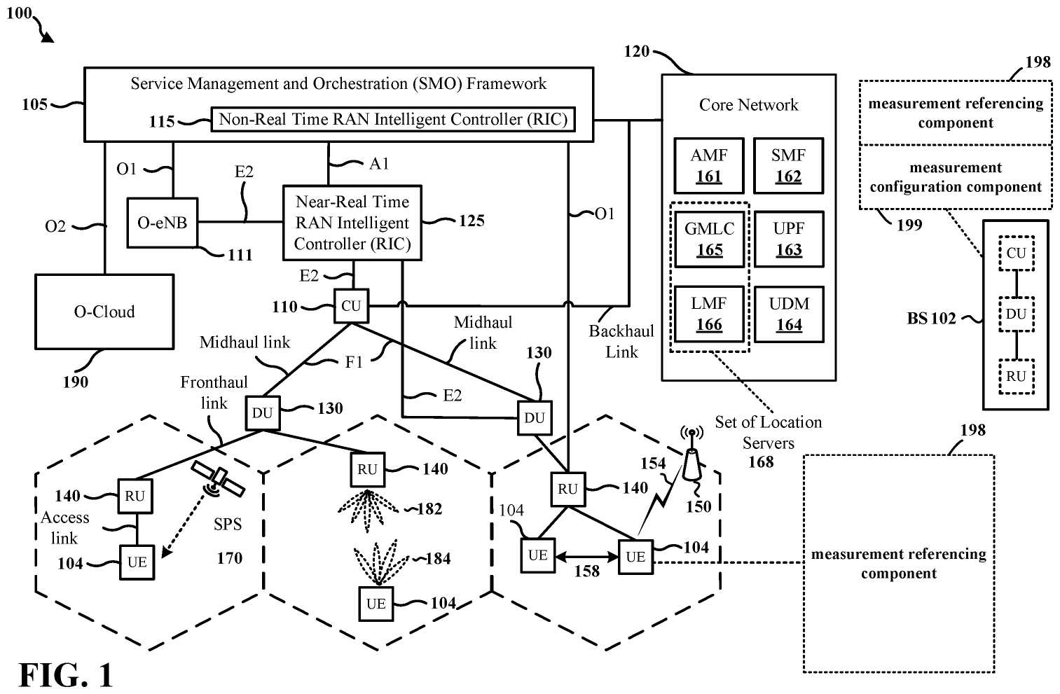

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 2002.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 and/or the base station 102 may have a measurement referencing component 198 that may be configured to receive a measurement configuration. The measurement referencing component 198 may be configured to receive a set of positioning signals (e.g., PRSs, SRSs). The measurement referencing component 198 may be configured to measure the set of positioning signals. The measurement referencing component 198 may be configured to reference the measured set of positioning signals based on the measurement configuration. The measurement referencing component 198 may be configured to output the referenced measured set of positioning signals to a positioning model. The measurement referencing component 198 may be configured to output the referenced measured set of positioning signals to a positioning model by transmitting the referenced measured set of positioning signals to a wireless device including the positioning model, by training the positioning model based on the referenced measured set of positioning signals and a set of labels, or by calculating a positioning output using the positioning model based on the referenced measured set of positioning signals. In certain aspects, the base station 102, the core network 120, the LMF 166, or the one or more location servers 168, may have a measurement configuration component 199 that may be configured to configure a measurement configuration for a set of positioning signals and a set of positioning models at a wireless positioning device. The measurement configuration component 199 may be configured to transmit the measurement configuration. The measurement configuration component 199 may be configured to receive a calculated position of a wireless device, or an intermediary measurement that may be used to calculate a position of the wireless device, based on measurements of the set of positioning signals that are referenced based on the measurement configuration. The measurement configuration component 199 may be configured to receive a set of positioning signal measurements that are referenced based on the measurement configuration.

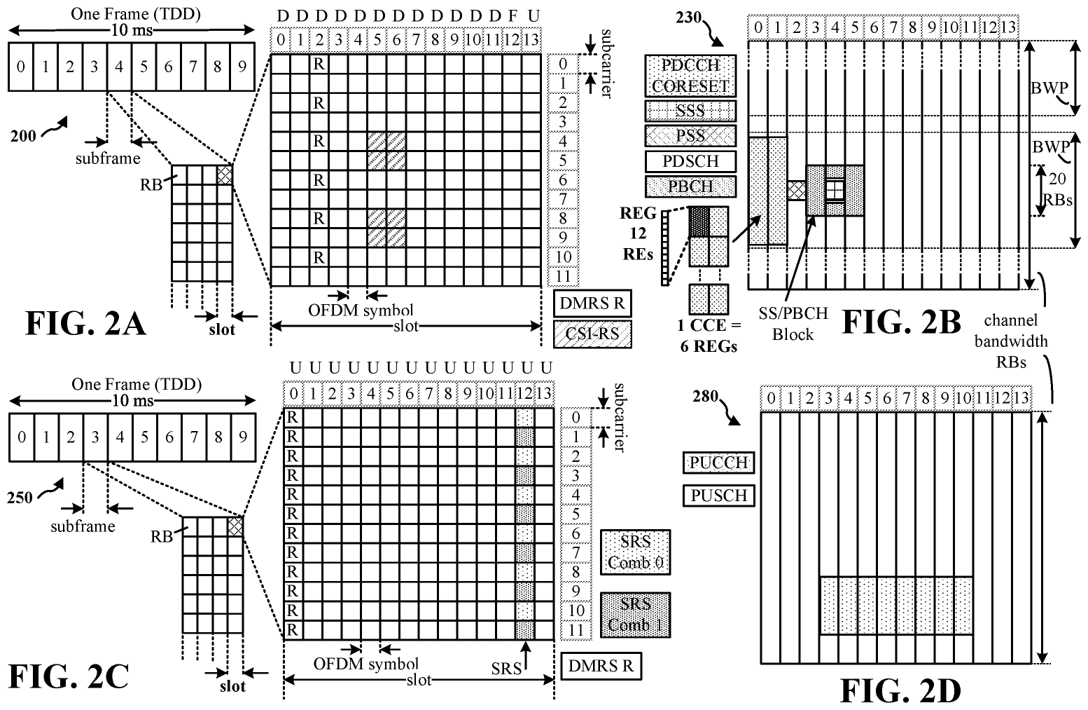

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 24 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

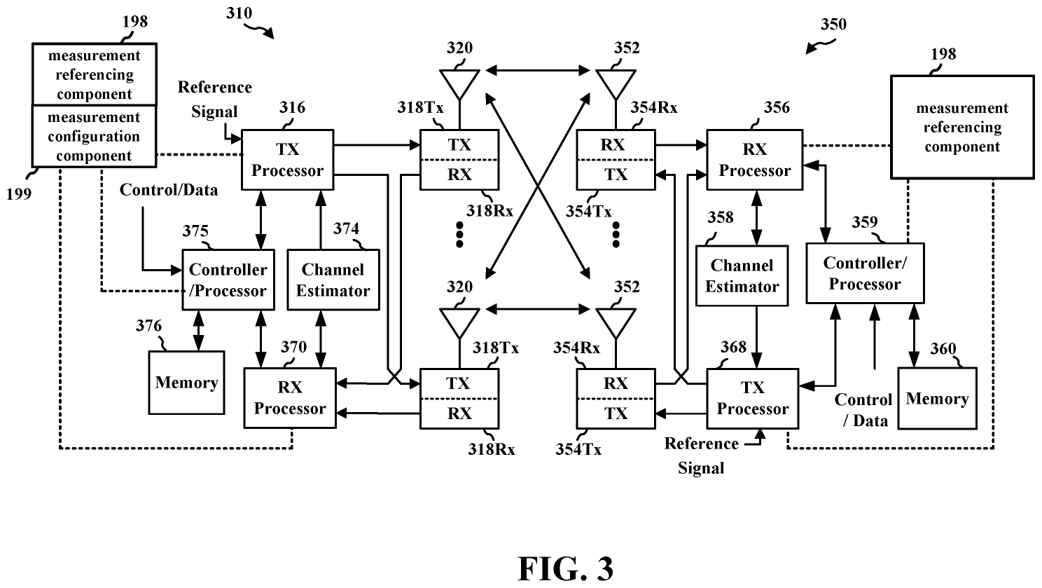

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the measurement referencing component 198 of FIG. 1.

At least one of the TX processor 316, the RX processor 370, and the controller/processor 375 may be configured to perform aspects in connection with the measurement referencing component 198 of FIG. 1.

At least one of the TX processor 316, the RX processor 370, and the controller/processor 375 may be configured to perform aspects in connection with the measurement configuration component 199 of FIG. 1.

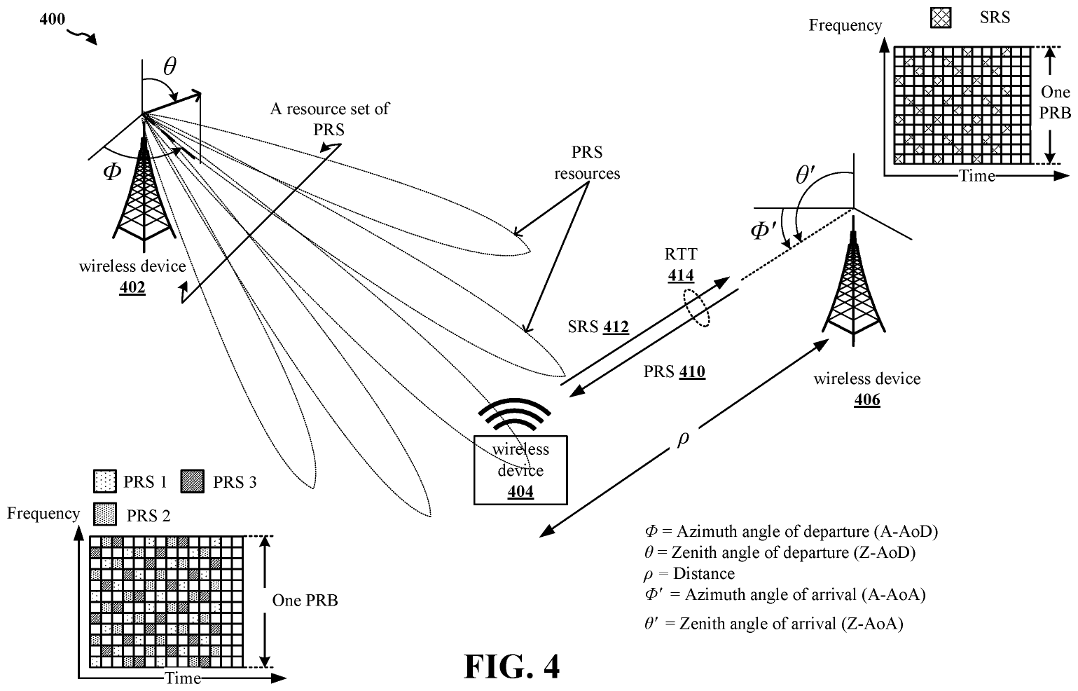

FIG. 4 is a diagram 400 illustrating an example of a positioning based on positioning signal measurements. A positioning signal may be any reference signal which may be measured to calculate a position attribute or a location attribute of a wireless device, for example a positioning reference signal (PRS), a sounding reference signal (SRS), a channel state information (CSI) reference signal (CSI-RS), or a synchronization and signal block (SSB). The wireless device 402 may be a base station, such as a TRP, or a UE with a known position/location, such as a positioning reference unit (PRU) or a UE with a high-accuracy sensor that may identify the location of the UE, for example a GNSS sensor or a GPS sensor. The wireless device 406 may be a base station or a UE with a known position/location. The wireless device 404 may be a UE or a TRP configured to perform positioning to gather data, for example to gather data to train an artificial intelligence machine learning (AI/ML or AIML) model, test positioning signal strength or test positioning noise attributes in an area. The wireless device 404 may transmit UL-SRS 412 at time TsRS_TX and receive DL positioning reference signals (PRS) (DL-PRS) 410 at time TPRS_RX. The wireless device 406 may receive the UL-SRS 412 at time TSRS RX and transmit the DL-PRS 410 at time TPRS_TX. The wireless device 404 may receive the DL-PRS 410 before transmitting the UL-SRS 412, or may transmit the UL-SRS 412 before receiving the DL-PRS 410. In both cases, a positioning server (e.g., location server(s) 168, LMF 166) or the wireless device 404 may determine the RTT 414 based on ∥T_{SRS_RX}−T_{PRS_TX}|−|T_{SRS_TX}−T_{PRS_RX}∥. Accordingly, multi-RTT positioning may make use of the UE Rx-Tx time difference measurements (i.e., |T_{SRS_TX}−T_{PRS_RX}|) and DL-PRS reference signal received power (RSRP) (DL-PRS-RSRP) of downlink signals received from multiple wireless devices 402, 406 and measured by the wireless device 404, and the measured TRP Rx-Tx time difference measurements (i.e., |T_{SRS_RX}−T_{PRS_TX}|) and UL-SRS-RSRP at multiple wireless devices 402, 406 of uplink signals transmitted from wireless device 404. The wireless device 404 may measure the UE Rx-Tx time difference measurements (and optionally DL-PRS-RSRP of the received signals) using assistance data received from the positioning server, and the wireless devices 402, 406 may measure the gNB Rx-Tx time difference measurements (and optionally UL-SRS-RSRP of the received signals) using assistance data received from the positioning server. The measurements may be used at the positioning server or the wireless device 404 to determine the RTT. The RTT may be used to estimate the location of the wireless device 404. Other methods are possible for determining the RTT, such as for example using DL-TDOA and/or UL-TDOA measurements.

DL-AoD positioning may make use of the measured DL-PRS-RSRP of downlink signals received from multiple wireless devices 402, 406 at the wireless device 404. The wireless device 404 may measure the DL-PRS-RSRP of the received signals using assistance data received from the positioning server, and the resulting measurements may be used along with the azimuth angle of departure (A-AoD), the zenith angle of departure (Z-AoD), and/or other configuration information to locate the wireless device 404 in relation to the neighboring wireless devices 402, 406.

DL-TDOA positioning may make use of the DL reference signal time difference (RSTD) (and optionally DL-PRS-RSRP) of downlink signals received from multiple wireless devices 402, 406 at the wireless device 404. The wireless device 404 may measure the DL RSTD (and optionally DL-PRS-RSRP) of the received signals using assistance data received from the positioning server, and the resulting measurements may be used along with other configuration information to locate a position/location the wireless device 404 in relation to the neighboring wireless devices 402, 406.

UL-TDOA positioning may make use of the UL relative time of arrival (RTOA) (and optionally UL-SRS-RSRP) at multiple wireless devices 402, 406 of uplink signals transmitted from wireless device 404. The wireless devices 402, 406 may measure the UL-RTOA (and optionally UL-SRS-RSRP) of the received signals using assistance data received from the positioning server, and the resulting measurements may be used along with other configuration information to estimate the location of the wireless device 404.

UL-AoA positioning may make use of the measured azimuth angle of arrival (A-AoA) and zenith angle of arrival (Z-AoA) at multiple wireless devices 402, 406 of uplink signals transmitted from the wireless device 404. The wireless devices 402, 406 may measure the A-AoA and the Z-AoA of the received signals using assistance data received from the positioning server, and the resulting measurements may be used along with other configuration information to estimate the location of the wireless device 404.

Additional positioning methods may be used for estimating the location of the wireless device 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

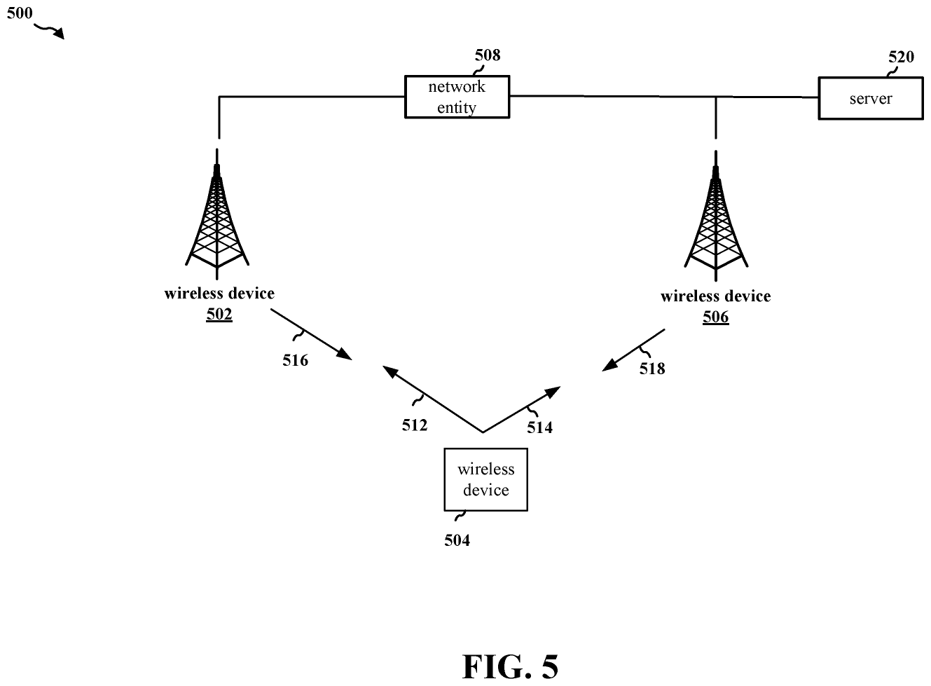

FIG. 5 is a diagram 500 illustrating a network entity 508 that may be configured to coordinate a wireless device 502 and a wireless device 506 to perform positioning with a wireless device 504. The location of the wireless device 502 and the wireless device 506 may be known to at least one of the devices, such as the wireless device 502, the wireless device 504, the wireless device 506, the network entity 508, and/or the server 520. The wireless device 502 may be a base station, a gNB, or a TRP. The wireless device 506 may be a base station, a gNB, or a TRP. The wireless device 504 may be a UE. In some aspects, the UE may be a PRU. A PRU may be a UE with a known location. For example, the PRU may be affixed in a known location or may be placed in a known location for a period of time, or the PRU may have a set of sensors (e.g., high-accuracy GNSS sensor) that may be used to accurately calculate the location of the PRU. In some aspects, the wireless device 504 may be a PRU configured to train a positioning model based on a set of inputs and a set of labels. In some aspects, the wireless device 504 may be a UE configured to use a positioning model to calculate a set of outputs based on a set of inputs, for example measurements of positioning signals. The network entity 508 may be connected to the wireless device 502 and the wireless device 506 via a physical link, for example a backhaul link or a midhaul link, or via a wireless link, such as an air interface (a UE-UTRAN (Uu)) link. The network entity 508 may be part of a core network, such as an LMF or a set of location servers. The network entity 508 may configure positioning occasions between the wireless device 502, the wireless device 504, and the wireless device 506. The server 520 may be an over-the-top (OTT) server or some other server functionally connected to a network that communicates with the network entity 508, the wireless device 502 and/or the wireless device 506, and/or with the wireless device 504 via a wireless device, such as the wireless device 502 and/or the wireless device 506. The server 520 may have storage for storing positioning models, for example AI/ML positioning models, trained using sets of positioning signals received by a wireless device, such as the wireless device 502, the wireless device 504, and/or the wireless device 506.

To perform positioning, the network entity 508 may configure one or more of the wireless devices to transmit positioning signals at one another. For example, the wireless device 504 may transmit the set of positioning signals 512 at the wireless device 502. The set of positioning signals 512 may be a set of SRSs, SSBs, or CSI-RSs. The wireless device 502 may measure the set of positioning signals 512. The wireless device 502 may transmit the set of positioning signals 516 at the wireless device 504. The set of positioning signals 516 may be a set of PRSs, SSBs, or CSI-RSs. The wireless device 504 may measure the set of positioning signals 516. The wireless device 504 may transmit a set of positioning signals 514 at the wireless device 506. The set of positioning signals 514 may be a set of SRSs, SSBs, or CSI-RSs. The wireless device 506 may measure the set of positioning signals 514. The wireless device 506 may transmit a set of positioning signals 518 at the wireless device 504. The set of positioning signals 518 may be a set of PRSs, SSBs, or CSI-RSs. The wireless device 504 may measure the set of positioning signals 518. One or more of the wireless devices may measure the received positioning signals to calculate a positioning measurement that may be used to calculate a position/location of the wireless device 504, or may be used to calculate a position/location of the wireless device 504. For example, if the location of the wireless device 502 and the location of the wireless device 506 are known, the location of the wireless device 504 may be calculated based on a RTT between the wireless device 502 and the wireless device 504, and a RTT between the wireless device 504 and the wireless device 506. In another example, the wireless device 504 may calculate an angle of arrival (AoA) or an angle of departure (AoD) of the set of positioning signals 516, and may calculate an AoA or an AoD of the set of positioning signals 518. The calculated AoAs and/or AoDs may be used to calculate a position of the wireless device 504 if the location of the wireless device 502 and the location of the wireless device 506 are also known. Other measurements, such as RTOA, line-of-sight (LOS) identification (identifying whether there is a direct line-of-sight path between wireless devices), or multi-cell round trip time (multi-RTT) calculations may be performed to calculate the position of the wireless device 504, or to calculate a measurement that may be used to calculate the position of the wireless device 504.

In some aspects, a positioning model may be used to calculate one or more positioning metrics based on the measurements. For example, based on the measurements of the set of positioning signals 512 and/or the set of positioning signals 514 transmitted by the wireless device 504, a position/location of the wireless device 504 may be calculated or estimated, or an intermediate measurement that may be used to calculate the position/location of the wireless device 504 may be calculated or estimated. Such a positioning metric may also be referred to as a positioning output. A positioning model may be trained using artificial intelligence (AI)/machine learning (ML) (AI/ML or AIML), based on a set of inputs (e.g., measurements of positioning signals, assistance information associated with the positioning signals) and a set of labels. A positioning signal may include any reference signal transmitted from a wireless device, such as a PRS, a SRS, an SSB, or a CSI-RS. An RS transmitted from a UE, such as a PRU, may be referred to as an uplink positioning signal, or an UL positioning signal. An RS transmitted from a base station, or TRP, may be referred to as a downlink positioning signal, or a DL positioning signal. A measurement may be a channel delay profile (DP), a channel power delay profile (PDP), a channel impulse response (CIR), a channel frequency response (CFR), or other measurement used for performing positioning on a target wireless device. A label may be a calculated, derived, or given (i.e., known) expected result associated with a set of inputs, such as a position/location of a wireless device 504 or an intermediate measurement (e.g., a timing measurement, an angle measurement, a LOS identification) that may be used to calculate the position/location of the wireless device 504. A set of inputs and a set of labels may be used for generating and/or training a positioning model using AI/ML.

When training a positioning model, measurements of positioning signals as inputs, clean or noisy labels (clean labels may have a quality metric greater or equal to a threshold, noisy labels may have a quality metric less than or equal to the threshold) as expected outputs, and training data assistance information as inputs or expected outputs. The positioning model may operate on any wireless device based on a set of inputs. For example, the wireless device 502 may have a positioning model configured to accept a set of positioning measurements and generate an estimate of a position/location of the wireless device 504. In another example, the wireless device 502 may have a positioning model configured to accept a set of positioning measurements and generate an intermediate measurement (e.g., a timing measurement, an angle measurement, a LOS identification) that may be used (by the wireless device 502, or another entity, such as the network entity 508, the wireless device 504, or the wireless device 506) to calculate the position/location of the wireless device 504. In another example, the network entity 508 may have a positioning model configured to accept a set of positioning measurements and generate an estimate of a position/location of the wireless device 504, or generate an intermediate measurement that may be used to calculate the position/location of the wireless device 504. In another example, the wireless device 504 may have a positioning model configured to accept a set of positioning measurements and generate an estimate of a position/location of the wireless device 504, or generate an intermediate measurement that may be used to calculate the position/location of the wireless device 504. In some aspects, the positioning measurements may be aggregated by the entity with the positioning model, for example the network entity 508 may aggregate measurements of the set of positioning signals 512 from the wireless device 502, measurements of the set of positioning signals 514 the wireless device 506 to use as inputs to a positioning model, measurements of the set of positioning signals 516 from the wireless device 504, and/or measurements of the set of positioning signals 518 from the wireless device 504.

A positioning model may be trained on a wireless device that performs positioning, such as the wireless device 502, the wireless device 504, the wireless device 506, the network entity 508, and/or the server 520. The inputs to the positioning model may include measurements of positioning signals, such as measurements of SRS, PRS, SSB, and/or CSI-RS. The inputs to the measurements may include assistance information associated with the measured positioning signals, such as BWP of a positioning signal resource, number of TRPs, beam information, positioning signal configuration). The labels/outputs for the positioning model may include a location, or an intermediate measurement. In one aspect, the server 520 may be an OTT server configured to train and store positioning models. In another aspect, the network entity 508 may be configured to train and store positioning models. In other words, the server 520 or the network entity 508 may be a training entity configured to train positioning models based on input measurements taken by a wireless device, such as the wireless device 502, the wireless device 504, and/or the wireless device 506, and based on labels either known (e.g., stored on memory) or calculated by at least one of the wireless device 502, the wireless device 504, the wireless device 506, and/or the network entity 508. A positioning model may be configured to calculate a set of outputs. The set of outputs may include, for example, position of a wireless device, a reference signal time difference (RSTD), a line of sight (LOS) indicator (e.g., whether there exists a direct line-of-sight path between wireless devices, the likelihood of whether there exists a direct line-of-sight path between wireless devices), a multipath timing indicator (e.g., a time of flight per path, a time of arrival per path with respect to a timing mark), a multipath power indicator (e.g., strength of a signal per path), a multipath phase indicator (e.g., phase of a signal per path), a reference signal received power (RSRP), and/or an angle of departure (AoD).

In some aspects, a positioning model may be configured to use measurements of positioning signals transmitted from a wireless device to calculate a position of the wireless device 504, or to calculate an intermediate measurement that may be used to calculate the position of the wireless device 504. The positioning model may be trained via a training entity, and may be used at the wireless device 502, at the wireless device 504, at the wireless device 506, or at the network entity 508. For example, a positioning model at the wireless device 504 may be configured to calculate the location of the wireless device 504 based on measurements of the set of positioning signals 516 and/or the set of positioning signals 518. In another example, the wireless device 502 may transmit a set of intermediate measurements to the network entity 508 so that the network entity 508 may calculate the location of the wireless device 504 based on the set of intermediate measurements. In another example, the wireless device 504 may transmit measurements of the set of positioning signals 516 and/or the set of positioning signals 518 to the network entity 508. The positioning model may be at the network entity 508. The positioning model at the network entity 508 may calculate the location of the wireless device 504 based on the transmitted measurements of the set of positioning signals 516 and/or the set of positioning signals 518 from the wireless device 504, the transmitted measurements of the set of positioning signals 512 from the wireless device 502, and/or the transmitted measurements of the set of positioning signals 514 from the wireless device 506. In other words, any of the wireless device 502, the wireless device 504, and/or the wireless device 506 may assist the network entity 508 in performing positioning using a trained positioning model.

In some aspects, a positioning model may be site-specific. For example, a first positioning model may be trained in a location, or a set of locations, associated with a first site having a first set of borders, and a second positioning model may be trained in a location, or a set of locations, associated with a second site having a second set of borders. A wireless device may be configured to use one of a plurality of site-specific positioning models. For example, the wireless device may select a site-specific positioning model based on its location, or may select a site-specific positioning model based on an indicator, for example a signal transmitted from the network entity 508 that indicates that a particular site-specific positioning model from a plurality of site-specific positioning models be selected.

Measurements of positioning signals may be performed by measuring channels between a target device (e.g., the wireless device 504) and a set of network nodes (e.g., the wireless device 502 and the wireless device 506). The wireless device 504 may transmit a positioning signal, such as an SRS, an SSB, or a CSI-RS. The wireless device 502 and/or the wireless device 506 may measure the positioning signal for data collection purposes to train a positioning model. The wireless device 504 and/or the wireless device 506 may transmit a positioning signal, such as a PRS, an SSB, or a CSI-RS. The wireless device 504 may measure the positioning signal for data collection purposes to train the positioning model. The wireless device 502, the wireless device 504, and/or the wireless device 506 may measure a positioning signal resource in a plurality of ways, for example the measurement may be a channel impulse response (CIR), a channel frequency response (CFR), a power delay profile (PDP), a delay profile (DP), a set of reflection paths, a reception-transmission (Rx-Tx) time difference, a received signal strength indicator (RSSI), a reference signal received power (RSRP), a reference signal received power per path (RSRPP), a reference signal received quality (RSRQ), a time of arrival (ToA), a reference signal time difference (RSTD), or an angle of departure (AoD).

While the diagram 500 illustrates two positioning neighbor wireless devices, wireless device 502 and wireless device 506, configured to perform positioning with one positioning target wireless device, wireless device 504, to calculate a position/location of the wireless device 504, any number of positioning neighbor wireless devices may be configured to perform positioning with any number of positioning target wireless devices. For example, four positioning neighbor wireless devices may be configured to calculate the position/location of two positioning target wireless devices, three positioning neighbor wireless devices may be configured to calculate the position/location of one positioning target wireless device, or two positioning neighbor wireless devices may be configured to calculate the position/location of one positioning target wireless device.

In some aspects, a wireless device receiving positioning signals during a positioning occasion may measure the positioning signals based on a reference point. For example, when measuring a time of when a positioning signal is received by the wireless device, the wireless device may measure the time based on a reference point of a start of a positioning occasion, or based on when a first positioning signal is received at the wireless device. The reference point may be used as a time=0, where signals received after the reference point may be referred to as positive values from the reference point and signals received before the reference point may be referred to as negative values from the reference point. In another example, when measuring a magnitude of a positioning signal received by the wireless device, the wireless device may measure the magnitude based on an average magnitude received in the past, or based on a minimum magnitude received within a positioning occasion. The reference point may be used as a magnitude/power=0, where signals with a stronger magnitude/power may be referred to as positive values from the reference point and signals with a weaker magnitude/power may be referred to as negative values from the reference point. The wireless device may reference measured positioning signals based on one or more common reference points, for example a timing reference point, a power/magnitude reference point, and/or a phase reference point.

For a positioning model at a network entity (e.g., the network entity 508, the server 520), a wireless device (e.g., the wireless device 502, the wireless device 504, the wireless device 506) may transmit a report of model input measurements of received positioning signals to the network entity. The wireless device may report CIR, PDP, DP, or a subsampled version thereof to the network entity, and the network entity may pass the measurements as a model input to the positioning model. The wireless device may first reference the measured positioning signals based on one or more reference points before transmitting the measurements to the network entity. For a positioning model at a wireless device (e.g., the wireless device 502, the wireless device 504, the wireless device 506), the wireless device may first reference the measured positioning signals based on one or more reference points before inputting the measurements as a model input to the positioning model. The designer of a positioning model may design the positioning model to be referenced using a particular referencing method to maintain accuracy and avoid unknown drifts (e.g., change in Tx power, UE clock drift, mis-synchronization between a UE and a network). Such referencing methods may be used as inputs to train a positioning model, or used as inputs to use a positioning model to calculate a positioning output. Such referencing methods may be specific to an antenna, a wireless device, or a set of wireless devices. In other words, signaling to use such methods may indicate a wireless device to apply such referencing methods to a specific antenna at the wireless device, may indicate a wireless device to apply such referencing methods to all measurements at the wireless device, or may indicate a set of wireless devices to apply such referencing methods to all measurements at the wireless device.

In some aspects, the wireless device may indicate capabilities of supported referencing methods for positioning signal measurements (e.g., CIR, PDP, DP) to the network entity. In some aspects, the wireless device may select a referencing method to use to select a set of referencing points (e.g., timing, magnitude/power, and/or phase), and may indicate the selected referencing method to the network entity. In some aspects, the network entity may select a referencing method for the wireless device to use, and may transmit an indicator of the selected referencing method to the wireless device. In some aspects, the network entity may transmit a set of conditions that should be satisfied for the wireless device to use a particular referencing method. The wireless device may select a referencing method based on whether a measurement, or a set of measurements, satisfies the set of conditions. In other words, the wireless device may adapt a measurement of a positioning signal (e.g., CIR, PDP, DP) based on a set of configured conditions. The wireless device may report the referenced measurements along with a referencing indicator to a network entity with the positioning model, or may use the referenced measurements as an input to a positioning model at the wireless device. The entity with the positioning model may use an indicated referencing method to select a positioning model, may use an indicated referencing method as an input to a positioning model, or may use a plurality of referencing methods to calculate inputs to a positioning model.

The conditions for adapting a referencing method for a measured positioning signal (e.g., a CIR, a PDP, a DP) may include whether the LOS probability of a reference signal (e.g., PRS, SRS, SSB, TRP, UE) is within a range of values (e.g., less than or equal to a threshold, not the top X LOS probabilities among other measurements). A referencing method may identify a referencing signal by a type (e.g., PRS, SRS, SSB), an RS ID (e.g., an ID that indicates a set of positioning signals), or an ID associated with the transmitting device (e.g., an ID that indicates a TRP, a UE, or a PRU). The conditions for adapting a referencing method for a measured positioning signal may include whether the delay spread of a reference signal is within a range of values (e.g., greater than or equal to a threshold, not the smallest X delay spread among other measurements). The conditions for adapting a referencing method for a measured positioning signal may include whether the signal-to-interference-plus-noise ratio (SINR) of a reference signal is within a range of values (e.g., less than or equal to a threshold, not the top X SINR values among other measurements). The conditions for adapting a referencing method for a measured positioning signal may include whether the reference signal received power (RSRP) of a reference signal is within a range of values (e.g., less than or equal to a threshold, not the top X RSRP values among other measurements). The conditions for adapting a referencing method for a measured positioning signal may include whether the timing of a reference signal is within a range of values (e.g., greater than or equal to a threshold). The conditions for adapting a referencing method for a measured positioning signal may include whether the first arrival path of a reference signal is within a range of values (e.g., not the earliest among other reference signals). The conditions for adapting a referencing method for a measured positioning signal may include whether the peak width of a reference signal is within a range of values (e.g., not the smallest among other reference signals).

The wireless entity may adapt a referencing method based on whether a set of measurements satisfies a set of conditions. The wireless entity may switch a reference point to the measured reference signal with the highest probability LOS state in response to a set of conditions being satisfied. The wireless entity may switch a reference point to the measured reference signal with the smallest delay spread in response to a set of conditions being satisfied. The wireless entity may switch a reference point to the measured reference signal with the smallest peak-width in response to a set of conditions being satisfied. The wireless entity may switch a reference point to the measured reference signal with the highest SINR in response to a set of conditions being satisfied. The wireless entity may switch a reference point to the measured reference signal with the highest RSRP in response to a set of conditions being satisfied.

A measurement configuration may indicate a set of conditions with associated referencing adaptation for the wireless entity. Such an indication may include an ID of a referencing method, an ID of an associated condition and referencing adaptation, an indicator of a positioning model to use (e.g., a positioning model ID), and/or an indicator of a positioning model input layer to use. The entity with the positioning model may use the referencing indicator to select a positioning model or relevant input. For example, the entity may switch from one positioning model to another positioning model that is associated with a selected referencing method (e.g., select a positioning model trained using inputs that use the selected referencing method) based on the referencing indicator. In another example, the entity may input an ID of the referencing method, an ID of a condition for the referencing method, an ID for a referencing adaptation for the referencing method, and/or an ID associated with both a condition and a referencing adaptation for the referencing method to the positioning model based on the referencing indicator. In another example, the entity may select a positioning model input layer based on the referencing indicator. In another example, the entity may select a positioning model that accepts measurements from a plurality of referencing methods based on the referencing indicator.

In some aspects, the wireless device (e.g., wireless device 502, wireless device 504, wireless device 506) may indicate to the network entity 508 of its capability to support a set of capabilities and a set of adaptation decisions. In some aspects, such a capability may be transmitted via a long-term evolution (LTE) positioning protocol (LPP) message (e.g., an LPP capability message for a UE) or a new radio (NR) positioning protocol (NRPP) message (e.g., an NRPP annex (NRPPa) TRP information message for a base station). The capability may be transmitted as part of a UE capability exchange procedure (for a UE or a PRU), or as part of a TRP information exchange procedure (for a TRP or a base station).

In some aspects, the network entity 508 may transmit a measurement configuration that indicates candidate conditions and/or decisions. In some aspects, such a measurement configuration may be transmitted via an LPP message (e.g., LPP broadcast, LPP location request, LPP assistance data) or an NRPP message (e.g., NRPPa assistance information). The measurement configuration may be transmitted as part of a provide location information request, as part of an assistance data exchange, as part of an assistance information exchange, as a broadcast message (e.g., position system information block (posSIB)), or as part of a medium access control (MAC) control element (MAC-CE), or as part of downlink control information (DCI). The network entity may configure the measurement configuration based on a set of standards, and/or based on a capability received from the wireless device. The network entity may transmit a measurement configuration to the wireless device which indicates a set of referencing approaches the wireless device should use to reference positioning signal measurements for a set of positioning models. The wireless device may apply a referencing method based on the measurement configuration. In other words, the measurement configuration may activate one of a set of configured referencing methods (e.g., by configuring the wireless device to use a referencing method). The wireless device may generate a referencing indicator that indicates which referencing method was used by the wireless device. The wireless device may use the referencing indicator to adapt how the wireless device uses the referenced measurements as inputs to a positioning model (e.g., use the referencing indicator as an input to the positioning model, use the referencing indicator to select an input layer of the positioning model, use the referencing indicator to select a set of positioning models). The wireless device may transmit the referencing indicator (e.g., in a report) to a network entity (e.g., the network entity 508, the server 520) along with the referenced measurements (e.g., referenced timing, referenced power, and/or referenced phase). The network entity may apply the referenced measurements based on the referencing indicator (e.g., applying the referenced measurements to a positioning model, transmitting the referenced measurements to an entity with a positioning model, aggregating the referenced measurements with other measurements).

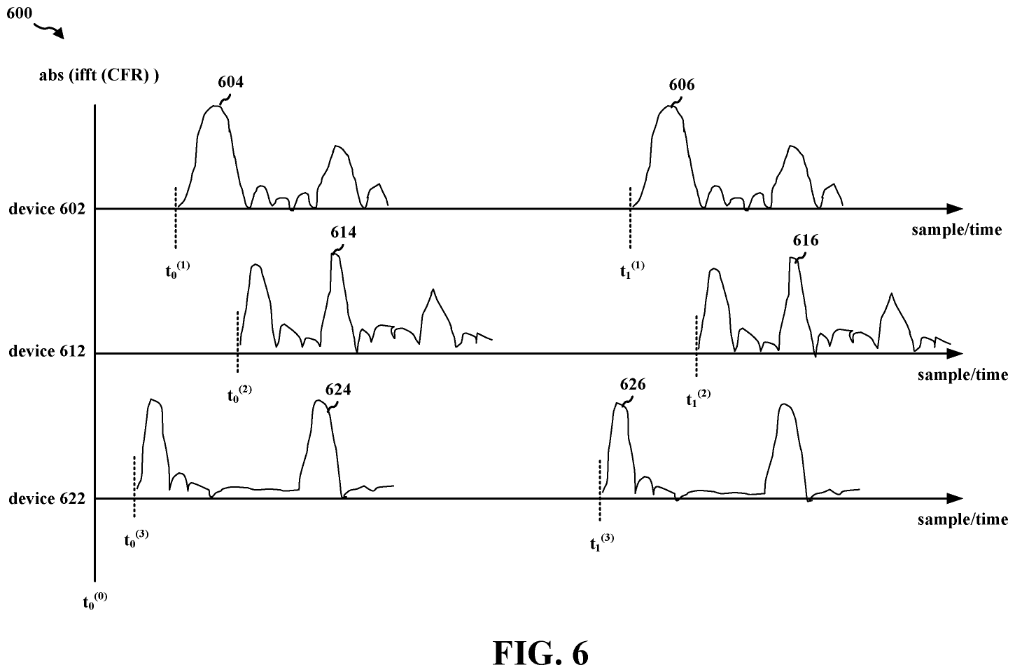

FIG. 6 is a diagram 600 illustrating an example of measurements of positioning signals received at a wireless device, such as the UE 104 or the base station 102 in FIG. 1, or the wireless device 502, the wireless device 504, or the wireless device 506 in FIG. 5. A receiver positioning wireless device may receive positioning signals transmitted by a plurality of other positioning wireless devices, such as device 602, device 612, and device 622. The receiver positioning wireless device may receive a positioning signal 604 and a positioning signal 606 from the device 602, a positioning signal 614 and a positioning signal 616 from the device 612, and a positioning signal 624 and a positioning signal 626 from the device 622. The positioning signals are shown in diagram 600 as absolute values of the received CFR.

In some aspects, the receiver positioning wireless device that measures the received positioning signals may reference the measurements of the positioning signals based on a referencing method. For example, the receiver positioning wireless device may reference the measurements based on a timing reference type. Without referencing, the receiver positioning wireless device may report the timing for each of the received positioning signals based on the time t₀⁽⁰⁾. In one aspect, for a first sample of positioning signals, the receiver positioning wireless device may receive the positioning signal 604 from the device 602 at a time t₀⁽¹⁾, may receive the positioning signal 614 from the device 612 at a time t₀⁽²⁾, and may receive the positioning signal 624 from the device 622 at a time t₀⁽³⁾. The receiver positioning wireless device may reference the measurements of the positioning signals based on an earliest received sample, for example based on the time t₀⁽³⁾, based on a strongest magnitude for a sample, for example based on the time t₀⁽¹⁾, or based on a strongest SINR sample, for example based on the time t₀⁽²⁾. In some aspects, the receiver positioning wireless device may be configured to measure all samples using the same reference method. For example, the receiver positioning wireless device may reference the positioning signal 604, the positioning signal 614, and the positioning signal 624 (the first received sample) using a first reference method, and may reference the positioning signal 606, the positioning signal 616, and the positioning signal 626 (the second received sample) using the same first reference method (e.g., reference all positioning signals based on an earliest arrival time for each set of positioning signals). In some aspects, the receiver positioning wireless device may be configured to measure samples using different reference methods. For example, the receiver positioning wireless device may reference the positioning signal 604, the positioning signal 614, and the positioning signal 624 (the first received sample) using a first reference method, and may reference the positioning signal 606, the positioning signal 616, and the positioning signal 626 (the second received sample) using a second reference method (e.g., reference the first set of positioning signals based on an earliest arrival time of the first set of positioning signals, reference the second set of positioning signals based on a strongest SINR sample of the second set of positioning signals).

While a positioning signal measurement may be used to create a reference point for timing differencing (e.g., the arrival time of positioning signal 624), a reference point for a power/magnitude differencing (e.g., the lowest/highest received power measurement of positioning signal 624), and/or a reference point for a phase differencing (e.g., the phase of positioning signal 624).

The receiver positioning wireless device may use one of a plurality of referencing methods to reference measured positioning signals. For example, the receiver positioning wireless device may consider a reference timing point (i.e., timing differencing, timing reference type) to reference received positioning signals. In one aspect, the receiver positioning wireless device may use a timing of the first arrival sample, or first arrival path, of a set of configured transmission devices (e.g., base station, UE, TRP, PRU), a set of configured SSBs, and/or a set of configured PRSs as the reference timing point. In one aspect, the receiver positioning wireless device may use a timing of the strongest/largest power for a sample, the largest power for a path, the largest magnitude for a sample, or the largest magnitude for a path of a set of configured transmission devices, a set of configured SSBs, and/or a set of configured PRSs as the reference timing point. In one aspect, the receiver positioning wireless device may use a timing of the strongest/largest signal-to-interference plus noise ratio (SINR) for a sample or the largest SINR for a path of a set of configured transmission devices, a set of configured SSBs, and/or a set of configured PRSs as the reference timing point. In one aspect, the receiver positioning wireless device may use a timing of the earliest arrival sample, or the earliest arrival path, of a set of indicated transmission devices (e.g., TRPs), of an indicated transmission device, of a set of indicated SSBs, and/or of a set of indicated PRSs as the reference timing point. In one aspect, the receiver positioning wireless device may use a timing of a first arrival sample, or a first arrival path of a set of configured transmission devices, a set of configured SSBs, and/or a set of configured PRSs as the reference timing point.

In another example, the receiver positioning wireless device may consider a reference power/magnitude point (i.e., power differencing, power reference type) to reference received positioning signals. A power may be of scale with a magnitude, allowing a device to convert a power measurement to a magnitude measurement and vice-versa.

In one aspect, the receiver positioning wireless device may use a power/magnitude of the first arrival sample, or first arrival path, of a set of configured transmission devices, a set of configured SSBs, and/or a set of configured PRSs as the reference timing point. In one aspect, the receiver positioning wireless device may use a power/magnitude of the strongest/largest power for a sample, the largest power for a path, the largest magnitude for a sample, or the largest magnitude for a path of a set of configured transmission devices, a set of configured SSBs, and/or a set of configured PRSs as the reference timing point. In one aspect, the receiver positioning wireless device may use a power/magnitude of the strongest/largest signal-to-interference plus noise ratio (SINR) for a sample or the largest SINR for a path of a set of configured transmission devices, a set of configured SSBs, and/or a set of configured PRSs as the reference timing point. In one aspect, the receiver positioning wireless device may use a power/magnitude of the earliest arrival sample, or the earliest arrival path of a set of configured transmission devices, a set of configured SSBs, and/or a set of configured PRSs as the reference timing point. In one aspect, the receiver positioning wireless device may use a power/magnitude of a first arrival sample, or a first arrival path of a set of configured transmission devices, a set of configured SSBs, and/or a set of configured PRSs as the reference timing point.

In another example, the receiver positioning wireless device may consider a reference phase point (i.e., phase differencing, phase reference type) to reference received positioning signals. In one aspect, the receiver positioning wireless device may use a phase of the first arrival sample, or first arrival path, of a set of configured transmission devices, a set of configured SSBs, and/or a set of configured PRSs as the reference timing point. In one aspect, the receiver positioning wireless device may use a phase of the strongest/largest power for a sample, the largest power for a path, the largest magnitude for a sample, or the largest magnitude for a path of a set of configured transmission devices, a set of configured SSBs, and/or a set of configured PRSs as the reference timing point. In one aspect, the receiver positioning wireless device may use a phase of the strongest/largest signal-to-interference plus noise ratio (SINR) for a sample or the largest SINR for a path of a set of configured transmission devices, a set of configured SSBs, and/or a set of configured PRSs as the reference timing point. In one aspect, the receiver positioning wireless device may use a phase of the earliest arrival sample, or the earliest arrival path of a set of configured transmission devices, a set of configured SSBs, and/or a set of configured PRSs as the reference timing point. In one aspect, the receiver positioning wireless device may use a phase of a first arrival sample, or a first arrival path of a set of configured transmission devices, a set of configured SSBs, and/or a set of configured PRSs as the reference timing point.

In some aspects, the receiver positioning wireless device may use a combination of reference points, for example a timing reference point, a power/magnitude reference point, and a phase reference point, to reference a set of measured positioning signals. A referencing method may consider a combination of timing, power/magnitude, and phase points which all correspond to the same reference path/sample. A referencing method may consider a combination of timing, power/magnitude, and phase points which each correspond to the different reference path/sample (e.g., a timing reference point of a first arrival path, a power/magnitude reference point of a strongest SINR sample, a phase reference point for an earliest arrival sample of a set of configured TRPs). The receiver positioning wireless device may apply a reference method to any number of resources, for example all transmission devices (e.g., all TRPs, all UEs), a subset of transmission devices, to a specific transmission device, to all antenna ports of a transmission device, to a subset of antenna ports of a transmission device, and/or to a specific antenna port of a transmission device. A network entity, such as an LMF, may indicate which referencing method for the receiver positioning wireless device, or the receiver positioning wireless device may be configured to autonomously select a referencing method from a set of applicable referencing methods for positioning models at the receiver positioning wireless device. A network entity may transmit a request to the receiver positioning wireless device to transmit a set of capabilities of what types of referencing methods the receiver positioning wireless device may use, and which types of measurements the receiver positioning wireless device may take (e.g., supported CIR, PDP, DP). The receiver positioning wireless device may transmit an indicator of its capabilities to the network entity in response to the request, or may be configured to transmit the indicator autonomously. For example, the wireless device may be configured to transmit in response to an event (e.g., a calculated positioning error margin exceeding a threshold) or may be configured to periodically broadcast its capabilities.

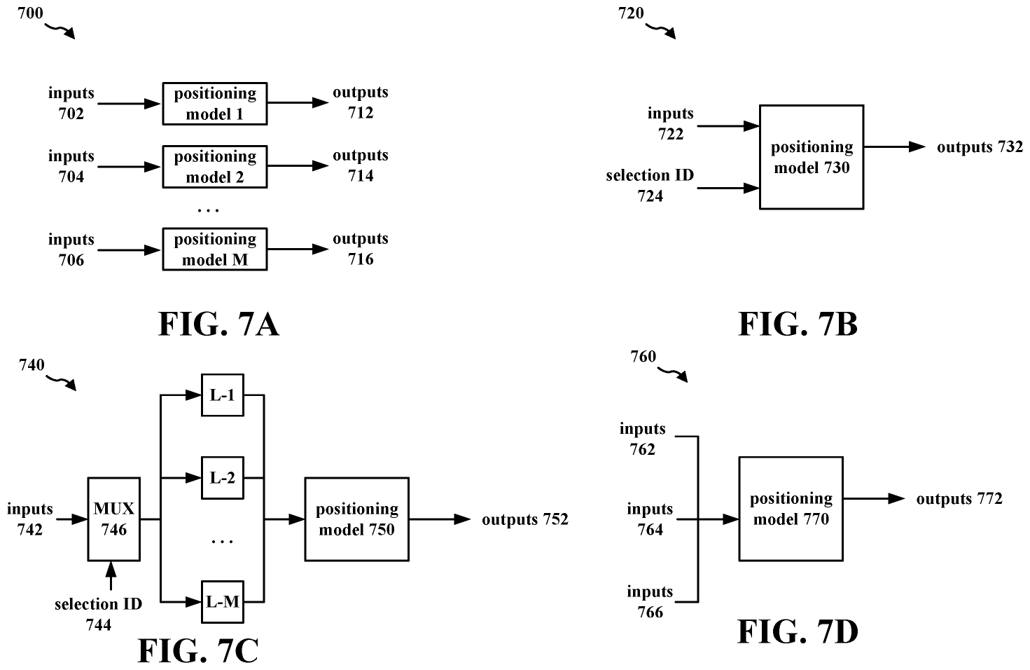

FIG. 7A is a diagram 700 illustrating an example of a set of positioning models, labeled as positioning model 1 through positioning model M, where each of the set of positioning models is configured to accept inputs for a particular referencing method to calculate a set of positioning outputs, such as a location of a wireless device or an intermediate measurement that may be used to calculate the location of the wireless device. The positioning model 1 may be trained to accept a set of inputs 702 referenced using a first referencing method to calculate a set of outputs 712. The positioning model 2 may be trained to accept a set of inputs 704 referenced using a second referencing method to calculate a set of outputs 714. The positioning model M may be trained to accept a set of inputs 706 referenced using a third referencing method to calculate a set of outputs 716. Each of the first, second, and third referencing methods may be different referencing methods. For example, the first referencing method may reference a set of positioning signal measurements about an earliest arrival time referencing point for a set of configured TRPs, while the second referencing method may reference a set of positioning signal measurements about a measurement sample with the strongest SINR for a specified TRP. A positioning wireless device may measure a set of positioning signals and select a positioning model to use based on the referencing method used by the positioning wireless device to reference the measured set of positioning signals.

FIG. 7B is a diagram 720 illustrating an example of a positioning model 730 trained to accept a set of inputs 722 and an ID 724 to calculate a set of positioning outputs 732. The positioning model 730 may be trained using inputs that have been referenced using a variety of referencing methods, for example a first referencing method that references measured positioning signals using a magnitude of the largest magnitude of a set of configured SSBs and a second referencing method that references measured positioning signals using a magnitude of the measured SSB having the strongest SINR of a set of measured SINRs associated with a set of SSBs. The positioning model 730 may accept an ID 724, for example a referencing method ID, which may be used to indicate to the positioning model 730 which referencing method was used to reference the set of inputs 722. The positioning model 730 may then adopt a positioning algorithm used to calculate the set of positioning outputs 732 using the set of inputs 722 based on the ID 724.

FIG. 7C is a diagram 740 illustrating an example of a positioning model 750 and a set of input layers, labeled as layer 1 through layer M, where each of the set of input layers is configured to accept inputs for a particular referencing method to calculate a set of positioning outputs 752. The set of input layers may accept a set of inputs 742 which are directed to the appropriate layer via a selection module, such as the mux 746, which may direct the set of inputs 742 towards the appropriate layer based on a selection ID 744. Each of the set of input layers 1 through M may be configured to adjust the set of inputs 742 based on a referencing method used for the set of inputs 742. For example, the layer 1 may apply a first set of weights to the set of inputs 742 for a first referencing method, and the layer 2 may apply a second set of weights to the set of inputs 742 for a second referencing method.

FIG. 7D is a diagram 760 illustrating an example of a positioning model 770 configured to accept any of a set of inputs, shown as the set of inputs 762, the set of inputs 764, and the set of inputs 766, for any of a set of referencing methods to calculate a set of positioning outputs. The positioning model 770 may be a robust positioning model trained using inputs for any of a set of referencing methods, which does not accept a selection ID or a referencing method ID to adjust how the positioning model 770 calculates the positioning outputs 772, as the positioning model 770 is capable of calculating the set of positioning outputs 772 with inputs that have been referenced using any of a set of referencing methods. Each of the set of inputs 762, the set of inputs 764, and the set of inputs 766 may be referenced using any of the set of referencing methods.

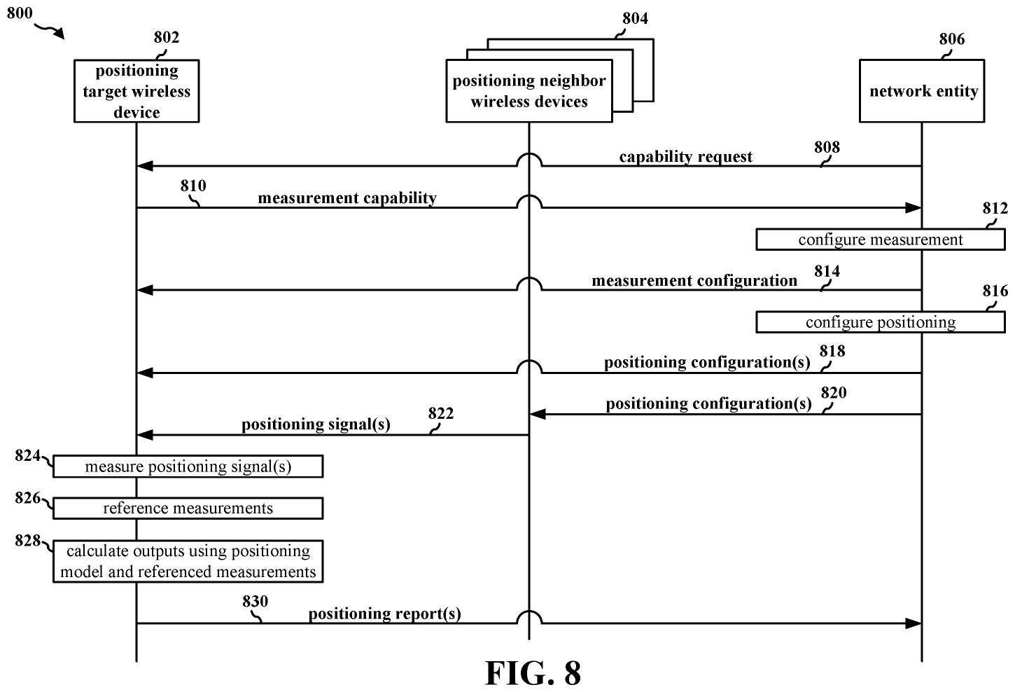

FIG. 8 is a connection flow diagram 800 illustrating an example of a network entity 806 configured to configure measurements of a set of positioning signals (e.g., SRS, PRS, SSB) for a positioning target wireless device 802. The positioning target wireless device 802 may be a UE or a PRU. The set of positioning neighbor wireless devices 804 may include a set of base stations and/or a set of TRPs. The network entity 806 may include a core network, an LMF, or a set of location servers.

The network entity 806 may transmit a capability request 808 to the positioning target wireless device 802. The positioning target wireless device 802 may receive the capability request 808 from the network entity 806. The capability request 808 may include an indicator of a request by the network entity 806 for an indication of capabilities of the positioning target wireless device 802 to support a plurality of referencing methods. In other words, the capability request 808 may request the positioning target wireless device 802 to indicate a set of capabilities and a set of adaptation decisions that the positioning target wireless device 802 may have with respect to referencing methods. The network entity 806 may transmit an LPP message including the capability request 808. For example, the network entity 806 may transmit the capability request 808 as part of LPP capability messaging between the network entity 806 and the positioning target wireless device 802. The network entity 806 may transmit the capability request 808 as part of a UE capability exchange procedure between the positioning target wireless device 802 and the network entity 806.

The positioning target wireless device 802 may transmit a measurement capability 810 to the network entity 806. The network entity 806 may receive the measurement capability 810 from the positioning target wireless device 802. The positioning target wireless device 802 may transmit an LPP message that includes the measurement capability 810. For example, the positioning target wireless device 802 may transmit the measurement capability 810 as part of LPP capability messaging between the network entity 806 and the positioning target wireless device 802. The positioning target wireless device 802 may transmit the measurement capability 810 as part of a UE capability exchange procedure between the positioning target wireless device 802 and the network entity 806. The measurement capability 810 may include an indicator of the capability of the positioning target wireless device 802 to select one of a set of referencing methods to reference a set of measurements of positioning signals. For example, the capability may indicate which referencing methods the positioning target wireless device 802 may use (e.g., reference timing point, reference power point, reference magnitude point, reference phase point), how the positioning target wireless device 802 may select a reference signal (e.g., first arrival path, strongest SINR sample), what conditions the positioning target wireless device 802 may use to select an adaptation decision, which adaptation decisions the positioning target wireless device 802 may use, which referencing indicators the positioning target wireless device 802 may calculate, how the positioning target wireless device 802 may format a report, and/or which positioning models are at the positioning target wireless device 802.

At 812, the network entity 806 may configure a measurement of the set of positioning signals 822 by the positioning target wireless device 802. In some aspects, the network entity 806 may configure the measurement of the set of positioning signals 822 based on a set of standards. In some aspects, the network entity 806 may configure the measurement of the set of positioning signals 822 based on the measurement capability 810. For example, the network entity 806 may configure referencing by the positioning target wireless device 802 to satisfy the indicated measurement capability of the positioning target wireless device 802. In some aspects, the network entity 806 may configure referencing based on a set of positioning models at the positioning target wireless device 802 (which may be indicated by the measurement capability 810), based on a set of positioning models at the network entity 806, a set of positioning models accessible via the positioning target wireless device 802 (e.g., the positioning target wireless device 802 is capable of transmitting reference measurements to a network entity with the set of positioning models), or a set of positioning models accessible via the network entity 806 (e.g., the network entity 806 is capable of transmitting reference measurements received from the positioning target wireless device 802 to a network entity with the set of positioning models). In some aspects, the network entity 806 may select a subset of referencing models (e.g., referencing models associated with the greatest accuracy metrics) for a set of positioning models that the positioning target wireless device 802 is capable of handling based on the measurement capability 810.

The network entity 806 may transmit a measurement configuration 814 to the positioning target wireless device 802. The positioning target wireless device 802 may receive the measurement configuration 814 from the network entity 806. The network entity 806 may transmit an LPP message that includes the measurement configuration 814. For example, the network entity 806 may transmit an LPP broadcast, an LPP location request, or LPP assistance data that includes the measurement configuration 814. The network entity 806 may transmit the measurement configuration 814 as part of a provide location information request, as part of an assistance data exchange, as part of an assistance information exchange, as broadcast information (e.g., a posSIB), as part of a MAC-CE, or as part of DCI transmitted to the positioning target wireless device 802.

The measurement configuration 814 may include one or more indicators for the positioning target wireless device 802 to perform referencing on the set of positioning signals 822. The measurement configuration 814 may include an indicator of conditions for the positioning target wireless device 802 to use to determine whether to perform an adaptation decision. In other words, the measurement configuration 814 may include a set of conditions, where each of the set of conditions is associated with an adaptation decision and a referencing type (e.g., select a reference timing point of a reference signal with the highest probability LOS state if the LOS probability of a set of reference signals is less than or equal to a threshold value). The measurement configuration 814 may indicate which referencing indicators the positioning target wireless device 802 may use to input references measurements into a set of positioning models at the positioning target wireless device 802. The referencing indicator may include an ID of the referencing method used by the positioning target wireless device 802, IDs of associated conditions and adaptation decisions, an indicator of which positioning models the positioning target wireless device 802 uses at 828, and/or an indicator of which input layers the positioning target wireless device 802 uses at 828.

At 816, the network entity 806 may configure positioning for the positioning target wireless device 802 and the set of positioning neighbor wireless devices 804. The configuration may include a configuration for the set of positioning neighbor wireless devices 804 to transmit a set of positioning signals 822 at the positioning target wireless device 802, and for the positioning target wireless device 802 to measure the set of positioning signals 822 received from the set of positioning neighbor wireless devices 804 for a set of positioning models.

The network entity 806 may transmit a set of positioning configurations 818 at the positioning target wireless device 802. The positioning target wireless device 802 may receive the set of positioning configurations 818 from the network entity 806. The network entity may transmit a set of positioning configurations 820 at the set of positioning neighbor wireless devices 804. The set of positioning neighbor wireless devices 804 may receive the set of positioning configurations 820 from the network entity 806. In some aspects, the network entity 806 may transmit the measurement configuration 814 and the set of positioning configurations 818 to the positioning target wireless device 802 in a single set of configurations transmitted to the positioning target wireless device 802. In some aspects, the network entity 806 may transmit the measurement configuration 814 and the set of positioning configurations 818 to the positioning target wireless device 802 in multiple transmissions to the positioning target wireless device 802.

The set of positioning neighbor wireless devices 804 may transmit the signals 822 at the positioning target wireless device 802 based on the set of positioning configurations 820 received from the network entity 806. The set of positioning signals 822 may include a set of positioning RSs, for example SRSs, PRSs, and/or SSBs.

At 824, the positioning target wireless device 802 may measure the set of positioning signals 822 received from the set of positioning neighbor wireless devices 804. At 826, the positioning target wireless device 802 may reference one or more of the set of measured positioning signals based on the measurement configuration 814. The positioning target wireless device 802 may apply multiple types of referencing to a set of positioning signal measurements, for example a reference timing method and a reference magnitude method, or may apply a single type of referencing to the set of positioning signal measurements, for example a reference timing method.

At 828, the positioning target wireless device 802 may calculate a set of outputs using a set of positioning models based on the referenced positioning signals. The positioning target wireless device 802 may input the referenced measurements into the set of positioning models based on a calculated referencing indicator. For example, the positioning target wireless device 802 may use the referencing indicator as a selection ID for a positioning model, the positioning target wireless device 802 may select a set of positioning models based on the referencing indicator, and/or the positioning target wireless device 802 may select an input layer of a set of positioning models based on the referencing indicator. The positioning target wireless device 802 may transmit a set of positioning reports 830 to the network entity 806 based on the calculation at 828. The network entity 806 may receive the set of positioning reports 830 from the positioning target wireless device 802. The set of positioning reports 830 may include at least some of the outputs from the positioning model calculation at 828.

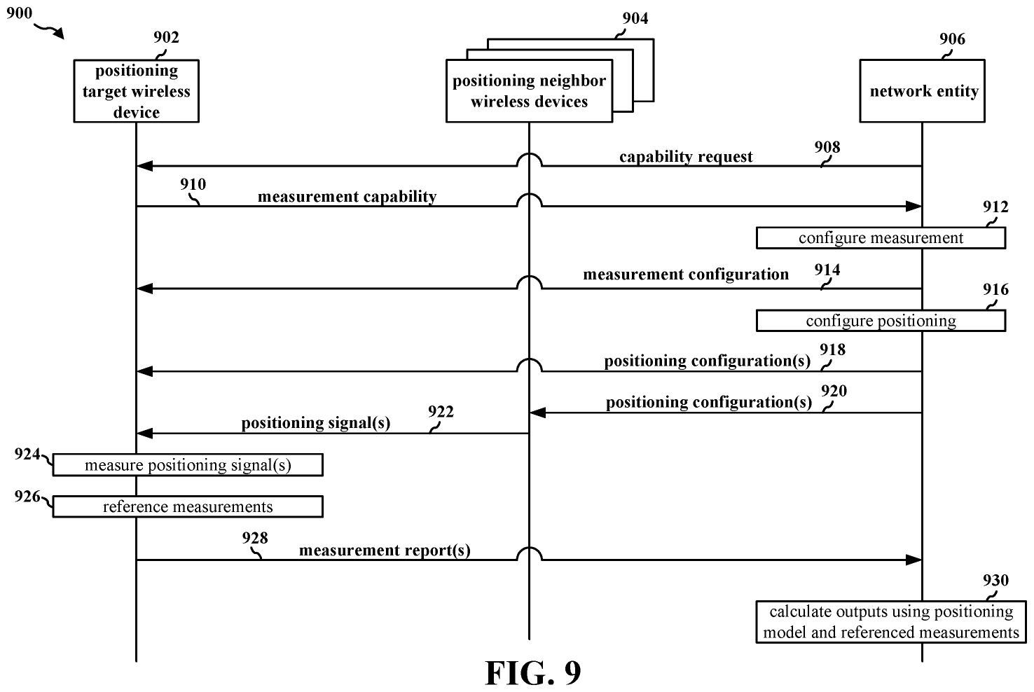

FIG. 9 is a connection flow diagram 900 illustrating an example of a network entity 906 configured to configure measurements of a set of positioning signals (e.g., SRS, PRS, SSB) for a positioning target wireless device 902. The positioning target wireless device 902 may be a UE or a PRU. The set of positioning neighbor wireless devices 904 may include a set of base stations and/or a set of TRPs. The network entity 906 may include a core network, an LMF, or a set of location servers.

The network entity 906 may transmit a capability request 908 to the positioning target wireless device 902. The positioning target wireless device 902 may receive the capability request 908 from the network entity 906. The capability request 908 may include an indicator of a request by the network entity 906 for an indication of capabilities of the positioning target wireless device 902 to support a plurality of referencing methods. In other words, the capability request 908 may request the positioning target wireless device 902 to indicate a set of capabilities and a set of adaptation decisions that the positioning target wireless device 902 may have with respect to referencing methods. The network entity 906 may transmit an LPP message including the capability request 908. For example, the network entity 906 may transmit the capability request 908 as part of LPP capability messaging between the network entity 906 and the positioning target wireless device 902. The network entity 906 may transmit the capability request 908 as part of a UE capability exchange procedure between the positioning target wireless device 902 and the network entity 906.

The positioning target wireless device 902 may transmit a measurement capability 910 to the network entity 906. The network entity 906 may receive the measurement capability 910 from the positioning target wireless device 902. The positioning target wireless device 902 may transmit an LPP message that includes the measurement capability 910. For example, the positioning target wireless device 902 may transmit the measurement capability 910 as part of LPP capability messaging between the network entity 906 and the positioning target wireless device 902. The positioning target wireless device 902 may transmit the measurement capability 910 as part of a UE capability exchange procedure between the positioning target wireless device 902 and the network entity 906. The measurement capability 910 may include an indicator of the capability of the positioning target wireless device 902 to select one of a set of referencing methods to reference a set of measurements of positioning signals. For example, the capability may indicate which referencing methods the positioning target wireless device 902 may use (e.g., reference timing point, reference power point, reference magnitude point, reference phase point), how the positioning target wireless device 902 may select a reference signal (e.g., first arrival path, strongest SINR sample), what conditions the positioning target wireless device 902 may use to select an adaptation decision, which adaptation decisions the positioning target wireless device 902 may use, which referencing indicators the positioning target wireless device 902 may calculate, how the positioning target wireless device 902 may format a report, and/or which positioning models are at the positioning target wireless device 902.

At 912, the network entity 906 may configure a measurement of the set of positioning signals 922 by the positioning target wireless device 902. In some aspects, the network entity 906 may configure the measurement of the set of positioning signals 922 based on a set of standards. In some aspects, the network entity 906 may configure the measurement of the set of positioning signals 922 based on the measurement capability 910. For example, the network entity 906 may configure referencing by the positioning target wireless device 902 to satisfy the indicated measurement capability of the positioning target wireless device 902. In some aspects, the network entity 906 may configure referencing based on a set of positioning models at the positioning target wireless device 902 (which may be indicated by the measurement capability 910), based on a set of positioning models at the network entity 906, a set of positioning models accessible via the positioning target wireless device 902 (e.g., the positioning target wireless device 902 is capable of transmitting reference measurements to a network entity with the set of positioning models), or a set of positioning models accessible via the network entity 906 (e.g., the network entity 906 is capable of transmitting reference measurements received from the positioning target wireless device 902 to a network entity with the set of positioning models). In some aspects, the network entity 906 may select a subset of referencing models (e.g., referencing models associated with the greatest accuracy metrics) for a set of positioning models that the positioning target wireless device 902 is capable of handling based on the measurement capability 910.

The network entity 906 may transmit a measurement configuration 914 to the positioning target wireless device 902. The positioning target wireless device 902 may receive the measurement configuration 914 from the network entity 906. The network entity 906 may transmit an LPP message that includes the measurement configuration 914. For example, the network entity 906 may transmit an LPP broadcast, an LPP location request, or LPP assistance data that includes the measurement configuration 914. The network entity 906 may transmit the measurement configuration 914 as part of a provide location information request, as part of an assistance data exchange, as part of an assistance information exchange, as broadcast information (e.g., a posSIB), as part of a MAC-CE, or as part of DCI transmitted to the positioning target wireless device 902.

The measurement configuration 914 may include one or more indicators for the positioning target wireless device 902 to perform referencing on the set of positioning signals 922. The measurement configuration 914 may include an indicator of conditions for the positioning target wireless device 902 to use to determine whether to perform an adaptation decision. In other words, the measurement configuration 914 may include a set of conditions, where each of the set of conditions is associated with an adaptation decision and a referencing type (e.g., select a reference timing point of a reference signal with the highest probability LOS state if the LOS probability of a set of reference signals is less than or equal to a threshold value). The measurement configuration 914 may indicate which referencing indicators the positioning target wireless device 902 may indicate to the network entity 906 in the set of measurement reports 928. The referencing indicator may include an ID of the referencing method used by the positioning target wireless device 902, IDs of associated conditions and adaptation decisions, an indicator of which positioning models the positioning target wireless device 902 suggests using, and/or an indicator of which input layers the positioning target wireless device 902 suggests using.

At 916, the network entity 906 may configure positioning for the positioning target wireless device 902 and the set of positioning neighbor wireless devices 904. The configuration may include a configuration for the set of positioning neighbor wireless devices 904 to transmit a set of positioning signals 922 at the positioning target wireless device 902, and for the positioning target wireless device 902 to measure the set of positioning signals 922 received from the set of positioning neighbor wireless devices 904 for a set of positioning models.

The network entity 906 may transmit a set of positioning configurations 918 at the positioning target wireless device 902. The positioning target wireless device 902 may receive the set of positioning configurations 918 from the network entity 906. The network entity may transmit a set of positioning configurations 920 at the set of positioning neighbor wireless devices 904. The set of positioning neighbor wireless devices 904 may receive the set of positioning configurations 920 from the network entity 906. In some aspects, the network entity 906 may transmit the measurement configuration 914 and the set of positioning configurations 918 to the positioning target wireless device 902 in a single set of configurations transmitted to the positioning target wireless device 902. In some aspects, the network entity 906 may transmit the measurement configuration 914 and the set of positioning configurations 918 to the positioning target wireless device 902 in multiple transmissions to the positioning target wireless device 902.

The set of positioning neighbor wireless devices 904 may transmit the signals 922 at the positioning target wireless device 902 based on the set of positioning configurations 920 received from the network entity 906. The set of positioning signals 922 may include a set of positioning RSs, for example SRSs, PRSs, and/or SSBs.

At 924, the positioning target wireless device 902 may measure the set of positioning signals 922 received from the set of positioning neighbor wireless devices 904. At 926, the positioning target wireless device 902 may reference one or more of the set of measured positioning signals based on the measurement configuration 914. The positioning target wireless device 902 may apply multiple types of referencing to a set of positioning signal measurements, for example a reference timing method and a reference magnitude method, or may apply a single type of referencing to the set of positioning signal measurements, for example a reference timing method.

The positioning target wireless device 902 may transmit a set of measurement reports 928 to the network entity 906. The network entity 906 may receive the set of measurement reports 928 from the positioning target wireless device 902. The set of measurement reports 928 may include an indicator of at least some of the referenced measurements referenced at 926. The positioning target wireless device 902 may select which measurements to transmit based on the measurement configuration 914. The positioning target wireless device 902 may select which measurements to transmit based on a set of positioning models that are indicated by the measurement configuration 914.

At 930, the network entity 906 may calculate a set of outputs using a positioning model based on the referenced positioning signals. The network entity 906 may input the referenced measurements into the set of positioning models based on a referencing indicator indicated by the set of measurement reports 928. For example, the network entity 906 may use the referencing indicator as a selection ID for a positioning model, the network entity 906 may select a set of positioning models based on the referencing indicator, and/or the network entity 906 may select an input layer of a set of positioning models based on the referencing indicator.

In some aspects, the network entity 906 may aggregate a set of referenced measurements from a plurality of wireless devices to input into a set of positioning models. The set of referenced measurements may be referenced using a same referencing method indicated by measurement configurations transmitted by the network entity 906. The set of referenced measurements may be referenced using the same set of conditions and adaptation decisions indicated by measurement configurations transmitted by the network entity 906. In some aspects, the set of referenced measurements may be referenced using different referencing methods, for example where a set of positioning models may be configured to accept inputs that have been referenced using a plurality of referencing methods.

In some aspects, the network entity 906 may transmit the referenced measurements to another network entity, for example an OTT server with a set of positioning models. In such aspects, the network entity 906 may also transmit the referencing indicator. In some aspects, the network entity 906 may aggregate a set of referenced measurements from a plurality of wireless devices before forwarding the aggregated referenced measurements to another network entity. The network entity 906 may calculate a new referencing indicator (e.g., an indicator that identifies a plurality of specified referencing models), or may aggregate referencing indicators to transmit to the other network entity (e.g., a vector of referencing indicators).

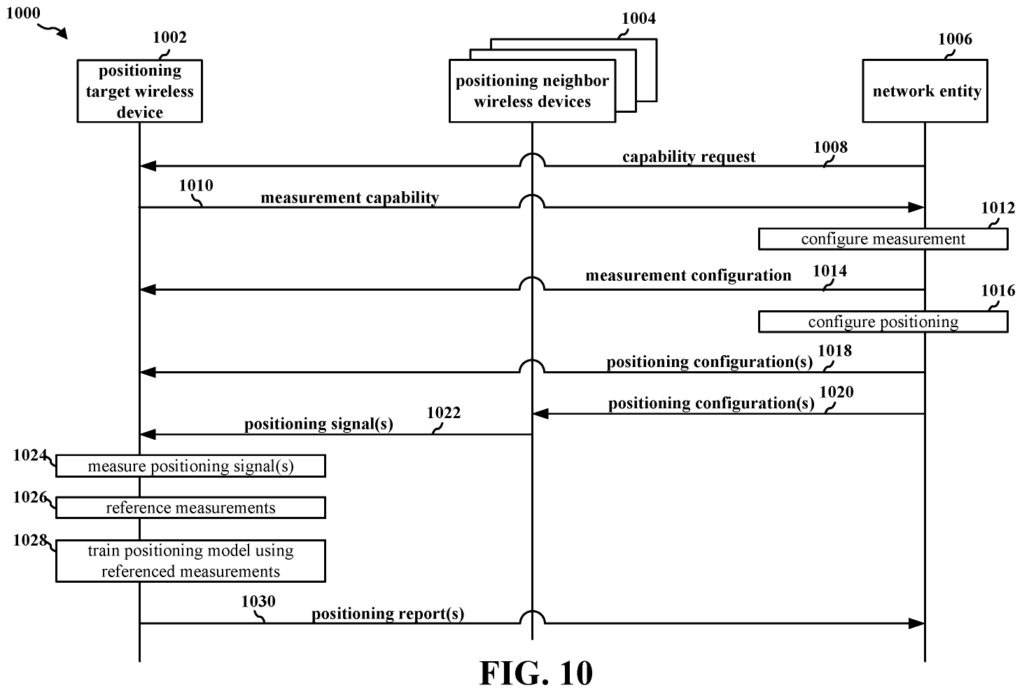

FIG. 10 is a connection flow diagram 1000 illustrating an example of a network entity 1006 configured to configure measurements of a set of positioning signals (e.g., SRS, PRS, SSB) for a positioning target wireless device 1002. The positioning target wireless device 1002 may be a UE or a PRU. The set of positioning neighbor wireless devices 1004 may include a set of base stations and/or a set of TRPs. The network entity 1006 may include a core network, an LMF, or a set of location servers.

The network entity 1006 may transmit a capability request 1008 to the positioning target wireless device 1002. The positioning target wireless device 1002 may receive the capability request 1008 from the network entity 1006. The capability request 1008 may include an indicator of a request by the network entity 1006 for an indication of capabilities of the positioning target wireless device 1002 to support a plurality of referencing methods. In other words, the capability request 1008 may request the positioning target wireless device 1002 to indicate a set of capabilities and a set of adaptation decisions that the positioning target wireless device 1002 may have with respect to referencing methods. The network entity 1006 may transmit an LPP message including the capability request 1008. For example, the network entity 1006 may transmit the capability request 1008 as part of LPP capability messaging between the network entity 1006 and the positioning target wireless device 1002. The network entity 1006 may transmit the capability request 1008 as part of a UE capability exchange procedure between the positioning target wireless device 1002 and the network entity 1006.

The positioning target wireless device 1002 may transmit a measurement capability 1010 to the network entity 1006. The network entity 1006 may receive the measurement capability 1010 from the positioning target wireless device 1002. The positioning target wireless device 1002 may transmit an LPP message that includes the measurement capability 1010. For example, the positioning target wireless device 1002 may transmit the measurement capability 1010 as part of LPP capability messaging between the network entity 1006 and the positioning target wireless device 1002. The positioning target wireless device 1002 may transmit the measurement capability 1010 as part of a UE capability exchange procedure between the positioning target wireless device 1002 and the network entity 1006. The measurement capability 1010 may include an indicator of the capability of the positioning target wireless device 1002 to select one of a set of referencing methods to reference a set of measurements of positioning signals. For example, the capability may indicate which referencing methods the positioning target wireless device 1002 may use (e.g., reference timing point, reference power point, reference magnitude point, reference phase point), how the positioning target wireless device 1002 may select a reference signal (e.g., first arrival path, strongest SINR sample), what conditions the positioning target wireless device 1002 may use to select an adaptation decision, which adaptation decisions the positioning target wireless device 1002 may use, which referencing indicators the positioning target wireless device 1002 may calculate, how the positioning target wireless device 1002 may format a report, and/or which positioning models are at the positioning target wireless device 1002.

At 1012, the network entity 1006 may configure a measurement of the set of positioning signals 1022 by the positioning target wireless device 1002. In some aspects, the network entity 1006 may configure the measurement of the set of positioning signals 1022 based on a set of standards. In some aspects, the network entity 1006 may configure the measurement of the set of positioning signals 1022 based on the measurement capability 1010. For example, the network entity 1006 may configure referencing by the positioning target wireless device 1002 to satisfy the indicated measurement capability of the positioning target wireless device 1002. In some aspects, the network entity 1006 may configure referencing based on a set of positioning models at the positioning target wireless device 1002 (which may be indicated by the measurement capability 1010), based on a set of positioning models at the network entity 1006, a set of positioning models accessible via the positioning target wireless device 1002 (e.g., the positioning target wireless device 1002 is capable of transmitting reference measurements to a network entity with the set of positioning models), or a set of positioning models accessible via the network entity 1006 (e.g., the network entity 1006 is capable of transmitting reference measurements received from the positioning target wireless device 1002 to a network entity with the set of positioning models). In some aspects, the network entity 1006 may select a subset of referencing models (e.g., referencing models associated with the greatest accuracy metrics) for a set of positioning models that the positioning target wireless device 1002 is capable of handling based on the measurement capability 1010.

The network entity 1006 may transmit a measurement configuration 1014 to the positioning target wireless device 1002. The positioning target wireless device 1002 may receive the measurement configuration 1014 from the network entity 1006. The network entity 1006 may transmit an LPP message that includes the measurement configuration 1014. For example, the network entity 1006 may transmit an LPP broadcast, an LPP location request, or LPP assistance data that includes the measurement configuration 1014. The network entity 1006 may transmit the measurement configuration 1014 as part of a provide location information request, as part of an assistance data exchange, as part of an assistance information exchange, as broadcast information (e.g., a posSIB), as part of a MAC-CE, or as part of DCI transmitted to the positioning target wireless device 1002.

The measurement configuration 1014 may include one or more indicators for the positioning target wireless device 1002 to perform referencing on the set of positioning signals 1022. The measurement configuration 1014 may include an indicator of conditions for the positioning target wireless device 1002 to use to determine whether to perform an adaptation decision. In other words, the measurement configuration 1014 may include a set of conditions, where each of the set of conditions is associated with an adaptation decision and a referencing type (e.g., select a reference timing point of a reference signal with the highest probability LOS state if the LOS probability of a set of reference signals is less than or equal to a threshold value). The measurement configuration 1014 may indicate which referencing indicators the positioning target wireless device 1002 may use to input references measurements into a set of positioning models at the positioning target wireless device 1002. The referencing indicator may include an ID of the referencing method used by the positioning target wireless device 1002, IDs of associated conditions and adaptation decisions, an indicator of which positioning models the positioning target wireless device 1002 uses at 1028, and/or an indicator of which input layers the positioning target wireless device 1002 uses at 1028.

At 1016, the network entity 1006 may configure positioning for the positioning target wireless device 1002 and the set of positioning neighbor wireless devices 1004. The configuration may include a configuration for the set of positioning neighbor wireless devices 1004 to transmit a set of positioning signals 1022 at the positioning target wireless device 1002, and for the positioning target wireless device 1002 to measure the set of positioning signals 1022 received from the set of positioning neighbor wireless devices 1004 for a set of positioning models.

The network entity 1006 may transmit a set of positioning configurations 1018 at the positioning target wireless device 1002. The positioning target wireless device 1002 may receive the set of positioning configurations 1018 from the network entity 1006. The network entity may transmit a set of positioning configurations 1020 at the set of positioning neighbor wireless devices 1004. The set of positioning neighbor wireless devices 1004 may receive the set of positioning configurations 1020 from the network entity 1006. In some aspects, the network entity 1006 may transmit the measurement configuration 1014 and the set of positioning configurations 1018 to the positioning target wireless device 1002 in a single set of configurations transmitted to the positioning target wireless device 1002. In some aspects, the network entity 1006 may transmit the measurement configuration 1014 and the set of positioning configurations 1018 to the positioning target wireless device 1002 in multiple transmissions to the positioning target wireless device 1002.

The set of positioning neighbor wireless devices 1004 may transmit the signals 1022 at the positioning target wireless device 1002 based on the set of positioning configurations 1020 received from the network entity 1006. The set of positioning signals 1022 may include a set of positioning RSs, for example SRSs, PRSs, and/or SSBs.

At 1024, the positioning target wireless device 1002 may measure the set of positioning signals 1022 received from the set of positioning neighbor wireless devices 1004. At 1026, the positioning target wireless device 1002 may reference one or more of the set of measured positioning signals based on the measurement configuration 1014. The positioning target wireless device 1002 may apply multiple types of referencing to a set of positioning signal measurements, for example a reference timing method and a reference magnitude method, or may apply a single type of referencing to the set of positioning signal measurements, for example a reference timing method.

At 1028, the positioning target wireless device 1002 may train a set of positioning models based on the referenced positioning signals. The positioning target wireless device 1002 may input the referenced measurements into the set of positioning models based on a calculated referencing indicator. For example, the positioning target wireless device 1002 may use the referencing indicator as a selection ID for a positioning model, the positioning target wireless device 1002 may select a set of positioning models based on the referencing indicator, and/or the positioning target wireless device 1002 may select an input layer of a set of positioning models based on the referencing indicator. The positioning target wireless device 1002 may transmit a set of positioning reports 1030 to the network entity 1006 based on the calculation at 1028. The network entity 1006 may receive the set of positioning reports 1030 from the positioning target wireless device 1002. The set of positioning reports 1030 may include an indicator that the positioning target wireless device 1002 used referenced positioning signals to train a set of positioning models.

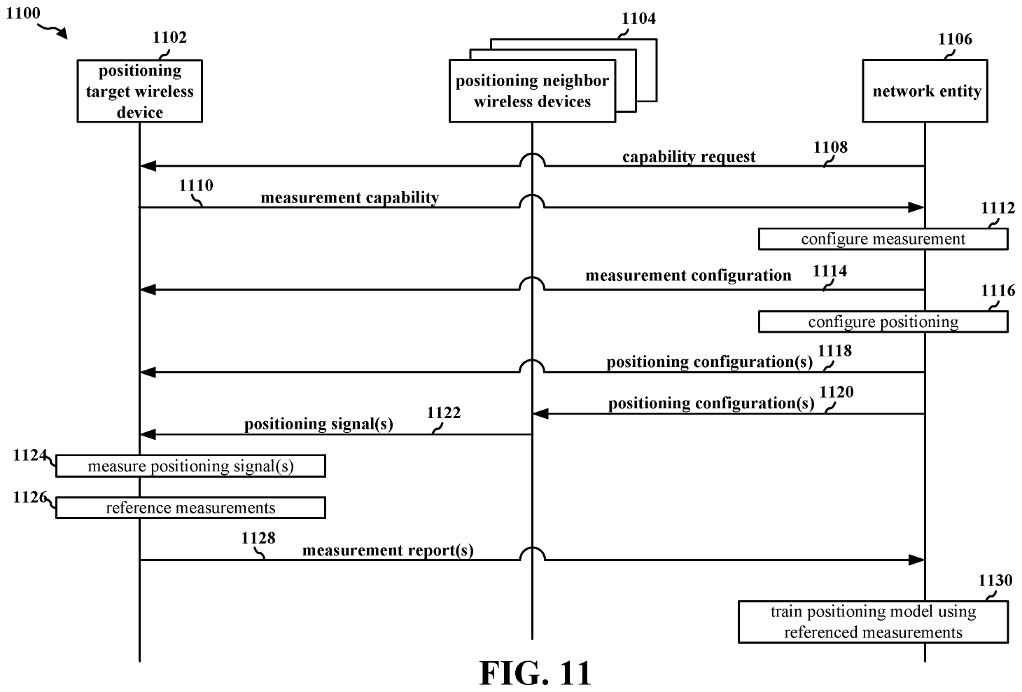

FIG. 11 is a connection flow diagram 1100 illustrating an example of a network entity 1106 configured to configure measurements of a set of positioning signals (e.g., SRS, PRS, SSB) for a positioning target wireless device 1102. The positioning target wireless device 1102 may be a UE or a PRU. The set of positioning neighbor wireless devices 1104 may include a set of base stations and/or a set of TRPs. The network entity 1106 may include a core network, an LMF, or a set of location servers.

The network entity 1106 may transmit a capability request 1108 to the positioning target wireless device 1102. The positioning target wireless device 1102 may receive the capability request 1108 from the network entity 1106. The capability request 1108 may include an indicator of a request by the network entity 1106 for an indication of capabilities of the positioning target wireless device 1102 to support a plurality of referencing methods. In other words, the capability request 1108 may request the positioning target wireless device 1102 to indicate a set of capabilities and a set of adaptation decisions that the positioning target wireless device 1102 may have with respect to referencing methods. The network entity 1106 may transmit an LPP message including the capability request 1108. For example, the network entity 1106 may transmit the capability request 1108 as part of LPP capability messaging between the network entity 1106 and the positioning target wireless device 1102. The network entity 1106 may transmit the capability request 1108 as part of a UE capability exchange procedure between the positioning target wireless device 1102 and the network entity 1106.

The positioning target wireless device 1102 may transmit a measurement capability 1110 to the network entity 1106. The network entity 1106 may receive the measurement capability 1110 from the positioning target wireless device 1102. The positioning target wireless device 1102 may transmit an LPP message that includes the measurement capability 1110. For example, the positioning target wireless device 1102 may transmit the measurement capability 1110 as part of LPP capability messaging between the network entity 1106 and the positioning target wireless device 1102. The positioning target wireless device 1102 may transmit the measurement capability 1110 as part of a UE capability exchange procedure between the positioning target wireless device 1102 and the network entity 1106. The measurement capability 1110 may include an indicator of the capability of the positioning target wireless device 1102 to select one of a set of referencing methods to reference a set of measurements of positioning signals. For example, the capability may indicate which referencing methods the positioning target wireless device 1102 may use (e.g., reference timing point, reference power point, reference magnitude point, reference phase point), how the positioning target wireless device 1102 may select a reference signal (e.g., first arrival path, strongest SINR sample), what conditions the positioning target wireless device 1102 may use to select an adaptation decision, which adaptation decisions the positioning target wireless device 1102 may use, which referencing indicators the positioning target wireless device 1102 may calculate, how the positioning target wireless device 1102 may format a report, and/or which positioning models are at the positioning target wireless device 1102.

At 1112, the network entity 1106 may configure a measurement of the set of positioning signals 1122 by the positioning target wireless device 1102. In some aspects, the network entity 1106 may configure the measurement of the set of positioning signals 1122 based on a set of standards. In some aspects, the network entity 1106 may configure the measurement of the set of positioning signals 1122 based on the measurement capability 1110. For example, the network entity 1106 may configure referencing by the positioning target wireless device 1102 to satisfy the indicated measurement capability of the positioning target wireless device 1102. In some aspects, the network entity 1106 may configure referencing based on a set of positioning models at the positioning target wireless device 1102 (which may be indicated by the measurement capability 1110), based on a set of positioning models at the network entity 1106, a set of positioning models accessible via the positioning target wireless device 1102 (e.g., the positioning target wireless device 1102 is capable of transmitting reference measurements to a network entity with the set of positioning models), or a set of positioning models accessible via the network entity 1106 (e.g., the network entity 1106 is capable of transmitting reference measurements received from the positioning target wireless device 1102 to a network entity with the set of positioning models). In some aspects, the network entity 1106 may select a subset of referencing models (e.g., referencing models associated with the greatest accuracy metrics) for a set of positioning models that the positioning target wireless device 1102 is capable of handling based on the measurement capability 1110.

The network entity 1106 may transmit a measurement configuration 1114 to the positioning target wireless device 1102. The positioning target wireless device 1102 may receive the measurement configuration 1114 from the network entity 1106. The network entity 1106 may transmit an LPP message that includes the measurement configuration 1114. For example, the network entity 1106 may transmit an LPP broadcast, an LPP location request, or LPP assistance data that includes the measurement configuration 1114. The network entity 1106 may transmit the measurement configuration 1114 as part of a provide location information request, as part of an assistance data exchange, as part of an assistance information exchange, as broadcast information (e.g., a posSIB), as part of a MAC-CE, or as part of DCI transmitted to the positioning target wireless device 1102.

The measurement configuration 1114 may include one or more indicators for the positioning target wireless device 1102 to perform referencing on the set of positioning signals 1122. The measurement configuration 1114 may include an indicator of conditions for the positioning target wireless device 1102 to use to determine whether to perform an adaptation decision. In other words, the measurement configuration 1114 may include a set of conditions, where each of the set of conditions is associated with an adaptation decision and a referencing type (e.g., select a reference timing point of a reference signal with the highest probability LOS state if the LOS probability of a set of reference signals is less than or equal to a threshold value). The measurement configuration 1114 may indicate which referencing indicators the positioning target wireless device 1102 may indicate to the network entity 1106 in the set of measurement reports 1128. The referencing indicator may include an ID of the referencing method used by the positioning target wireless device 1102, IDs of associated conditions and adaptation decisions, an indicator of which positioning models the positioning target wireless device 1102 suggests using, and/or an indicator of which input layers the positioning target wireless device 1102 suggests using.

At 1116, the network entity 1106 may configure positioning for the positioning target wireless device 1102 and the set of positioning neighbor wireless devices 1104. The configuration may include a configuration for the set of positioning neighbor wireless devices 1104 to transmit a set of positioning signals 1122 at the positioning target wireless device 1102, and for the positioning target wireless device 1102 to measure the set of positioning signals 1122 received from the set of positioning neighbor wireless devices 1104 for a set of positioning models.

The network entity 1106 may transmit a set of positioning configurations 1118 at the positioning target wireless device 1102. The positioning target wireless device 1102 may receive the set of positioning configurations 1118 from the network entity 1106. The network entity may transmit a set of positioning configurations 1120 at the set of positioning neighbor wireless devices 1104. The set of positioning neighbor wireless devices 1104 may receive the set of positioning configurations 1120 from the network entity 1106. In some aspects, the network entity 1106 may transmit the measurement configuration 1114 and the set of positioning configurations 1118 to the positioning target wireless device 1102 in a single set of configurations transmitted to the positioning target wireless device 1102. In some aspects, the network entity 1106 may transmit the measurement configuration 1114 and the set of positioning configurations 1118 to the positioning target wireless device 1102 in multiple transmissions to the positioning target wireless device 1102.

The set of positioning neighbor wireless devices 1104 may transmit the signals 1122 at the positioning target wireless device 1102 based on the set of positioning configurations 1120 received from the network entity 1106. The set of positioning signals 1122 may include a set of positioning RSs, for example SRSs, PRSs, and/or SSBs.

At 1124, the positioning target wireless device 1102 may measure the set of positioning signals 1122 received from the set of positioning neighbor wireless devices 1104. At 1126, the positioning target wireless device 1102 may reference one or more of the set of measured positioning signals based on the measurement configuration 1114. The positioning target wireless device 1102 may apply multiple types of referencing to a set of positioning signal measurements, for example a reference timing method and a reference magnitude method, or may apply a single type of referencing to the set of positioning signal measurements, for example a reference timing method.

The positioning target wireless device 1102 may transmit a set of measurement reports 1128 to the network entity 1106. The network entity 1106 may receive the set of measurement reports 1128 from the positioning target wireless device 1102. The set of measurement reports 1128 may include an indicator of at least some of the referenced measurements referenced at 1126. The positioning target wireless device 1102 may select which measurements to transmit based on the measurement configuration 1114. The positioning target wireless device 1102 may select which measurements to transmit based on a set of positioning models that are indicated by the measurement configuration 1114. In some aspects, the set of measurement reports 1128 may include an indicator of a label, for example a known location of the positioning target wireless device 1102. For example, the positioning target wireless device 1102 may be a PRU with a known location.

At 1130, the network entity 1106 may train a set of positioning models based on the referenced positioning signals. The network entity 1106 may input the referenced measurements into the set of positioning models based on a referencing indicator indicated by the set of measurement reports 1128. For example, the network entity 1106 may use the referencing indicator as a selection ID for a positioning model, the network entity 1106 may select a set of positioning models based on the referencing indicator, and/or the network entity 1106 may select an input layer of a set of positioning models based on the referencing indicator.

In some aspects, the network entity 1106 may aggregate a set of referenced measurements from a plurality of wireless devices to input into a set of positioning models. The set of referenced measurements may be referenced using a same referencing method indicated by measurement configurations transmitted by the network entity 1106. The set of referenced measurements may be referenced using the same set of conditions and adaptation decisions indicated by measurement configurations transmitted by the network entity 1106. In some aspects, the set of referenced measurements may be referenced using different referencing methods, for example where a set of positioning models may be configured to accept inputs that have been referenced using a plurality of referencing methods.

In some aspects, the network entity 1106 may transmit the referenced measurements to another network entity, for example an OTT server with a set of positioning models. In such aspects, the network entity 1106 may also transmit the referencing indicator. In some aspects, the network entity 1106 may aggregate a set of referenced measurements from a plurality of wireless devices before forwarding the aggregated referenced measurements to another network entity. The network entity 1106 may calculate a new referencing indicator (e.g., an indicator that identifies a plurality of specified referencing models), or may aggregate referencing indicators to transmit to the other network entity (e.g., a vector of referencing indicators).

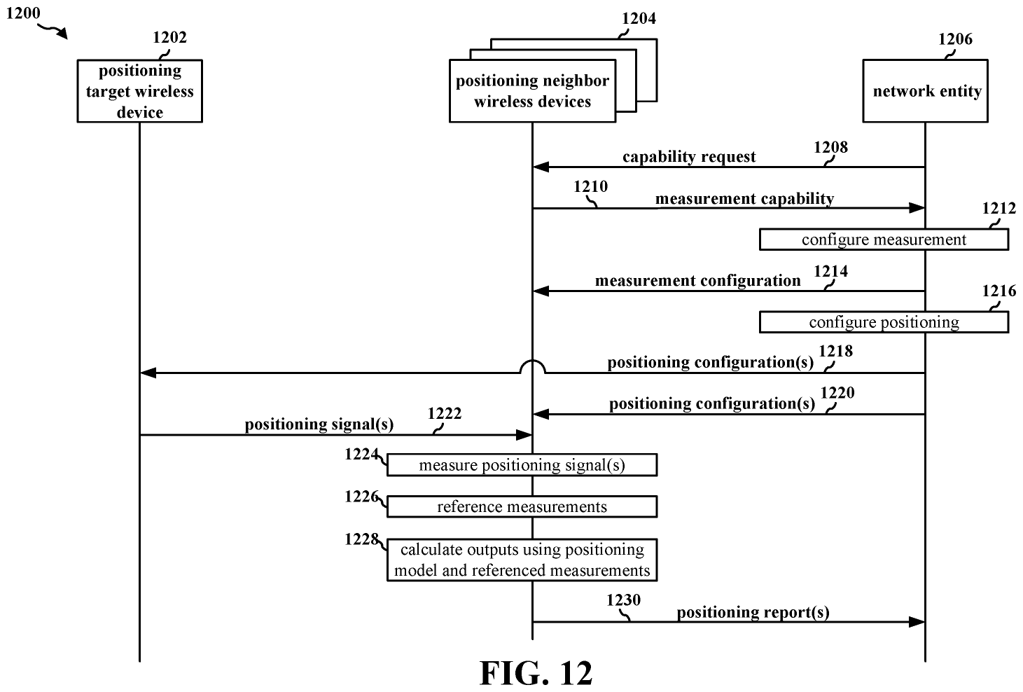

FIG. 12 is a connection flow diagram 1200 illustrating an example of a network entity 1206 configured to configure measurements of a set of positioning signals (e.g., SRS, PRS, SSB) for a positioning target wireless device 1202. The positioning target wireless device 1202 may be a UE or a PRU. The set of positioning neighbor wireless devices 1204 may include a set of base stations and/or a set of TRPs. The network entity 1206 may include an LMF or a set of location servers.

The network entity 1206 may transmit a capability request 1208 to at least one of the set of positioning neighbor wireless devices 1204. The at least one of the set of positioning neighbor wireless devices 1204 may receive the capability request 1208 from the network entity 1206. The capability request 1208 may include an indicator of a request by the network entity 1206 for an indication of capabilities of the at least one of the set of positioning neighbor wireless devices 1204 to support a plurality of referencing methods. In other words, the capability request 1208 may request the at least one of the set of positioning neighbor wireless devices 1204 to indicate a set of capabilities and a set of adaptation decisions that the at least one of the set of positioning neighbor wireless devices 1204 may have with respect to referencing methods. The network entity 1206 may transmit an NRPP message including the capability request 1208. For example, the network entity 1206 may transmit the capability request 1208 as part of NRPPa TRP information messaging between the network entity 1206 and the set of positioning neighbor wireless devices 1204. The network entity 1206 may transmit the capability request 1208 as part of a TRP information exchange procedure between the set of positioning neighbor wireless devices 1204 and the network entity 1206.

At least one of the set of positioning neighbor wireless devices 1204 may transmit a measurement capability 1210 to the network entity 1206. The network entity 1206 may receive the measurement capability 1210 from the at least one of the set of positioning neighbor wireless devices 1204. The at least one of the set of positioning neighbor wireless devices 1204 may transmit an NRPP message that includes the measurement capability 1210. For example, the at least one of the set of positioning neighbor wireless devices 1204 may transmit the measurement capability 1210 as part of NRPPa TRP information messaging between the network entity 1206 and the set of positioning neighbor wireless devices 1204. The at least one of the set of positioning neighbor wireless devices 1204 may transmit the measurement capability 1210 as part of a TRP information exchange procedure between the set of positioning neighbor wireless devices 1204 and the network entity 1206. The measurement capability 1210 may include an indicator of the capability of the at least one of the set of positioning neighbor wireless devices 1204 to select one of a set of referencing methods to reference a set of measurements of positioning signals. For example, the capability may indicate which referencing methods the at least one of the set of positioning neighbor wireless devices 1204 may use (e.g., reference timing point, reference power point, reference magnitude point, reference phase point), how the at least one of the set of positioning neighbor wireless devices 1204 may select a reference signal (e.g., first arrival path, strongest SINR sample), what conditions the at least one of the set of positioning neighbor wireless devices 1204 may use to select an adaptation decision, which adaptation decisions the at least one of the set of positioning neighbor wireless devices 1204 may use, which referencing indicators the at least one of the set of positioning neighbor wireless devices 1204 may calculate, how the at least one of the set of positioning neighbor wireless devices 1204 may format a report, and/or which positioning models are at the at least one of the set of positioning neighbor wireless devices 1204.

At 1212, the network entity 1206 may configure a measurement of the set of positioning signals 1222 by at least one of the set of positioning neighbor wireless devices 1204. In some aspects, the network entity 1206 may configure the measurement of the set of positioning signals 1222 based on a set of standards. In some aspects, the network entity 1206 may configure the measurement of the set of positioning signals 1222 based on the measurement capability 1210. For example, the network entity 1206 may configure referencing by at least one of the set of positioning neighbor wireless devices 1204 to satisfy the indicated measurement capability of the at least one of the set of positioning neighbor wireless devices 1204. In some aspects, the network entity 1206 may configure referencing based on a set of positioning models at the at least one of the set of positioning neighbor wireless devices 1204 (which may be indicated by the measurement capability 1210), based on a set of positioning models at the network entity 1206, a set of positioning models accessible via at least one of the set of positioning neighbor wireless devices 1204 (e.g., at least one of the set of positioning neighbor wireless devices 1204 may be capable of transmitting reference measurements to a network entity with the set of positioning models), or a set of positioning models accessible via the network entity 1206 (e.g., the network entity 1206 is capable of transmitting reference measurements received from at least one of the set of positioning neighbor wireless devices 1204 to a network entity with the set of positioning models). In some aspects, the network entity 1206 may select a subset of referencing models (e.g., referencing models associated with the greatest accuracy metrics) for a set of positioning models that the at least one of the set of positioning neighbor wireless devices 1204 is capable of handling based on the measurement capability 1210. In some aspects, the network entity 1206 may configure a common measurement configuration for each of the set of positioning neighbor wireless devices 1204.

The network entity 1206 may transmit a measurement configuration 1214 to at least one of the set of positioning neighbor wireless devices 1204. The at least one of the set of positioning neighbor wireless devices 1204 may receive the measurement configuration 1214 from the network entity 1206. The network entity 1206 may transmit an NRPP message that includes the measurement configuration 1214. For example, the network entity 1206 may transmit an NRPPa assistance information message that includes the measurement configuration 1214. The network entity 1206 may transmit the measurement configuration 1214 as part of a provide location information request, as part of an assistance data exchange, as part of an assistance information exchange, as broadcast information (e.g., a posSIB), or as part of a MAC-CE transmitted to the set of positioning neighbor wireless devices 1204.

The measurement configuration 1214 may include one or more indicators for at least one of the set of positioning neighbor wireless devices 1204 to perform referencing on the set of positioning signals 1222. The measurement configuration 1214 may include an indicator of conditions for the at least one of the set of positioning neighbor wireless devices 1204 to use to determine whether to perform an adaptation decision. In other words, the measurement configuration 1214 may include a set of conditions, where each of the set of conditions is associated with an adaptation decision and a referencing type (e.g., select a reference timing point of a reference signal with the highest probability LOS state if the LOS probability of a set of reference signals is less than or equal to a threshold value). The measurement configuration 1214 may indicate which referencing indicators the at least one of the set of positioning neighbor wireless devices 1204 may use to input references measurements into a set of positioning models at the at least one of the set of positioning neighbor wireless devices 1204. The referencing indicator may include an ID of the referencing method used by the at least one of the set of positioning neighbor wireless devices 1204, IDs of associated conditions and adaptation decisions, an indicator of which positioning models the at least one of the set of positioning neighbor wireless devices 1204 uses at 1228, and/or an indicator of which input layers the at least one of the set of positioning neighbor wireless devices 1204 uses at 1228.

At 1216, the network entity 1206 may configure positioning for the positioning target wireless device 1202 and the set of positioning neighbor wireless devices 1204. The configuration may include a configuration for the positioning target wireless device 1202 to transmit a set of positioning signals 1222 at the set of positioning neighbor wireless devices 1204 to transmit, and for the set of positioning neighbor wireless devices 1204 to measure the set of positioning signals 1222 received from the positioning target wireless device 1202 for a set of positioning models. In some aspects, the network entity 1206 may configure a plurality of wireless devices, for example a set of UEs and/or PRUs in a zone, to transmit the set of positioning signals at the set of positioning neighbor wireless devices 1204.

The network entity 1206 may transmit a set of positioning configurations 1218 at the positioning target wireless device 1202. The positioning target wireless device 1202 may receive the set of positioning configurations 1218 from the network entity 1206. The network entity may transmit a set of positioning configurations 1220 at the set of positioning neighbor wireless devices 1204. The set of positioning neighbor wireless devices 1204 may receive the set of positioning configurations 1220 from the network entity 1206. In some aspects, the network entity 1206 may transmit the measurement configuration 1214 and the set of positioning configurations 1220 to the set of positioning neighbor wireless devices 1204, or at least one of the set of positioning neighbor wireless devices 1204 in a single set of transmitted configurations. In some aspects, the network entity 1206 may transmit the measurement configuration 1214 and the set of positioning configurations 1220 to the set of positioning neighbor wireless devices 1204 in multiple transmissions.

The positioning target wireless device 1202 may transmit the signals 1222 at the set of positioning neighbor wireless devices 1204 based on the set of positioning configurations 1218 received from the network entity 1206. The set of positioning signals 1222 may include a set of positioning RSs, for example SRSs, PRSs, and/or SSBs.

At 1224, the set of positioning neighbor wireless devices 1204 may measure the set of positioning signals 1222 received from the positioning target wireless device 1202. At 1226, at least one of the set of positioning neighbor wireless devices 1204 may reference one or more of the set of measured positioning signals based on the measurement configuration 1214. The at least one of the set of positioning neighbor wireless devices 1204 may apply multiple types of referencing to a set of positioning signal measurements, for example a reference timing method and a reference magnitude method, or may apply a single type of referencing to the set of positioning signal measurements, for example a reference timing method.

At 1228, at least one of the set of positioning neighbor wireless devices 1204 may calculate a set of outputs using a set of positioning models based on the referenced positioning signals. The at least one of the set of positioning neighbor wireless devices 1204 may input the referenced measurements into the set of positioning models based on a calculated referencing indicator. For example, the at least one of the set of positioning neighbor wireless devices 1204 may use the referencing indicator as a selection ID for a positioning model, the at least one of the set of positioning neighbor wireless devices 1204 may select a set of positioning models based on the referencing indicator, and/or the at least one of the set of positioning neighbor wireless devices 1204 may select an input layer of a set of positioning models based on the referencing indicator. At least one of the set of positioning neighbor wireless devices 1204 may transmit a set of positioning reports 1230 to the network entity 1206 based on the calculation at 1228. The network entity 1206 may receive the set of positioning reports 1230 from at least one of the set of positioning neighbor wireless devices 1204. The set of positioning reports 1230 may include at least some of the outputs from the positioning model calculation(s) at 1228.

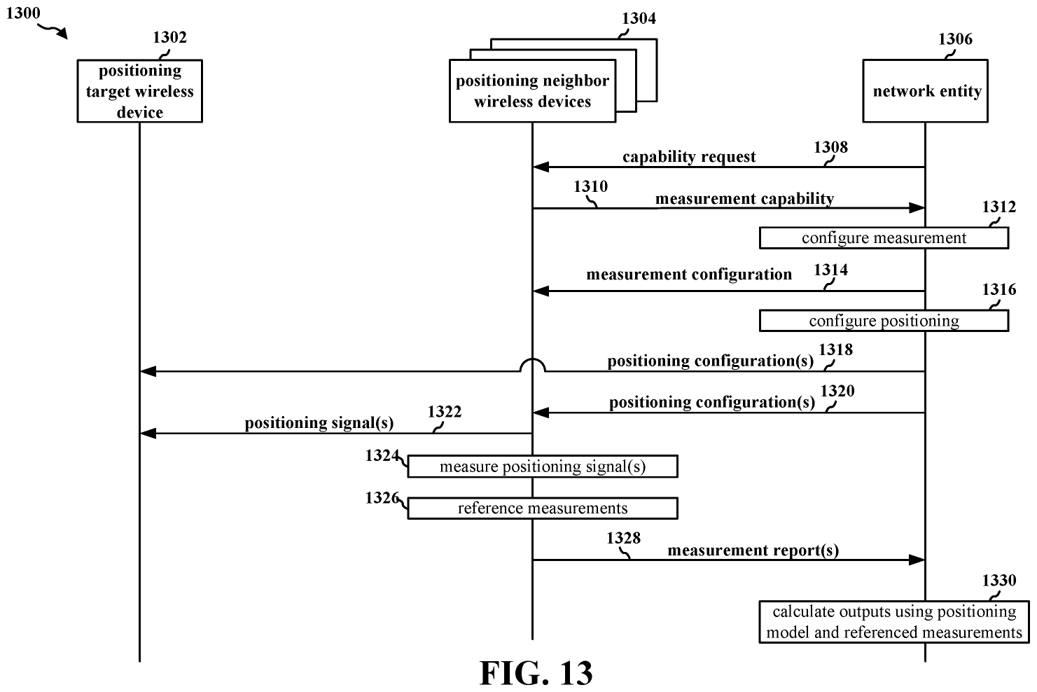

FIG. 13 is a connection flow diagram 1300 illustrating an example of a network entity 1306 configured to configure measurements of a set of positioning signals (e.g., SRS, PRS, SSB) for a positioning target wireless device 1302. The positioning target wireless device 1302 may be a UE or a PRU. The set of positioning neighbor wireless devices 1304 may include a set of base stations and/or a set of TRPs. The network entity 1306 may include an LMF or a set of location servers.

The network entity 1306 may transmit a capability request 1308 to at least one of the set of positioning neighbor wireless devices 1304. The at least one of the set of positioning neighbor wireless devices 1304 may receive the capability request 1308 from the network entity 1306. The capability request 1308 may include an indicator of a request by the network entity 1306 for an indication of capabilities of the at least one of the set of positioning neighbor wireless devices 1304 to support a plurality of referencing methods. In other words, the capability request 1308 may request the at least one of the set of positioning neighbor wireless devices 1304 to indicate a set of capabilities and a set of adaptation decisions that the at least one of the set of positioning neighbor wireless devices 1304 may have with respect to referencing methods. The network entity 1306 may transmit an NRPP message including the capability request 1308. For example, the network entity 1306 may transmit the capability request 1308 as part of NRPPa TRP information messaging between the network entity 1306 and the set of positioning neighbor wireless devices 1304. The network entity 1306 may transmit the capability request 1308 as part of a TRP information exchange procedure between the set of positioning neighbor wireless devices 1304 and the network entity 1306.

At least one of the set of positioning neighbor wireless devices 1304 may transmit a measurement capability 1310 to the network entity 1306. The network entity 1306 may receive the measurement capability 1310 from the at least one of the set of positioning neighbor wireless devices 1304. The at least one of the set of positioning neighbor wireless devices 1304 may transmit an NRPP message that includes the measurement capability 1310. For example, the at least one of the set of positioning neighbor wireless devices 1304 may transmit the measurement capability 1310 as part of NRPPa TRP information messaging between the network entity 1306 and the set of positioning neighbor wireless devices 1304. The at least one of the set of positioning neighbor wireless devices 1304 may transmit the measurement capability 1310 as part of a TRP information exchange procedure between the set of positioning neighbor wireless devices 1304 and the network entity 1306. The measurement capability 1310 may include an indicator of the capability of the at least one of the set of positioning neighbor wireless devices 1304 to select one of a set of referencing methods to reference a set of measurements of positioning signals. For example, the capability may indicate which referencing methods the at least one of the set of positioning neighbor wireless devices 1304 may use (e.g., reference timing point, reference power point, reference magnitude point, reference phase point), how the at least one of the set of positioning neighbor wireless devices 1304 may select a reference signal (e.g., first arrival path, strongest SINR sample), what conditions the at least one of the set of positioning neighbor wireless devices 1304 may use to select an adaptation decision, which adaptation decisions the at least one of the set of positioning neighbor wireless devices 1304 may use, which referencing indicators the at least one of the set of positioning neighbor wireless devices 1304 may calculate, how the at least one of the set of positioning neighbor wireless devices 1304 may format a report, and/or which positioning models are at the at least one of the set of positioning neighbor wireless devices 1304.

At 1312, the network entity 1306 may configure a measurement of the set of positioning signals 1322 by at least one of the set of positioning neighbor wireless devices 1304. In some aspects, the network entity 1306 may configure the measurement of the set of positioning signals 1322 based on a set of standards. In some aspects, the network entity 1306 may configure the measurement of the set of positioning signals 1322 based on the measurement capability 1310. For example, the network entity 1306 may configure referencing by at least one of the set of positioning neighbor wireless devices 1304 to satisfy the indicated measurement capability of the at least one of the set of positioning neighbor wireless devices 1304. In some aspects, the network entity 1306 may configure referencing based on a set of positioning models at the at least one of the set of positioning neighbor wireless devices 1304 (which may be indicated by the measurement capability 1310), based on a set of positioning models at the network entity 1306, a set of positioning models accessible via at least one of the set of positioning neighbor wireless devices 1304 (e.g., at least one of the set of positioning neighbor wireless devices 1304 may be capable of transmitting reference measurements to a network entity with the set of positioning models), or a set of positioning models accessible via the network entity 1306 (e.g., the network entity 1306 is capable of transmitting reference measurements received from at least one of the set of positioning neighbor wireless devices 1304 to a network entity with the set of positioning models). In some aspects, the network entity 1306 may select a subset of referencing models (e.g., referencing models associated with the greatest accuracy metrics) for a set of positioning models that the at least one of the set of positioning neighbor wireless devices 1304 is capable of handling based on the measurement capability 1310. In some aspects, the network entity 1306 may configure a common measurement configuration for each of the set of positioning neighbor wireless devices 1304.

The network entity 1306 may transmit a measurement configuration 1314 to at least one of the set of positioning neighbor wireless devices 1304. The at least one of the set of positioning neighbor wireless devices 1304 may receive the measurement configuration 1314 from the network entity 1306. The network entity 1306 may transmit an NRPP message that includes the measurement configuration 1314. For example, the network entity 1306 may transmit an NRPPa assistance information message that includes the measurement configuration 1314. The network entity 1306 may transmit the measurement configuration 1314 as part of a provide location information request, as part of an assistance data exchange, as part of an assistance information exchange, as broadcast information (e.g., a posSIB), or as part of a MAC-CE transmitted to the set of positioning neighbor wireless devices 1304.

The measurement configuration 1314 may include one or more indicators for at least one of the set of positioning neighbor wireless devices 1304 to perform referencing on the set of positioning signals 1322. The measurement configuration 1314 may include an indicator of conditions for the at least one of the set of positioning neighbor wireless devices 1304 to use to determine whether to perform an adaptation decision. In other words, the measurement configuration 1314 may include a set of conditions, where each of the set of conditions is associated with an adaptation decision and a referencing type (e.g., select a reference timing point of a reference signal with the highest probability LOS state if the LOS probability of a set of reference signals is less than or equal to a threshold value). The measurement configuration 1314 may indicate which referencing indicators the at least one of the set of positioning neighbor wireless devices 1304 may indicate to the network entity 1306 in the set of measurement reports 1328. The referencing indicator may include an ID of the referencing method used by the at least one of the set of positioning neighbor wireless devices 1304, IDs of associated conditions and adaptation decisions, an indicator of which positioning models the at least one of the set of positioning neighbor wireless devices 1304 suggests using, and/or an indicator of which input layers the at least one of the set of positioning neighbor wireless devices 1304 suggests using.

At 1316, the network entity 1306 may configure positioning for the positioning target wireless device 1302 and the set of positioning neighbor wireless devices 1304. The configuration may include a configuration for the positioning target wireless device 1302 to transmit a set of positioning signals 1322 at the set of positioning neighbor wireless devices 1304 to transmit, and for the set of positioning neighbor wireless devices 1304 to measure the set of positioning signals 1322 received from the positioning target wireless device 1302 for a set of positioning models. In some aspects, the network entity 1306 may configure a plurality of wireless devices, for example a set of UEs and/or PRUs in a zone, to transmit the set of positioning signals at the set of positioning neighbor wireless devices 1304.

The network entity 1306 may transmit a set of positioning configurations 1318 at the positioning target wireless device 1302. The positioning target wireless device 1302 may receive the set of positioning configurations 1318 from the network entity 1306. The network entity may transmit a set of positioning configurations 1320 at the set of positioning neighbor wireless devices 1304. The set of positioning neighbor wireless devices 1304 may receive the set of positioning configurations 1320 from the network entity 1306. In some aspects, the network entity 1306 may transmit the measurement configuration 1314 and the set of positioning configurations 1320 to the set of positioning neighbor wireless devices 1304, or at least one of the set of positioning neighbor wireless devices 1304 in a single set of transmitted configurations. In some aspects, the network entity 1306 may transmit the measurement configuration 1314 and the set of positioning configurations 1320 to the set of positioning neighbor wireless devices 1304 in multiple transmissions.

The positioning target wireless device 1302 may transmit the signals 1322 at the set of positioning neighbor wireless devices 1304 based on the set of positioning configurations 1318 received from the network entity 1306. The set of positioning signals 1322 may include a set of positioning RSs, for example SRSs, PRSs, and/or SSBs.

At 1324, the set of positioning neighbor wireless devices 1304 may measure the set of positioning signals 1322 received from the positioning target wireless device 1302.

At 1326, at least one of the set of positioning neighbor wireless devices 1304 may reference one or more of the set of measured positioning signals based on the measurement configuration 1314. The at least one of the set of positioning neighbor wireless devices 1304 may apply multiple types of referencing to a set of positioning signal measurements, for example a reference timing method and a reference magnitude method, or may apply a single type of referencing to the set of positioning signal measurements, for example a reference timing method.

At least one of the set of positioning neighbor wireless devices 1304 may transmit a set of measurement reports 1328 to the network entity 1306. The network entity 1306 may receive the set of measurement reports 1328 from the at least one of the set of positioning neighbor wireless devices 1304. The set of measurement reports 1328 may include an indicator of at least some of the referenced measurements referenced at 1326. The at least one of the set of positioning neighbor wireless devices 1304 may select which measurements to transmit based on the measurement configuration 1314. The at least one of the set of positioning neighbor wireless devices 1304 may select which measurements to transmit based on a set of positioning models that are indicated by the measurement configuration 1314.

At 1330, the network entity 1306 may calculate a set of outputs using a positioning model based on the referenced positioning signals. The network entity 1306 may input the referenced measurements into the set of positioning models based on a referencing indicator indicated by the set of measurement reports 1328. For example, the network entity 1306 may use the referencing indicator as a selection ID for a positioning model, the network entity 1306 may select a set of positioning models based on the referencing indicator, and/or the network entity 1306 may select an input layer of a set of positioning models based on the referencing indicator.

In some aspects, the network entity 1306 may aggregate a set of referenced measurements from a plurality of wireless devices (e.g., the entire set of positioning neighbor wireless devices 1304) to input into a set of positioning models. The set of referenced measurements may be referenced using a same referencing method indicated by measurement configurations transmitted by the network entity 1306. The set of referenced measurements may be referenced using the same set of conditions and adaptation decisions indicated by measurement configurations transmitted by the network entity 1306. In some aspects, the set of referenced measurements may be referenced using different referencing methods, for example where a set of positioning models may be configured to accept inputs that have been referenced using a plurality of referencing methods.

In some aspects, the network entity 1306 may transmit the referenced measurements to another network entity for calculating positioning outputs using a set of positioning models, for example an OTT server with a set of positioning models. In such aspects, the network entity 1306 may also transmit the referencing indicator. In some aspects, the network entity 1306 may aggregate a set of referenced measurements from a plurality of wireless devices before forwarding the aggregated referenced measurements to another network entity. The network entity 1306 may calculate a new referencing indicator (e.g., an indicator that identifies a plurality of specified referencing models), or may aggregate referencing indicators to transmit to the other network entity (e.g., a vector of referencing indicators).

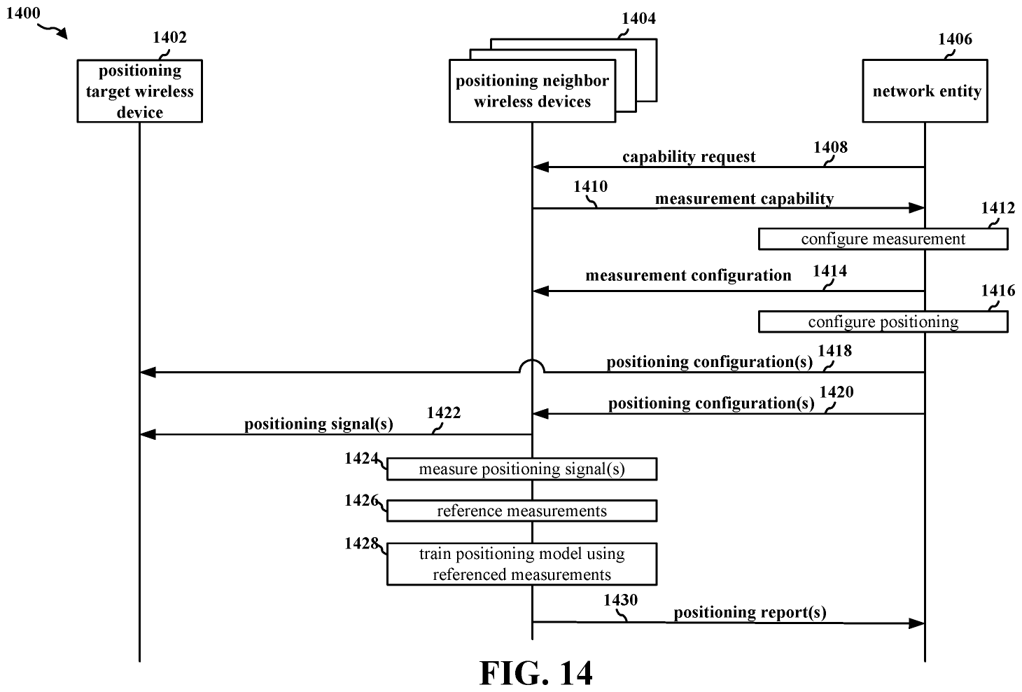

FIG. 14 is a connection flow diagram 1400 illustrating an example of a network entity 1406 configured to configure measurements of a set of positioning signals (e.g., SRS, PRS, SSB) for a positioning target wireless device 1402. The positioning target wireless device 1402 may be a UE or a PRU. The set of positioning neighbor wireless devices 1404 may include a set of base stations and/or a set of TRPs. The network entity 1406 may include an LMF or a set of location servers.

The network entity 1406 may transmit a capability request 1408 to at least one of the set of positioning neighbor wireless devices 1404. The at least one of the set of positioning neighbor wireless devices 1404 may receive the capability request 1408 from the network entity 1406. The capability request 1408 may include an indicator of a request by the network entity 1406 for an indication of capabilities of the at least one of the set of positioning neighbor wireless devices 1404 to support a plurality of referencing methods. In other words, the capability request 1408 may request the at least one of the set of positioning neighbor wireless devices 1404 to indicate a set of capabilities and a set of adaptation decisions that the at least one of the set of positioning neighbor wireless devices 1404 may have with respect to referencing methods. The network entity 1406 may transmit an NRPP message including the capability request 1408. For example, the network entity 1406 may transmit the capability request 1408 as part of NRPPa TRP information messaging between the network entity 1406 and the set of positioning neighbor wireless devices 1404. The network entity 1406 may transmit the capability request 1408 as part of a TRP information exchange procedure between the set of positioning neighbor wireless devices 1404 and the network entity 1406.

At least one of the set of positioning neighbor wireless devices 1404 may transmit a measurement capability 1410 to the network entity 1406. The network entity 1406 may receive the measurement capability 1410 from the at least one of the set of positioning neighbor wireless devices 1404. The at least one of the set of positioning neighbor wireless devices 1404 may transmit an NRPP message that includes the measurement capability 1410. For example, the at least one of the set of positioning neighbor wireless devices 1404 may transmit the measurement capability 1410 as part of NRPPa TRP information messaging between the network entity 1406 and the set of positioning neighbor wireless devices 1404. The at least one of the set of positioning neighbor wireless devices 1404 may transmit the measurement capability 1410 as part of a TRP information exchange procedure between the set of positioning neighbor wireless devices 1404 and the network entity 1406. The measurement capability 1410 may include an indicator of the capability of the at least one of the set of positioning neighbor wireless devices 1404 to select one of a set of referencing methods to reference a set of measurements of positioning signals. For example, the capability may indicate which referencing methods the at least one of the set of positioning neighbor wireless devices 1404 may use (e.g., reference timing point, reference power point, reference magnitude point, reference phase point), how the at least one of the set of positioning neighbor wireless devices 1404 may select a reference signal (e.g., first arrival path, strongest SINR sample), what conditions the at least one of the set of positioning neighbor wireless devices 1404 may use to select an adaptation decision, which adaptation decisions the at least one of the set of positioning neighbor wireless devices 1404 may use, which referencing indicators the at least one of the set of positioning neighbor wireless devices 1404 may calculate, how the at least one of the set of positioning neighbor wireless devices 1404 may format a report, and/or which positioning models are at the at least one of the set of positioning neighbor wireless devices 1404.

At 1412, the network entity 1406 may configure a measurement of the set of positioning signals 1422 by at least one of the set of positioning neighbor wireless devices 1404. In some aspects, the network entity 1406 may configure the measurement of the set of positioning signals 1422 based on a set of standards. In some aspects, the network entity 1406 may configure the measurement of the set of positioning signals 1422 based on the measurement capability 1410. For example, the network entity 1406 may configure referencing by at least one of the set of positioning neighbor wireless devices 1404 to satisfy the indicated measurement capability of the at least one of the set of positioning neighbor wireless devices 1404. In some aspects, the network entity 1406 may configure referencing based on a set of positioning models at the at least one of the set of positioning neighbor wireless devices 1404 (which may be indicated by the measurement capability 1410), based on a set of positioning models at the network entity 1406, a set of positioning models accessible via at least one of the set of positioning neighbor wireless devices 1404 (e.g., at least one of the set of positioning neighbor wireless devices 1404 may be capable of transmitting reference measurements to a network entity with the set of positioning models), or a set of positioning models accessible via the network entity 1406 (e.g., the network entity 1406 is capable of transmitting reference measurements received from at least one of the set of positioning neighbor wireless devices 1404 to a network entity with the set of positioning models). In some aspects, the network entity 1406 may select a subset of referencing models (e.g., referencing models associated with the greatest accuracy metrics) for a set of positioning models that the at least one of the set of positioning neighbor wireless devices 1404 is capable of handling based on the measurement capability 1410. In some aspects, the network entity 1406 may configure a common measurement configuration for each of the set of positioning neighbor wireless devices 1404.

The network entity 1406 may transmit a measurement configuration 1414 to at least one of the set of positioning neighbor wireless devices 1404. The at least one of the set of positioning neighbor wireless devices 1404 may receive the measurement configuration 1414 from the network entity 1406. The network entity 1406 may transmit an NRPP message that includes the measurement configuration 1414. For example, the network entity 1406 may transmit an NRPPa assistance information message that includes the measurement configuration 1414. The network entity 1406 may transmit the measurement configuration 1414 as part of a provide location information request, as part of an assistance data exchange, as part of an assistance information exchange, as broadcast information (e.g., a posSIB), or as part of a MAC-CE transmitted to the set of positioning neighbor wireless devices 1404.

The measurement configuration 1414 may include one or more indicators for at least one of the set of positioning neighbor wireless devices 1404 to perform referencing on the set of positioning signals 1422. The measurement configuration 1414 may include an indicator of conditions for the at least one of the set of positioning neighbor wireless devices 1404 to use to determine whether to perform an adaptation decision. In other words, the measurement configuration 1414 may include a set of conditions, where each of the set of conditions is associated with an adaptation decision and a referencing type (e.g., select a reference timing point of a reference signal with the highest probability LOS state if the LOS probability of a set of reference signals is less than or equal to a threshold value). The measurement configuration 1414 may indicate which referencing indicators the at least one of the set of positioning neighbor wireless devices 1404 may use to input references measurements into a set of positioning models at the at least one of the set of positioning neighbor wireless devices 1404. The referencing indicator may include an ID of the referencing method used by the at least one of the set of positioning neighbor wireless devices 1404, IDs of associated conditions and adaptation decisions, an indicator of which positioning models the at least one of the set of positioning neighbor wireless devices 1404 uses at 1428, and/or an indicator of which input layers the at least one of the set of positioning neighbor wireless devices 1404 uses at 1428.

At 1416, the network entity 1406 may configure positioning for the positioning target wireless device 1402 and the set of positioning neighbor wireless devices 1404. The configuration may include a configuration for the positioning target wireless device 1402 to transmit a set of positioning signals 1422 at the set of positioning neighbor wireless devices 1404 to transmit, and for the set of positioning neighbor wireless devices 1404 to measure the set of positioning signals 1422 received from the positioning target wireless device 1402 for a set of positioning models. In some aspects, the network entity 1406 may configure a plurality of wireless devices, for example a set of UEs and/or PRUs in a zone, to transmit the set of positioning signals at the set of positioning neighbor wireless devices 1404.

The network entity 1406 may transmit a set of positioning configurations 1418 at the positioning target wireless device 1402. The positioning target wireless device 1402 may receive the set of positioning configurations 1418 from the network entity 1406. The network entity may transmit a set of positioning configurations 1420 at the set of positioning neighbor wireless devices 1404. The set of positioning neighbor wireless devices 1404 may receive the set of positioning configurations 1420 from the network entity 1406. In some aspects, the network entity 1406 may transmit the measurement configuration 1414 and the set of positioning configurations 1420 to the set of positioning neighbor wireless devices 1404, or at least one of the set of positioning neighbor wireless devices 1404 in a single set of transmitted configurations. In some aspects, the network entity 1406 may transmit the measurement configuration 1414 and the set of positioning configurations 1420 to the set of positioning neighbor wireless devices 1404 in multiple transmissions.

The positioning target wireless device 1402 may transmit the signals 1422 at the set of positioning neighbor wireless devices 1404 based on the set of positioning configurations 1418 received from the network entity 1406. The set of positioning signals 1422 may include a set of positioning RSs, for example SRSs, PRSs, and/or SSBs.

At 1424, the set of positioning neighbor wireless devices 1404 may measure the set of positioning signals 1422 received from the positioning target wireless device 1402. At 1426, at least one of the set of positioning neighbor wireless devices 1404 may reference one or more of the set of measured positioning signals based on the measurement configuration 1414. The at least one of the set of positioning neighbor wireless devices 1404 may apply multiple types of referencing to a set of positioning signal measurements, for example a reference timing method and a reference magnitude method, or may apply a single type of referencing to the set of positioning signal measurements, for example a reference timing method.

At 1428, at least one of the set of positioning neighbor wireless devices 1404 may train a set of positioning models based on the referenced positioning signals. The at least one of the set of positioning neighbor wireless devices 1404 may input the referenced measurements into the set of positioning models based on a calculated referencing indicator. For example, the at least one of the set of positioning neighbor wireless devices 1404 may use the referencing indicator as a selection ID for a positioning model, the at least one of the set of positioning neighbor wireless devices 1404 may select a set of positioning models based on the referencing indicator, and/or the at least one of the set of positioning neighbor wireless devices 1404 may select an input layer of a set of positioning models based on the referencing indicator. The at least one of the set of positioning neighbor wireless devices 1404 may use a known location of the positioning target wireless device 1402 as an input to the set of positioning models. At least one of the set of positioning neighbor wireless devices 1404 may transmit a set of positioning reports 1430 to the network entity 1406 based on the calculation at 1428. The network entity 1406 may receive the set of positioning reports 1430 from at least one of the set of positioning neighbor wireless devices 1404. The set of positioning reports 1430 may include an indicator that the at least one of the set of positioning neighbor wireless devices 1404 trained a set of positioning models based on the referenced positioning signals.

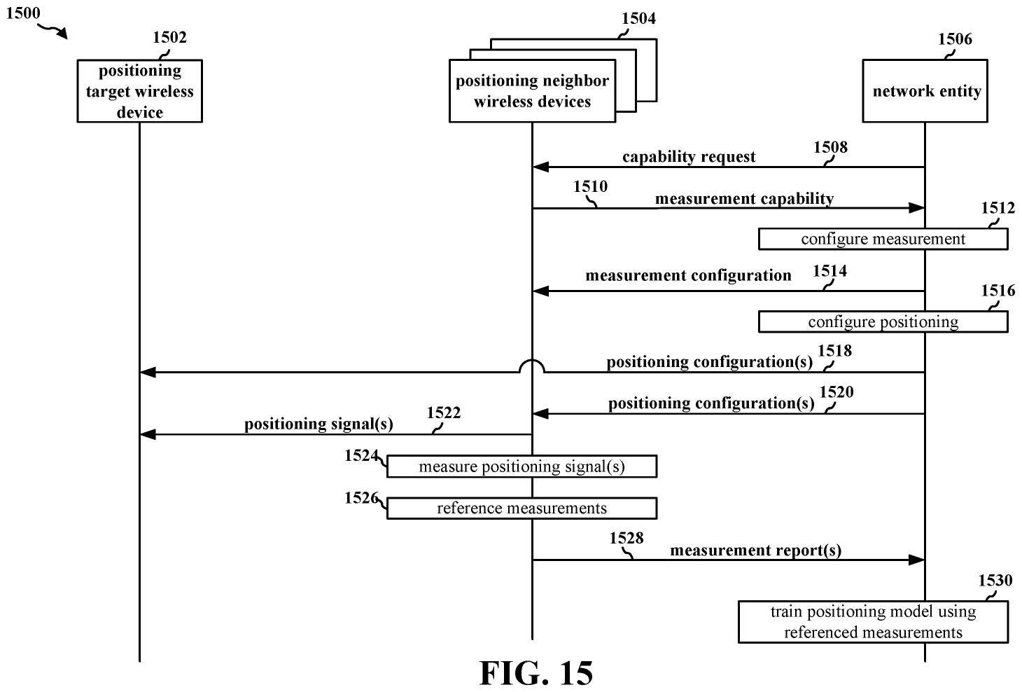

FIG. 15 is a connection flow diagram 1500 illustrating an example of a network entity 1506 configured to configure measurements of a set of positioning signals (e.g., SRS, PRS, SSB) for a positioning target wireless device 1502. The positioning target wireless device 1502 may be a UE or a PRU. The set of positioning neighbor wireless devices 1504 may include a set of base stations and/or a set of TRPs. The network entity 1506 may include an LMF or a set of location servers.

The network entity 1506 may transmit a capability request 1508 to at least one of the set of positioning neighbor wireless devices 1504. The at least one of the set of positioning neighbor wireless devices 1504 may receive the capability request 1508 from the network entity 1506. The capability request 1508 may include an indicator of a request by the network entity 1506 for an indication of capabilities of the at least one of the set of positioning neighbor wireless devices 1504 to support a plurality of referencing methods. In other words, the capability request 1508 may request the at least one of the set of positioning neighbor wireless devices 1504 to indicate a set of capabilities and a set of adaptation decisions that the at least one of the set of positioning neighbor wireless devices 1504 may have with respect to referencing methods. The network entity 1506 may transmit an NRPP message including the capability request 1508. For example, the network entity 1506 may transmit the capability request 1508 as part of NRPPa TRP information messaging between the network entity 1506 and the set of positioning neighbor wireless devices 1504. The network entity 1506 may transmit the capability request 1508 as part of a TRP information exchange procedure between the set of positioning neighbor wireless devices 1504 and the network entity 1506.

At least one of the set of positioning neighbor wireless devices 1504 may transmit a measurement capability 1510 to the network entity 1506. The network entity 1506 may receive the measurement capability 1510 from the at least one of the set of positioning neighbor wireless devices 1504. The at least one of the set of positioning neighbor wireless devices 1504 may transmit an NRPP message that includes the measurement capability 1510. For example, the at least one of the set of positioning neighbor wireless devices 1504 may transmit the measurement capability 1510 as part of NRPPa TRP information messaging between the network entity 1506 and the set of positioning neighbor wireless devices 1504. The at least one of the set of positioning neighbor wireless devices 1504 may transmit the measurement capability 1510 as part of a TRP information exchange procedure between the set of positioning neighbor wireless devices 1504 and the network entity 1506. The measurement capability 1510 may include an indicator of the capability of the at least one of the set of positioning neighbor wireless devices 1504 to select one of a set of referencing methods to reference a set of measurements of positioning signals. For example, the capability may indicate which referencing methods the at least one of the set of positioning neighbor wireless devices 1504 may use (e.g., reference timing point, reference power point, reference magnitude point, reference phase point), how the at least one of the set of positioning neighbor wireless devices 1504 may select a reference signal (e.g., first arrival path, strongest SINR sample), what conditions the at least one of the set of positioning neighbor wireless devices 1504 may use to select an adaptation decision, which adaptation decisions the at least one of the set of positioning neighbor wireless devices 1504 may use, which referencing indicators the at least one of the set of positioning neighbor wireless devices 1504 may calculate, how the at least one of the set of positioning neighbor wireless devices 1504 may format a report, and/or which positioning models are at the at least one of the set of positioning neighbor wireless devices 1504.

At 1512, the network entity 1506 may configure a measurement of the set of positioning signals 1522 by at least one of the set of positioning neighbor wireless devices 1504. In some aspects, the network entity 1506 may configure the measurement of the set of positioning signals 1522 based on a set of standards. In some aspects, the network entity 1506 may configure the measurement of the set of positioning signals 1522 based on the measurement capability 1510. For example, the network entity 1506 may configure referencing by at least one of the set of positioning neighbor wireless devices 1504 to satisfy the indicated measurement capability of the at least one of the set of positioning neighbor wireless devices 1504. In some aspects, the network entity 1506 may configure referencing based on a set of positioning models at the at least one of the set of positioning neighbor wireless devices 1504 (which may be indicated by the measurement capability 1510), based on a set of positioning models at the network entity 1506, a set of positioning models accessible via at least one of the set of positioning neighbor wireless devices 1504 (e.g., at least one of the set of positioning neighbor wireless devices 1504 may be capable of transmitting reference measurements to a network entity with the set of positioning models), or a set of positioning models accessible via the network entity 1506 (e.g., the network entity 1506 is capable of transmitting reference measurements received from at least one of the set of positioning neighbor wireless devices 1504 to a network entity with the set of positioning models). In some aspects, the network entity 1506 may select a subset of referencing models (e.g., referencing models associated with the greatest accuracy metrics) for a set of positioning models that the at least one of the set of positioning neighbor wireless devices 1504 is capable of handling based on the measurement capability 1510. In some aspects, the network entity 1506 may configure a common measurement configuration for each of the set of positioning neighbor wireless devices 1504.

The network entity 1506 may transmit a measurement configuration 1514 to at least one of the set of positioning neighbor wireless devices 1504. The at least one of the set of positioning neighbor wireless devices 1504 may receive the measurement configuration 1514 from the network entity 1506. The network entity 1506 may transmit an NRPP message that includes the measurement configuration 1514. For example, the network entity 1506 may transmit an NRPPa assistance information message that includes the measurement configuration 1514. The network entity 1506 may transmit the measurement configuration 1514 as part of a provide location information request, as part of an assistance data exchange, as part of an assistance information exchange, as broadcast information (e.g., a posSIB), or as part of a MAC-CE transmitted to the set of positioning neighbor wireless devices 1504.

The measurement configuration 1514 may include one or more indicators for at least one of the set of positioning neighbor wireless devices 1504 to perform referencing on the set of positioning signals 1522. The measurement configuration 1514 may include an indicator of conditions for the at least one of the set of positioning neighbor wireless devices 1504 to use to determine whether to perform an adaptation decision. In other words, the measurement configuration 1514 may include a set of conditions, where each of the set of conditions is associated with an adaptation decision and a referencing type (e.g., select a reference timing point of a reference signal with the highest probability LOS state if the LOS probability of a set of reference signals is less than or equal to a threshold value). The measurement configuration 1514 may indicate which referencing indicators the at least one of the set of positioning neighbor wireless devices 1504 may indicate to the network entity 1506 in the set of measurement reports 1528. The referencing indicator may include an ID of the referencing method used by the at least one of the set of positioning neighbor wireless devices 1504, IDs of associated conditions and adaptation decisions, an indicator of which positioning models the at least one of the set of positioning neighbor wireless devices 1504 suggests using, and/or an indicator of which input layers the at least one of the set of positioning neighbor wireless devices 1504 suggests using.

At 1516, the network entity 1506 may configure positioning for the positioning target wireless device 1502 and the set of positioning neighbor wireless devices 1504. The configuration may include a configuration for the positioning target wireless device 1502 to transmit a set of positioning signals 1522 at the set of positioning neighbor wireless devices 1504 to transmit, and for the set of positioning neighbor wireless devices 1504 to measure the set of positioning signals 1522 received from the positioning target wireless device 1502 for a set of positioning models. In some aspects, the network entity 1506 may configure a plurality of wireless devices, for example a set of UEs and/or PRUs in a zone, to transmit the set of positioning signals at the set of positioning neighbor wireless devices 1504.

The network entity 1506 may transmit a set of positioning configurations 1518 at the positioning target wireless device 1502. The positioning target wireless device 1502 may receive the set of positioning configurations 1518 from the network entity 1506. The network entity may transmit a set of positioning configurations 1520 at the set of positioning neighbor wireless devices 1504. The set of positioning neighbor wireless devices 1504 may receive the set of positioning configurations 1520 from the network entity 1506. In some aspects, the network entity 1506 may transmit the measurement configuration 1514 and the set of positioning configurations 1520 to the set of positioning neighbor wireless devices 1504, or at least one of the set of positioning neighbor wireless devices 1504 in a single set of transmitted configurations. In some aspects, the network entity 1506 may transmit the measurement configuration 1514 and the set of positioning configurations 1520 to the set of positioning neighbor wireless devices 1504 in multiple transmissions.

The positioning target wireless device 1502 may transmit the signals 1522 at the set of positioning neighbor wireless devices 1504 based on the set of positioning configurations 1518 received from the network entity 1506. The set of positioning signals 1522 may include a set of positioning RSs, for example SRSs, PRSs, and/or SSBs.

At 1524, the set of positioning neighbor wireless devices 1504 may measure the set of positioning signals 1522 received from the positioning target wireless device 1502. At 1526, at least one of the set of positioning neighbor wireless devices 1504 may reference one or more of the set of measured positioning signals based on the measurement configuration 1514. The at least one of the set of positioning neighbor wireless devices 1504 may apply multiple types of referencing to a set of positioning signal measurements, for example a reference timing method and a reference magnitude method, or may apply a single type of referencing to the set of positioning signal measurements, for example a reference timing method.

At least one of the set of positioning neighbor wireless devices 1504 may transmit a set of measurement reports 1528 to the network entity 1506. The network entity 1506 may receive the set of measurement reports 1528 from the at least one of the set of positioning neighbor wireless devices 1504. The set of measurement reports 1528 may include an indicator of at least some of the referenced measurements referenced at 1526. The at least one of the set of positioning neighbor wireless devices 1504 may select which measurements to transmit based on the measurement configuration 1514. The at least one of the set of positioning neighbor wireless devices 1504 may select which measurements to transmit based on a set of positioning models that are indicated by the measurement configuration 1514.

At 1530, the network entity 1506 may train a set of positioning models based on the referenced positioning signals. The network entity 1506 may input the referenced measurements into the set of positioning models based on a referencing indicator indicated by the set of measurement reports 1528. For example, the network entity 1506 may use the referencing indicator as a selection ID for a positioning model, the network entity 1506 may select a set of positioning models based on the referencing indicator, and/or the network entity 1506 may select an input layer of a set of positioning models based on the referencing indicator. The network entity 1506 may train the set of positioning models based on a known location of the positioning target wireless device 1502. The set of measurement reports 1528 may indicate the known location of the positioning target wireless device 1502.

In some aspects, the network entity 1506 may aggregate a set of referenced measurements from a plurality of wireless devices (e.g., the entire set of positioning neighbor wireless devices 1504) to input into a set of positioning models. The set of referenced measurements may be referenced using a same referencing method indicated by measurement configurations transmitted by the network entity 1506. The set of referenced measurements may be referenced using the same set of conditions and adaptation decisions indicated by measurement configurations transmitted by the network entity 1506. In some aspects, the set of referenced measurements may be referenced using different referencing methods, for example where a set of positioning models may be configured to accept inputs that have been referenced using a plurality of referencing methods.

In some aspects, the network entity 1506 may transmit the referenced measurements to another network entity for training the set of positioning models at the other network entity, for example an OTT server with a set of positioning models. In such aspects, the network entity 1506 may also transmit the referencing indicator. In some aspects, the network entity 1506 may aggregate a set of referenced measurements from a plurality of wireless devices before forwarding the aggregated referenced measurements to another network entity. The network entity 1506 may calculate a new referencing indicator (e.g., an indicator that identifies a plurality of specified referencing models), or may aggregate referencing indicators to transmit to the other network entity (e.g., a vector of referencing indicators).

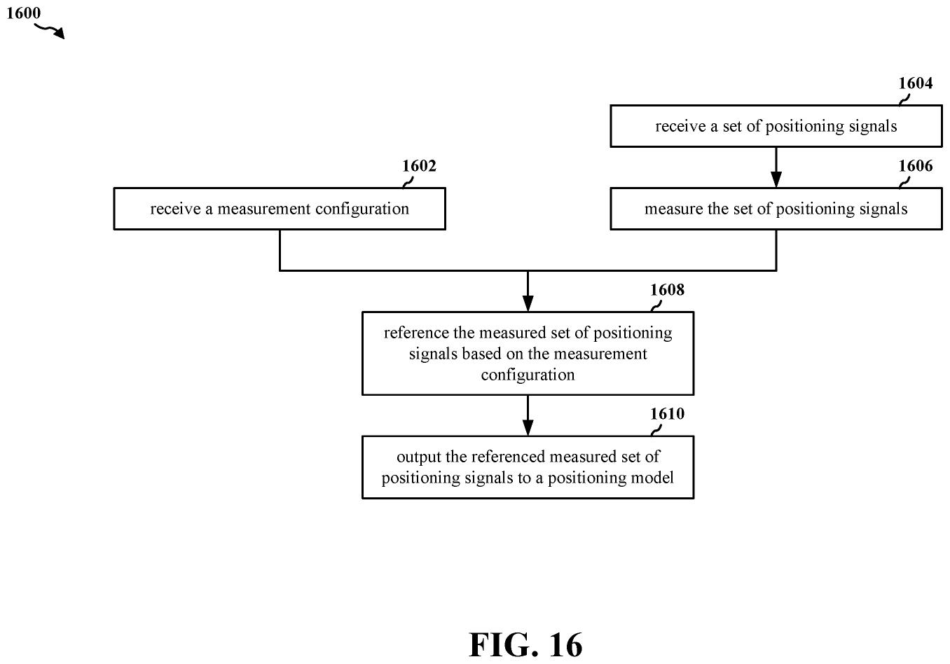

FIG. 16 is a flowchart 1600 of a method of wireless communication. The method may be performed by a wireless positioning device (e.g., the UE 104, the UE 350; the base station 102, the base station 310; the wireless device 402, the wireless device 404, the wireless device 406, the wireless device 502, the wireless device 504, the wireless device 506, the positioning target wireless device 802, the set of positioning neighbor wireless devices 804; the apparatus 2204 the network entity 2202, the network entity 2302, the network entity 2460). At 1602, the wireless positioning device may receive a measurement configuration. For example, 1602 may be performed by the positioning target wireless device 802 in FIG. 8, which may receive the measurement configuration 814 from the network entity 806. Moreover, 1602 may be performed by the component 198 in FIG. 1, 3, 22, 23, or 24.

At 1604, the wireless positioning device may receive a set of positioning signals. For example, 1604 may be performed by the positioning target wireless device 802 in FIG. 8, which may receive the set of positioning signals 822 transmitted by the set of positioning neighbor wireless devices 804. Moreover, 1604 may be performed by the component 198 in FIG. 1, 3, 22, 23, or 24.

At 1606, the wireless positioning device may measure the set of positioning signals. For example, 1606 may be performed by the positioning target wireless device 802 in FIG. 8, which may measure the set of positioning signals 822. Moreover, 1606 may be performed by the component 198 in FIG. 1, 3, 22, 23, or 24.

At 1608, the wireless positioning device may reference the measured set of positioning signals based on the measurement configuration. For example, 1608 may be performed by the positioning target wireless device 802 in FIG. 8, which may, at 826, reference the measured set of positioning signals based on the measurement configuration 814. Moreover, 1608 may be performed by the component 198 in FIG. 1, 3, 22, 23, or 24.

At 1610, the wireless positioning device may output the referenced measured set of positioning signals to a positioning model. For example, 1610 may be performed by the positioning target wireless device 802 in FIG. 8, which may, at 828, output the referenced measured set of positioning signals to a positioning model by calculating the outputs using a set of positioning models based on the referenced measurements. In another example, 1610 may be performed by the positioning target wireless device 902 in FIG. 9, which may output the referenced measured set of positioning signals to a positioning model by transmitting the set of measurement reports 928 to the network entity 906 for a calculation of positioning outputs at the network entity 906. The set of measurement reports 928 may include an indicator of the referenced measurements that were referenced at 926. Moreover, 1610 may be performed by the component 198 in FIG. 1, 3, 22, 23, or 24.

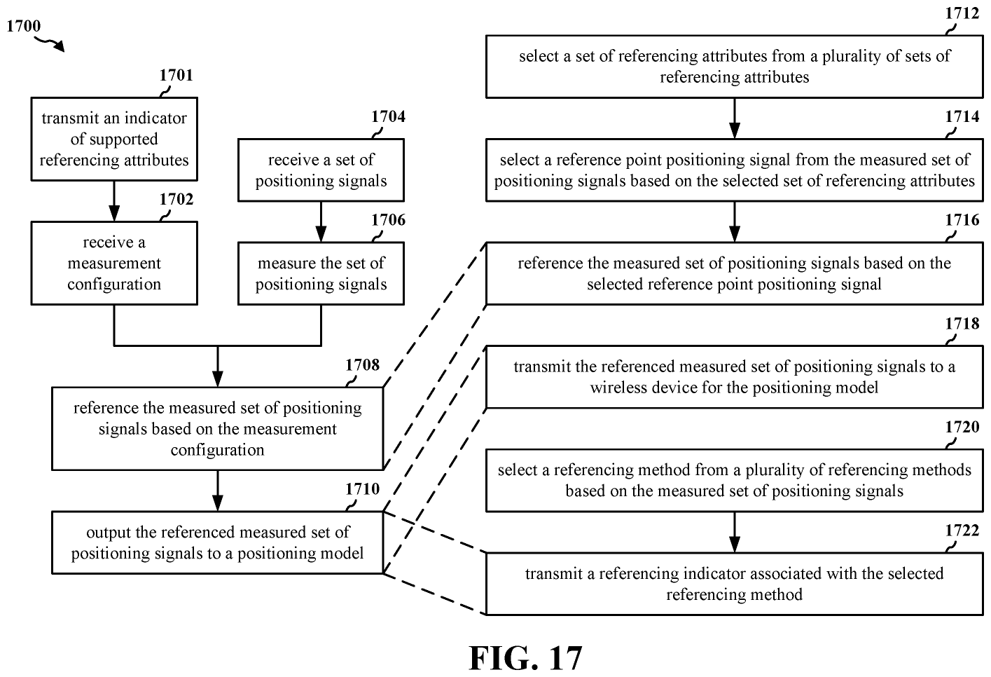

FIG. 17 is a flowchart 1700 of a method of wireless communication. The method may be performed by a wireless positioning device (e.g., the UE 104, the UE 350; the base station 102, the base station 310; the wireless device 402, the wireless device 404, the wireless device 406, the wireless device 502, the wireless device 504, the wireless device 506, the positioning target wireless device 802, the set of positioning neighbor wireless devices 804; the apparatus 2204 the network entity 2202, the network entity 2302, the network entity 2460). At 1701, the wireless positioning device may transmit an indicator of supported referencing attributes. The supported referencing attributes may include at least one of a timing reference type, a power referencing type, or a phase referencing type. For example, 1701 may be performed by the positioning target wireless device 802 in FIG. 8, which may transmit a measurement capability 810 to the network entity 806. The measurement capability 810 may include an indicator of supported referencing attributes. The supported referencing attributes may include at least one of a timing reference type (e.g., referencing using a reference timing point), a power referencing type (e.g., referencing using a reference power/magnitude point), or a phase referencing type (e.g., referencing using a reference phase point). Moreover, 1701 may be performed by the component 198 in FIG. 1, 3, 22, 23, or 24.

At 1702, the wireless positioning device may receive a measurement configuration. For example, 1702 may be performed by the positioning target wireless device 802 in FIG. 8, which may receive the measurement configuration 814 from the network entity 806. Moreover, 1702 may be performed by the component 198 in FIG. 1, 3, 22, 23, or 24.

At 1704, the wireless positioning device may receive a set of positioning signals. For example, 1704 may be performed by the positioning target wireless device 802 in FIG. 8, which may receive the set of positioning signals 822 transmitted by the set of positioning neighbor wireless devices 804. Moreover, 1704 may be performed by the component 198 in FIG. 1, 3, 22, 23, or 24.

At 1706, the wireless positioning device may measure the set of positioning signals. For example, 1706 may be performed by the positioning target wireless device 802 in FIG. 8, which may measure the set of positioning signals 822. Moreover, 1706 may be performed by the component 198 in FIG. 1, 3, 22, 23, or 24.

At 1708, the wireless positioning device may reference the measured set of positioning signals based on the measurement configuration. For example, 1708 may be performed by the positioning target wireless device 802 in FIG. 8, which may, at 826, reference the measured set of positioning signals based on the measurement configuration 814. Moreover, 1708 may be performed by the component 198 in FIG. 1, 3, 22, 23, or 24.

At 1710, the wireless positioning device may output the referenced measured set of positioning signals to a positioning model. For example, 1710 may be performed by the positioning target wireless device 802 in FIG. 8, which may, at 828, output the referenced measured set of positioning signals to a positioning model by calculating the outputs using a set of positioning models based on the referenced measurements. In another example, 1710 may be performed by the positioning target wireless device 902 in FIG. 9, which may output the referenced measured set of positioning signals to a positioning model by transmitting the set of measurement reports 928 to the network entity 906 for a calculation of positioning outputs at the network entity 906. The set of measurement reports 928 may include an indicator of the referenced measurements that were referenced at 926. Moreover, 1710 may be performed by the component 198 in FIG. 1, 3, 22, 23, or 24.

At 1712, the wireless positioning device may select a set of referencing attributes from a plurality of sets of referencing attributes. The measurement configuration may include an indicator of the plurality of sets of referencing attributes. For example, 1712 may be performed by the positioning target wireless device 802 in FIG. 8, which may, at 826, select a set of referencing attributes (e.g., select an adaptation decision based on a condition being satisfied) from a plurality of sets of referencing attributes (e.g., a plurality of adaptation decisions indicated by the measurement configuration 814). The measurement configuration 814 may include an indicator of the plurality of sets of referencing attributes. Moreover, 1712 may be performed by the component 198 in FIG. 1, 3, 22, 23, or 24.

At 1714, the wireless positioning device may select a reference point positioning signal from the measured set of positioning signals based on the selected set of referencing attributes. For example, 1714 may be performed by the positioning target wireless device 802 in FIG. 8, which may, at 826, select a reference point positioning signal (e.g., a TRP/PRS/SRS resource) from the measured set of positioning signals measured at 824 based on the selected set of referencing attributes. Moreover, 1714 may be performed by the component 198 in FIG. 1, 3, 22, 23, or 24.

At 1716, the wireless positioning device may reference the measured set of positioning signals based on the measurement configuration by referencing the measured set of positioning signals based on the selected reference point positioning signal. For example, 1716 may be performed by the positioning target wireless device 802 in FIG. 8, which may, at 826, reference the measured set of positioning signals based on the selected reference point positioning signal (e.g., reference a set of measurements based on a reference timing point of a reference signal with the highest probability LOS). Moreover, 1716 may be performed by the component 198 in FIG. 1, 3, 22, 23, or 24.

At 1718, the wireless positioning device may output the referenced measured set of positioning signals to a positioning model by transmitting the referenced measured set of positioning signals to a wireless device for the positioning model. For example, 1718 may be performed by the positioning target wireless device 902 in FIG. 9, which may transmit the set of measurement reports 928 to the network entity 906 for a set of positioning models. The set of measurement reports 928 may include an indicator of the referenced measured set of positioning signals. Moreover, 1718 may be performed by the component 198 in FIG. 1, 3, 22, 23, or 24.

At 1720, the wireless positioning device may select a referencing method from a plurality of referencing methods based on the measured set of positioning signals. The measurement configuration may include an indicator of the plurality of referencing methods. For example, 1720 may be performed by the positioning target wireless device 902 in FIG. 9, which may, at 926, select a referencing method (e.g., an adaptation decision) from a plurality of referencing methods based on the measured set of positioning signals (e.g., based on whether the measurements satisfy a condition associated with the adaptation decision). The measurement configuration 814 may include an indicator of the plurality of referencing methods that the positioning target wireless device 902 may use, and the positioning target wireless device 902 may select a method from the indicated plurality of referencing methods. Moreover, 1720 may be performed by the component 198 in FIG. 1, 3, 22, 23, or 24.

At 1722, the wireless positioning device may output the referenced measured set of positioning signals to a positioning model by transmitting a referencing indicator associated with the selected referencing method. The referencing indicator may include at least one of (a) a referencing method ID associated with the selected referencing method, (b) a condition range ID associated with the selected referencing method, (c) an adaptation decision ID associated with the selected referencing method, (d) a positioning model ID associated with the selected referencing method, or (e) a positioning model input layer ID associated with the selected referencing method. For example, 1722 may be performed by the positioning target wireless device 902 in FIG. 9, which may transmit a set of measurement reports 928 to the network entity 906. The set of measurement reports 928 may indicate a referencing indicator associated with the selected referencing method (e.g., referencing method ID, an ID of an adaptation decision and an ID of an associated condition). The referencing indicator may include at least one of (a) a referencing method ID associated with the selected referencing method, (b) a condition range ID associated with the selected referencing method, (c) an adaptation decision ID associated with the selected referencing method, (d) a positioning model ID associated with the selected referencing method, or (e) a positioning model input layer ID associated with the selected referencing method. Moreover, 1722 may be performed by the component 198 in FIG. 1, 3, 22, 23, or 24.

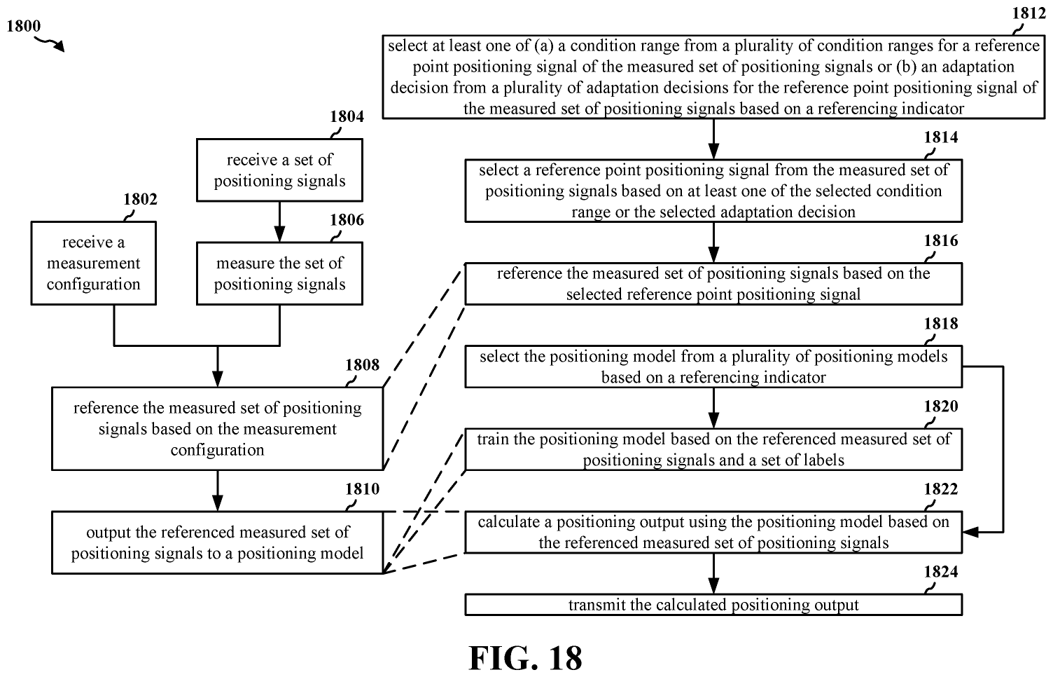

FIG. 18 is a flowchart 1800 of a method of wireless communication. The method may be performed by a wireless positioning device (e.g., the UE 104, the UE 350; the base station 102, the base station 310; the wireless device 402, the wireless device 404, the wireless device 406, the wireless device 502, the wireless device 504, the wireless device 506, the positioning target wireless device 802, the set of positioning neighbor wireless devices 804; the apparatus 2204 the network entity 2202, the network entity 2302, the network entity 2460). At 1802, the wireless positioning device may receive a measurement configuration. For example, 1802 may be performed by the positioning target wireless device 802 in FIG. 8, which may receive the measurement configuration 814 from the network entity 806. Moreover, 1802 may be performed by the component 198 in FIG. 1, 3, 22, 23, or 24.

At 1804, the wireless positioning device may receive a set of positioning signals. For example, 1804 may be performed by the positioning target wireless device 802 in FIG. 8, which may receive the set of positioning signals 822 transmitted by the set of positioning neighbor wireless devices 804. Moreover, 1804 may be performed by the component 198 in FIG. 1, 3, 22, 23, or 24.

At 1806, the wireless positioning device may measure the set of positioning signals. For example, 1806 may be performed by the positioning target wireless device 802 in FIG. 8, which may measure the set of positioning signals 822. Moreover, 1806 may be performed by the component 198 in FIG. 1, 3, 22, 23, or 24.

At 1808, the wireless positioning device may reference the measured set of positioning signals based on the measurement configuration. For example, 1808 may be performed by the positioning target wireless device 802 in FIG. 8, which may, at 826, reference the measured set of positioning signals based on the measurement configuration 814. Moreover, 1808 may be performed by the component 198 in FIG. 1, 3, 22, 23, or 24.

At 1810, the wireless positioning device may output the referenced measured set of positioning signals to a positioning model. For example, 1810 may be performed by the positioning target wireless device 802 in FIG. 8, which may, at 828, output the referenced measured set of positioning signals to a positioning model by calculating the outputs using a set of positioning models based on the referenced measurements. In another example, 1810 may be performed by the positioning target wireless device 902 in FIG. 9, which may output the referenced measured set of positioning signals to a positioning model by transmitting the set of measurement reports 928 to the network entity 906 for a calculation of positioning outputs at the network entity 906. The set of measurement reports 928 may include an indicator of the referenced measurements that were referenced at 926. Moreover, 1810 may be performed by the component 198 in FIG. 1, 3, 22, 23, or 24.

At 1812, the wireless positioning device may select at least one of (a) a condition range from a plurality of condition ranges for a reference point positioning signal of the measured set of positioning signals or (b) an adaptation decision from a plurality of adaptation decisions for the reference point positioning signal of the measured set of positioning signals based on a referencing indicator. For example, 1812 may be performed by the positioning target wireless device 802 in FIG. 8, which may, at 826, select at least one of (a) a condition range from a plurality of condition ranges for a reference point positioning signal of the measured set of positioning signals or (b) an adaptation decision from a plurality of adaptation decisions for the reference point positioning signal of the measured set of positioning signals based on a referencing indicator (e.g., the referencing indicator may indicate a condition from a plurality of possible conditions and an adaptation decision from a plurality of possible adaptation decisions). Moreover, 1812 may be performed by the component 198 in FIG. 1, 3, 22, 23, or 24.

At 1814, the wireless positioning device may select a reference point positioning signal from the measured set of positioning signals based on at least one of the selected condition range or the selected adaptation decision. For example, 1814 may be performed by the positioning target wireless device 802 in FIG. 8, which may, at 826, select a reference point positioning signal (e.g., a TRP/PRS/SRS reference signal) from the measured set of positioning signals based on at least one of the selected condition range or the selected adaptation decision from 1812. Moreover, 1814 may be performed by the component 198 in FIG. 1, 3, 22, 23, or 24.

At 1816, the wireless positioning device may reference the measured set of positioning signals based on the measurement configuration by referencing the measured set of positioning signals based on the selected reference point positioning signal. For example, 1816 may be performed by the positioning target wireless device 802 in FIG. 8, which may, at 826, reference the measured set of positioning signals based on the selected reference point positioning signal. Moreover, 1816 may be performed by the component 198 in FIG. 1, 3, 22, 23, or 24.

At 1818, the wireless positioning device may select the positioning model from a plurality of positioning models based on a referencing indicator. The measurement configuration may include the referencing indicator. For example, 1818 may be performed by the positioning target wireless device 802 in FIG. 8, which may, at 828, select a set of positioning models used at 828 from a plurality of positioning models based on a referencing indicator. The measurement configuration 814 may include the referencing indicator, allowing the positioning target wireless device 802 to select a set of positioning models based on the measurement configuration 814. Moreover, 1818 may be performed by the component 198 in FIG. 1, 3, 22, 23, or 24.

At 1820, the wireless positioning device may output the referenced measured set of positioning signals to a positioning model by training the positioning model based on the referenced measured set of positioning signals and a set of labels. For example, 1820 may be performed by the positioning target wireless device 1002 in FIG. 10, which may, at 1028, train a set of positioning models based on the referenced measured set of positioning signals at 1026 and a set of labels (e.g., a known location of the positioning target wireless device 1002). Moreover, 1820 may be performed by the component 198 in FIG. 1, 3, 22, 23, or 24.

At 1822, the wireless positioning device may output the referenced measured set of positioning signals to a positioning model by calculating a positioning output using the positioning model based on the referenced measured set of positioning signals. For example, 1822 may be performed by the positioning target wireless device 802 in FIG. 8, which may, at 828, calculate a positioning output using a set of positioning models based on the referenced measured set of positioning signals. Moreover, 1822 may be performed by the component 198 in FIG. 1, 3, 22, 23, or 24.

At 1824, the wireless positioning device may transmit the calculated positioning output. For example, 1824 may be performed by the positioning target wireless device 802 in FIG. 8, which may transmit the set of positioning reports 830 to the network entity 806. The set of positioning reports 830 may include an indicator of the positioning outputs calculated at 828. Moreover, 1824 may be performed by the component 198 in FIG. 1, 3, 22, 23, or 24.

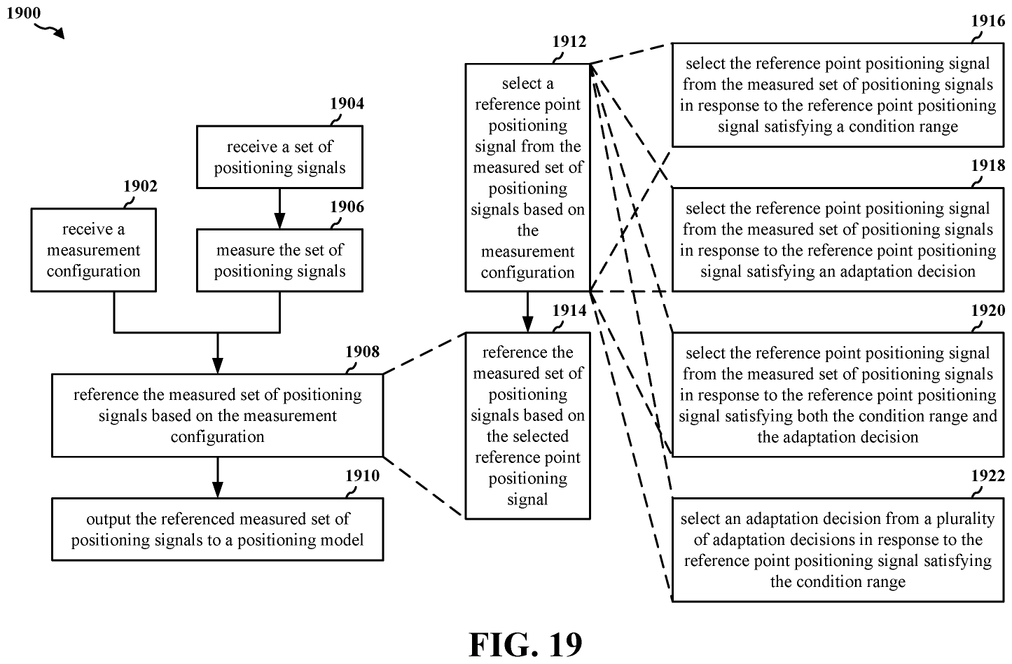

FIG. 19 is a flowchart 1900 of a method of wireless communication. The method may be performed by a wireless positioning device (e.g., the UE 104, the UE 350; the base station 102, the base station 310; the wireless device 402, the wireless device 404, the wireless device 406, the wireless device 502, the wireless device 504, the wireless device 506, the positioning target wireless device 802, the set of positioning neighbor wireless devices 804; the apparatus 2204 the network entity 2202, the network entity 2302, the network entity 2460). At 1902, the wireless positioning device may receive a measurement configuration. For example, 1902 may be performed by the positioning target wireless device 802 in FIG. 8, which may receive the measurement configuration 814 from the network entity 806. Moreover, 1902 may be performed by the component 198 in FIG. 1, 3, 22, 23, or 24.

At 1904, the wireless positioning device may receive a set of positioning signals. For example, 1904 may be performed by the positioning target wireless device 802 in FIG. 8, which may receive the set of positioning signals 822 transmitted by the set of positioning neighbor wireless devices 804. Moreover, 1904 may be performed by the component 198 in FIG. 1, 3, 22, 23, or 24.

At 1906, the wireless positioning device may measure the set of positioning signals. For example, 1906 may be performed by the positioning target wireless device 802 in FIG. 8, which may measure the set of positioning signals 822. Moreover, 1906 may be performed by the component 198 in FIG. 1, 3, 22, 23, or 24.

At 1908, the wireless positioning device may reference the measured set of positioning signals based on the measurement configuration. For example, 1908 may be performed by the positioning target wireless device 802 in FIG. 8, which may, at 826, reference the measured set of positioning signals based on the measurement configuration 814. Moreover, 1908 may be performed by the component 198 in FIG. 1, 3, 22, 23, or 24.

At 1910, the wireless positioning device may output the referenced measured set of positioning signals to a positioning model. For example, 1910 may be performed by the positioning target wireless device 802 in FIG. 8, which may, at 828, output the referenced measured set of positioning signals to a positioning model by calculating the outputs using a set of positioning models based on the referenced measurements. In another example, 1910 may be performed by the positioning target wireless device 902 in FIG. 9, which may output the referenced measured set of positioning signals to a positioning model by transmitting the set of measurement reports 928 to the network entity 906 for a calculation of positioning outputs at the network entity 906. The set of measurement reports 928 may include an indicator of the referenced measurements that were referenced at 926. Moreover, 1910 may be performed by the component 198 in FIG. 1, 3, 22, 23, or 24.

At 1912, the wireless positioning device may select a reference point positioning signal from the measured set of positioning signals based on the measurement configuration. For example, 1912 may be performed by the positioning target wireless device 802 in FIG. 8, which may, at 826, select a reference point positioning signal from the measured set of positioning signals measured at 824 based on the measurement configuration 814. Moreover, 1912 may be performed by the component 198 in FIG. 1, 3, 22, 23, or 24.

At 1914, the wireless positioning device may reference the measured set of positioning signals based on the measurement configuration by referencing the measured set of positioning signals based on the selected reference point positioning signal. For example, 1914 may be performed by the positioning target wireless device 802 in FIG. 8, which may, at 826, reference the measured set of positioning signals measured at 824 based on the reference point positioning signal selected at 1912. Moreover, 1914 may be performed by the component 198 in FIG. 1, 3, 22, 23, or 24.

At 1916, the wireless positioning device may select the reference point positioning signal from the measured set of positioning signals based on the measurement configuration by selecting the reference point positioning signal from the measured set of positioning signals in response to the reference point positioning signal satisfying a condition range. The condition range may include at least one of (a) a first range of LOS probabilities, where the measurement configuration includes a first indicator to select the first range of LOS probabilities, (b) a second range of delay spread values, where the measurement configuration may include a second indicator to select the second range of delay spread values, (c) a third range of SINRs, where the measurement configuration may include a third indicator to select the third range of SINRs, (d) a fourth range of RSRPs, where the measurement configuration may include a fourth indicator to select the fourth range of RSRPs, or (e) a fifth range of path timing measurements, where the measurement configuration may include a fifth indicator to select the fifth range of path timing measurements. For example, 1916 may be performed by the positioning target wireless device 802 in FIG. 8, which may, at 826, select the reference point positioning signal from the measured set of positioning signals in response to the reference point positioning signal satisfying a condition range (e.g., LOS probability being less than or equal to a threshold value). The condition range may include a first range of LOS probabilities (i.e., probability that there exists a direct LOS path between the transmitting one of the positioning neighbor wireless devices and the positioning target wireless device 802). The measurement configuration 814 may include a first indicator to select the first range of LOS probabilities (e.g., highest LOS probability, LOS probability greater than or equal to a threshold). The condition range may include a second range of delay spread values (e.g., smallest delay spread values, delay spread values less than or equal to a threshold). The measurement configuration 814 may include a second indicator to select the second range of delay spread values. The condition range may include a third range of SINRs (e.g., SINRs greater or equal to a threshold, largest N SINR signals). The measurement configuration may include a third indicator to select the third range of SINRs. The condition range may include a fourth range of RSRPs. The measurement configuration may include a fourth indicator to select the fourth range of RSRPs. The condition range may include a fifth range of path timing measurements (e.g., earliest received signal, first sample path from a set of specified transmitting wireless devices). The measurement configuration 814 may include a fifth indicator to select the fifth range of path timing measurements. Moreover, 1916 may be performed by the component 198 in FIG. 1, 3, 22, 23, or 24.

At 1918, the wireless positioning device may select the reference point positioning signal from the measured set of positioning signals based on the measurement configuration by selecting the reference point positioning signal from the measured set of positioning signals in response to the reference point positioning signal satisfying an adaptation decision. The adaptation decision may include at least one of (a) a largest LOS probability, where the measurement configuration may include a first indicator to select the largest LOS probability, (b) a smallest delay spread, where the measurement configuration may include a second indicator to select the smallest delay spread, (c) a smallest peak width, where the measurement configuration may include a third indicator to select the smallest peak width, (d) a largest calculated SINR, where the measurement configuration may include a fourth indicator to select the largest SINR, (e) a largest RSRP, where the measurement configuration may include a fifth indicator to select the largest RSRP, (f) an earliest arrival, where the measurement configuration may include a sixth indicator to select the earliest arrival, (g) a largest power, where the measurement configuration may include a seventh indicator to select the largest power or (h) a largest magnitude, where the measurement configuration may include an eighth indicator to select the largest magnitude. For example, 1918 may be performed by the positioning target wireless device 802 in FIG. 8, which may, at 826, select the reference point positioning signal from the measured set of positioning signals in response to the reference point positioning signal satisfying an adaptation decision (e.g., the reference signal having a smallest delay spread of a set of measurements). The adaptation decision may include a reference signal measurement having the largest LOS probability. The measurement configuration 814 may include a first indicator to select the largest LOS probability. The adaptation decision may include a reference signal measurement having a smallest delay spread. The measurement configuration 814 may include a second indicator to select the smallest delay spread. The adaptation decision may include a reference signal measurement having a smallest peak width. The measurement configuration 814 may include a third indicator to select the smallest peak width. The adaptation decision may include a reference signal measurement having a largest calculated SINR. The measurement configuration 814 may include a fourth indicator to select the largest SINR. The adaptation decision may include a reference signal measurement having a largest RSRP. The measurement configuration 814 may include a fifth indicator to select the largest RSRP. The adaptation decision may include a reference signal measurement having an earliest arrival time. The measurement configuration 814 may include a sixth indicator to select the earliest arrival. The adaptation decision may include a reference signal measurement having a largest power/magnitude. The measurement configuration 814 may include a seventh indicator to select the largest power. The adaptation decision may include a reference signal measurement having a largest magnitude. The measurement configuration 814 may include an eighth indicator to select the largest magnitude. Moreover, 1918 may be performed by the component 198 in FIG. 1, 3, 22, 23, or 24.

At 1920, the wireless positioning device may select the reference point positioning signal from the measured set of positioning signals based on the measurement configuration by selecting the reference point positioning signal from the measured set of positioning signals in response to the reference point positioning signal satisfying both the condition range and the adaptation decision. For example, 1920 may be performed by the positioning target wireless device 802 in FIG. 8, which may, at 826, select the reference point positioning signal from the measured set of positioning signals in response to the reference point positioning signal satisfying both the condition range and the adaptation decision (e.g., having an SINR less than or equal to a threshold and having a highest probability LOS state). Moreover, 1920 may be performed by the component 198 in FIG. 1, 3, 22, 23, or 24.

At 1922, the wireless positioning device may select the reference point positioning signal from the measured set of positioning signals based on the measurement configuration by selecting an adaptation decision from a plurality of adaptation decisions in response to the reference point positioning signal satisfying the condition range. The measurement configuration may include an indicator of the plurality of adaptation decisions. For example, 1922 may be performed by the positioning target wireless device 802 in FIG. 8, which may, at 826, select an adaptation decision from a plurality of adaptation decisions in response to the reference point positioning signal satisfying the condition range. The measurement configuration 814 may include an indicator of the plurality of adaptation decisions. Moreover, 1922 may be performed by the component 198 in FIG. 1, 3, 22, 23, or 24.

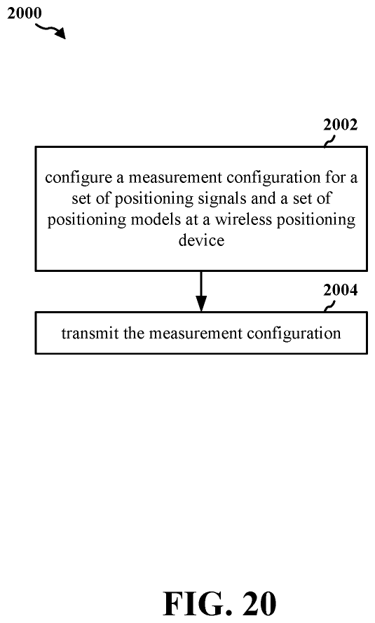

FIG. 20 is a flowchart 2000 of a method of wireless communication. The method may be performed by a base station (e.g., the base station 102, the base station 310; the LMF 166; the core network 120; the one or more location servers 168; the wireless device 402, the wireless device 406, the wireless device 502, the wireless device 506, one of the set of positioning neighbor wireless devices 804; the network entity 806; the network entity 2202, the network entity 2302, the network entity 2460). At 2002, the network entity may configure a measurement configuration for a set of positioning signals and a set of positioning models at a wireless positioning device. For example, 2002 may be performed by the network entity 806 in FIG. 8, which may, at 812, configure the measurement configuration 814 for the set of positioning signals 822 and a set of positioning models at the positioning target wireless device 802. Moreover, 2004 may be performed by the component 199 in FIG. 1, 3, 23, or 24.

At 2004, the network entity may transmit the measurement configuration. For example, 2004 may be performed by the network entity 806 in FIG. 8, which may transmit the measurement configuration 814 to the positioning target wireless device 802. Moreover, 2004 may be performed by the component 199 in FIG. 1, 3, 23, or 24.

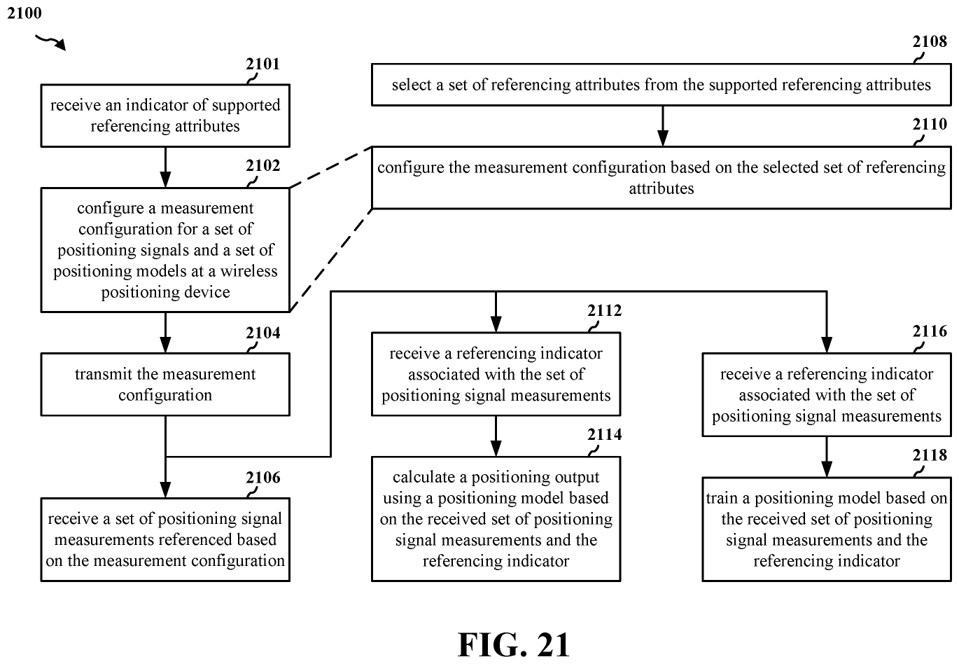

FIG. 21 is a flowchart 2100 of a method of wireless communication. The method may be performed by a base station (e.g., the base station 102, the base station 310; the LMF 166; the core network 120; the one or more location servers 168; the wireless device 402, the wireless device 406, the wireless device 502, the wireless device 506, one of the set of positioning neighbor wireless devices 804; the network entity 806; the network entity 2202, the network entity 2302, the network entity 2460). At 2101, the network entity may receive an indicator of supported referencing attributes. The supported referencing attributes may include at least one of a timing reference type, a power referencing type, or a phase referencing type. For example, 2101 may be performed by the network entity 806 in FIG. 8, which may receive a measurement capability 810 from the positioning target wireless device 802. The measurement capability 810 may include an indicator of referencing attributes supported by the positioning target wireless device 802. The supported referencing attributes may include at least one of a timing reference type, a power referencing type, or a phase referencing type. Moreover, 2101 may be performed by the component 199 in FIG. 1, 3, 23, or 24.

At 2102, the network entity may configure a measurement configuration for a set of positioning signals and a set of positioning models at a wireless positioning device. The measurement configuration may include a referencing indicator associated with a plurality of referencing methods associated with the set of positioning signals and the set of positioning models. The referencing indicator may include at least one of (a) a method ID, (b) a condition range ID, (c) an adaptation decision ID, (d) a positioning model ID, or (e) a positioning model input layer ID. The measurement configuration may include a referencing indicator. The referencing indicator may include at least one of (a) a method ID, (b) a condition range ID, (c) an adaptation decision ID, (d) a positioning model ID, or (e) a positioning model input layer ID. The measurement configuration may include at least one of (a) a first indicator to select a first range of LOS probabilities, (b) a second indicator to select a second range of delay spread values, (c) a third indicator to select a third range of SINRs, (d) a fourth indicator to select a fourth range of RSRPs, (e) a fifth indicator to select a fifth range of path timing measurements, (f) a sixth indicator to select a largest LOS probability, (g) a seventh indicator to select a smallest delay spread, (h) an eighth indicator to select a smallest peak width, (i) a ninth indicator to select a largest SINR, (j) a tenth indicator to select a largest RSRP, (k) an eleventh indicator to select an earliest arrival, (l) a twelfth indicator to select a largest power, or (m) a thirteenth indicator to select a largest magnitude. For example, 2102 may be performed by the network entity 806 in FIG. 8, which may, at 812, configure the measurement configuration 814 for the set of positioning signals 822 and a set of positioning models at the positioning target wireless device 802. The measurement configuration 814 may include a referencing indicator associated with a plurality of referencing methods associated with the set of positioning signals 822 and the set of positioning models at the positioning target wireless device 802. The referencing indicator may include at least one of (a) a method ID, (b) a condition range ID, (c) an adaptation decision ID, (d) a positioning model ID, or (e) a positioning model input layer ID. The measurement configuration 814 may include a referencing indicator. The referencing indicator may include at least one of (a) a method ID, (b) a condition range ID, (c) an adaptation decision ID, (d) a positioning model ID, or (e) a positioning model input layer ID. The measurement configuration 814 may include at least one of (a) a first indicator to select a first range of LOS probabilities, (b) a second indicator to select a second range of delay spread values, (c) a third indicator to select a third range of SINRs, (d) a fourth indicator to select a fourth range of RSRPs, (e) a fifth indicator to select a fifth range of path timing measurements, (f) a sixth indicator to select a largest LOS probability, (g) a seventh indicator to select a smallest delay spread, (h) an eighth indicator to select a smallest peak width, (i) a ninth indicator to select a largest SINR, (j) a tenth indicator to select a largest RSRP, (k) an eleventh indicator to select an earliest arrival, (l) a twelfth indicator to select a largest power, or (m) a thirteenth indicator to select a largest magnitude. Moreover, 2104 may be performed by the component 199 in FIG. 1, 3, 23, or 24.

At 2104, the network entity may transmit the measurement configuration. For example, 2104 may be performed by the network entity 806 in FIG. 8, which may transmit the measurement configuration 814 to the positioning target wireless device 802. Moreover, 2104 may be performed by the component 199 in FIG. 1, 3, 23, or 24.

At 2106, the network entity may receive a set of positioning signal measurements referenced based on the measurement configuration. For example, 2106 may be performed by the network entity 906 in FIG. 9, which may receive a set of measurement reports 928 from the positioning target wireless device 902. The set of measurement reports 928 may include a set of positioning signal measurements referenced at 926 based on the measurement configuration 914. Moreover, 2106 may be performed by the component 199 in FIG. 1, 3, 23, or 24.

At 2108, the network entity may select a set of referencing attributes from the supported referencing attributes. For example, 2108 may be performed by the network entity 806 in FIG. 8, which may, at 812, select a set of referencing attributes for the measurement configuration 814 from the supported referencing attributes indicated by the measurement capability 810. Moreover, 2108 may be performed by the component 199 in FIG. 1, 3, 23, or 24.

At 2110, the network entity may configure the measurement configuration by configuring the measurement configuration based on the selected set of referencing attributes. For example, 2110 may be performed by the network entity 806 in FIG. 8, which may, at 812, configure the measurement configuration based on the selected set of referencing attributes. Moreover, 2110 may be performed by the component 199 in FIG. 1, 3, 23, or 24.

At 2112, the network entity may receive a referencing indicator associated with the set of positioning signal measurements. For example, 2112 may be performed by the network entity 906 in FIG. 9, which may receive the set of measurement reports 928 from the positioning target wireless device 902. The set of measurement reports 928 may include a referencing indicator associated with the set of positioning signal measurements indicated by the set of measurement reports 928. Moreover, 2112 may be performed by the component 199 in FIG. 1, 3, 23, or 24.

At 2114, the network entity may calculate a positioning output using a positioning model based on the received set of positioning signal measurements and the referencing indicator. For example, 2114 may be performed by the network entity 906 in FIG. 9, which may, at 930, calculate a positioning output using a set of positioning models based on the received set of positioning signal measurements indicated in the set of measurement reports 928 and the referencing indicator indicated in the set of measurement reports 928. Moreover, 2114 may be performed by the component 199 in FIG. 1, 3, 23, or 24.

At 2116, the network entity may receive a referencing indicator associated with the set of positioning signal measurements. For example, 2116 may be performed by the network entity 1106 in FIG. 11, which may receive a set of measurement reports 1128 from the positioning target wireless device 1102. The set of measurement reports 1128 may include a referencing indicator associated with the set of positioning signal measurements included in the set of measurement reports 1128. Moreover, 2116 may be performed by the component 199 in FIG. 1, 3, 23, or 24.

At 2118, the network entity may train a positioning model based on the received set of positioning signal measurements and the referencing indicator. The referencing indicator may include at least one of (a) a method ID associated with the set of positioning signal measurements, (b) a condition range ID associated with the set of positioning signal measurements, (c) an adaptation decision ID associated with the set of positioning signal measurements, (d) a positioning model ID associated with the set of positioning signal measurements, or (e) a positioning model input layer ID associated with the set of positioning signal measurements. For example, 2118 may be performed by the network entity 1106 in FIG. 11, which may, at 1130, train a set of positioning models based on the received set of positioning signal measurements indicated by the set of measurement reports 1128 and the referencing indicator indicated by the set of measurement reports 1128. The referencing indicator may include at least one of (a) a method ID associated with the set of positioning signal measurements, (b) a condition range ID associated with the set of positioning signal measurements, (c) an adaptation decision ID associated with the set of positioning signal measurements, (d) a positioning model ID associated with the set of positioning signal measurements, or (e) a positioning model input layer ID associated with the set of positioning signal measurements. Moreover, 2118 may be performed by the component 199 in FIG. 1, 3, 23, or 24.

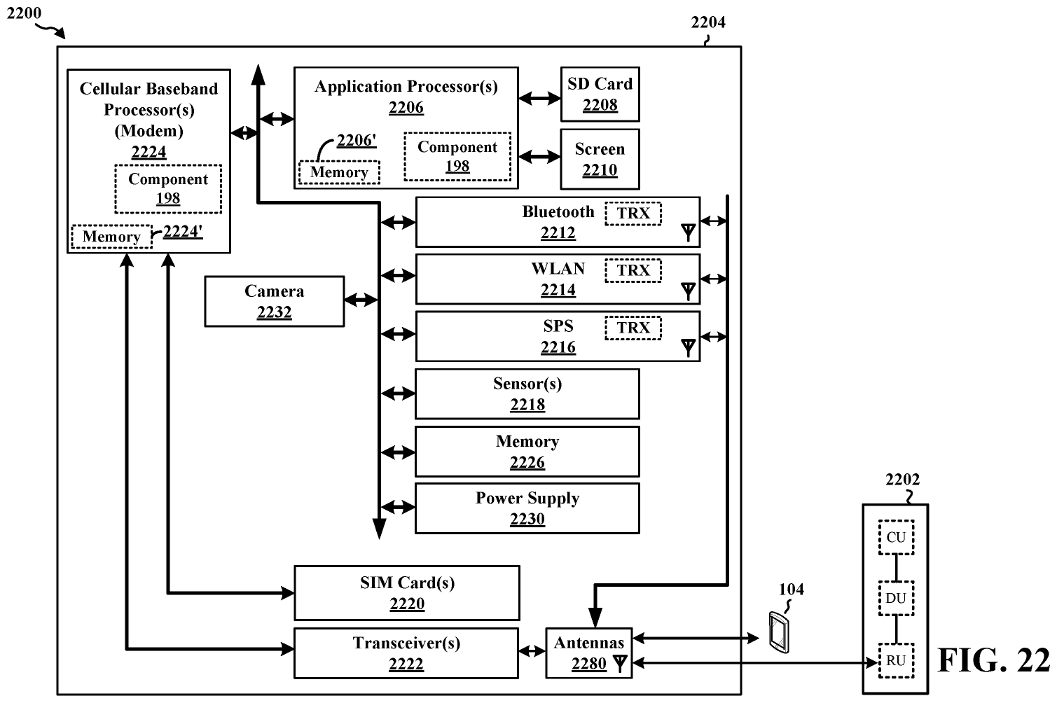

FIG. 22 is a diagram 2200 illustrating an example of a hardware implementation for an apparatus 2204. The apparatus 2204 may be a UE, a component of a UE, or may implement UE functionality. In some aspects, the apparatus 2204 may include at least one cellular baseband processor 2224 (also referred to as a modem) coupled to one or more transceivers 2222 (e.g., cellular RF transceiver). The cellular baseband processor(s) 2224 may include at least one on-chip memory 2224′. In some aspects, the apparatus 2204 may further include one or more subscriber identity modules (SIM) cards 2220 and at least one application processor 2206 coupled to a secure digital (SD) card 2208 and a screen 2210. The application processor(s) 2206 may include on-chip memory 2206′. In some aspects, the apparatus 2204 may further include a Bluetooth module 2212, a WLAN module 2214, an SPS module 2216 (e.g., GNSS module), one or more sensor modules 2218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 2226, a power supply 2230, and/or a camera 2232. The Bluetooth module 2212, the WLAN module 2214, and the SPS module 2216 may include an on-chip transceiver (TRX) (or in some cases, just a receiver (RX)). The Bluetooth module 2212, the WLAN module 2214, and the SPS module 2216 may include their own dedicated antennas and/or utilize the antennas 2280 for communication. The cellular baseband processor(s) 2224 communicates through the transceiver(s) 2222 via one or more antennas 2280 with the UE 104 and/or with an RU associated with a network entity 2202. The cellular baseband processor(s) 2224 and the application processor(s) 2206 may each include a computer-readable medium/memory 2224′, 2206′, respectively. The additional memory modules 2226 may also be considered a computer-readable medium/memory. Each computer-readable medium/memory 2224′, 2206′, 2226 may be non-transitory. The cellular baseband processor(s) 2224 and the application processor(s) 2206 are each responsible for general processing, including the execution of software stored on the computer-readable medium/memory. The software, when executed by the cellular baseband processor(s) 2224/application processor(s) 2206, causes the cellular baseband processor(s) 2224/application processor(s) 2206 to perform the various functions described supra. The cellular baseband processor(s) 2224 and the application processor(s) 2206 are configured to perform the various functions described supra based at least in part of the information stored in the memory. That is, the cellular baseband processor(s) 2224 and the application processor(s) 2206 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 2224/application processor(s) 2206 when executing software. The cellular baseband processor(s) 2224/application processor(s) 2206 may be a component of the UE 350 and may include the at least one memory 360 and/or at least one of the TX processor 368, the RX processor 356, and the controller/processor 359. In one configuration, the apparatus 2204 may be at least one processor chip (modem and/or application) and include just the cellular baseband processor(s) 2224 and/or the application processor(s) 2206, and in another configuration, the apparatus 2204 may be the entire UE (e.g., see UE 350 of FIG. 3) and include the additional modules of the apparatus 2204.

As discussed supra, the component 198 may be configured to receive a measurement configuration. The component 198 may be configured to receive a set of positioning signals (e.g., PRSs, SRSs). The component 198 may be configured to measure the set of positioning signals. The component 198 may be configured to reference the measured set of positioning signals based on the measurement configuration. The component 198 may be configured to output the referenced measured set of positioning signals to a positioning model. The component 198 may be configured to output the referenced measured set of positioning signals to a positioning model by transmitting the referenced measured set of positioning signals to a wireless device including the positioning model, by training the positioning model based on the referenced measured set of positioning signals and a set of labels, or by calculating a positioning output using the positioning model based on the referenced measured set of positioning signals. The component 198 may be within the cellular baseband processor(s) 2224, the application processor(s) 2206, or both the cellular baseband processor(s) 2224 and the application processor(s) 2206. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 2204 may include a variety of components configured for various functions. In one configuration, the apparatus 2204, and in particular the cellular baseband processor(s) 2224 and/or the application processor(s) 2206, may include means for receiving a measurement configuration. The apparatus 2204 may include means for receiving a set of positioning signals. The apparatus 2204 may include means for measuring the set of positioning signals. The apparatus 2204 may include means for referencing the measured set of positioning signals based on the measurement configuration. The apparatus 2204 may include means for outputting the referenced measured set of positioning signals to a positioning model. The apparatus 2204 may include means for outputting the referenced measured set of positioning signals to the positioning model by transmitting the referenced measured set of positioning signals to a wireless device that uses the positioning model. The apparatus 2204 may include means for selecting a referencing method from a plurality of referencing methods based on the measured set of positioning signals. The measurement configuration may include an indicator of the plurality of referencing methods. The apparatus 2204 may include means for transmitting a referencing indicator associated with the selected referencing method. The referencing indicator may include at least one of (a) a referencing method ID associated with the selected referencing method, (b) a condition range ID associated with the selected referencing method, (c) an adaptation decision ID associated with the selected referencing method, (d) a positioning model ID associated with the selected referencing method, or (e) a positioning model input layer ID associated with the selected referencing method. The apparatus 2204 may include means for outputting the referenced measured set of positioning signals to the positioning model by training the positioning model based on the referenced measured set of positioning signals and a set of labels. The apparatus 2204 may include means for outputting the referenced measured set of positioning signals to the positioning model by calculating a positioning output using the positioning model based on the referenced measured set of positioning signals. The measurement configuration may include a referencing indicator. The apparatus 2204 may include means for selecting the positioning model from a plurality of positioning models based on the referencing indicator. The apparatus 2204 may include means for selecting at least one of (a) a condition range from a plurality of condition ranges for a reference point positioning signal of the measured set of positioning signals or (b) an adaptation decision from a plurality of adaptation decisions for the reference point positioning signal of the measured set of positioning signals based on the referencing indicator. The apparatus 2204 may include means for referencing the measured set of positioning signals based on the measurement configuration by (a) selecting a reference point positioning signal from the measured set of positioning signals based on at least one of the selected condition range or the selected adaptation decision, and (b) referencing the measured set of positioning signals based on the selected reference point positioning signal. The apparatus 2204 may include means for transmitting the calculated positioning output. The apparatus 2204 may include means for referencing the measured set of positioning signals based on the measurement configuration by (a) selecting a reference point positioning signal from the measured set of positioning signals based on the measurement configuration, and (b) referencing the measured set of positioning signals based on the selected reference point positioning signal. The apparatus 2204 may include means for selecting the reference point positioning signal from the measured set of positioning signals based on the measurement configuration by selecting the reference point positioning signal from the measured set of positioning signals in response to the reference point positioning signal satisfying a condition range. The apparatus 2204 may include means for selecting the reference point positioning signal from the measured set of positioning signals based on the measurement configuration by selecting the reference point positioning signal from the measured set of positioning signals in response to the reference point positioning signal satisfying an adaptation decision. The apparatus 2204 may include means for selecting the reference point positioning signal from the measured set of positioning signals based on the measurement configuration by selecting the reference point positioning signal from the measured set of positioning signals in response to the reference point positioning signal satisfying both the condition range and the adaptation decision. The condition range may include a first range of LOS probabilities. The measurement configuration may include a first indicator to select the first range of LOS probabilities. The condition range may include a second range of delay spread values. The measurement configuration may include a second indicator to select the second range of delay spread values. The condition range may include a third range of SINRs. The measurement configuration may include a third indicator to select the third range of SINRs. The condition range may include a fourth range of RSRPs. The measurement configuration may include a fourth indicator to select the fourth range of RSRPs. The condition range may include a fifth range of path timing measurements. The measurement configuration may include a fifth indicator to select the fifth range of path timing measurements. The adaptation decision may include a largest LOS probability. The measurement configuration may include a first indicator to select the largest LOS probability. The adaptation decision may include a smallest delay spread. The measurement configuration may include a second indicator to select the smallest delay spread. The adaptation decision may include a smallest peak width. The measurement configuration may include a third indicator to select the smallest peak width. The adaptation decision may include a largest calculated SINR. The measurement configuration may include a fourth indicator to select the largest SINR. The adaptation decision may include a largest RSRP. The measurement configuration may include a fifth indicator to select the largest RSRP. The adaptation decision may include an earliest arrival. The measurement configuration may include a sixth indicator to select the earliest arrival. The adaptation decision may include a largest power. The measurement configuration may include a seventh indicator to select the largest power. The adaptation decision may include a largest magnitude. The measurement configuration may include an eighth indicator to select the largest magnitude. The apparatus 2204 may include means for selecting the reference point positioning signal from the measured set of positioning signals based on the measurement configuration by selecting the adaptation decision from a plurality of adaptation decisions in response to the reference point positioning signal satisfying the condition range. The measurement configuration may include an indicator of the plurality of adaptation decisions. The apparatus 2204 may include means for transmitting an indicator of supported referencing attributes. The measurement configuration may be based on the supported referencing attributes. The supported referencing attributes may include at least one of (a) a timing reference type, (b) a power referencing type, or (c) a phase referencing type. The measurement configuration may include a plurality of sets of referencing attributes. The apparatus 2204 may include means for referencing the measured set of positioning signals based on the measurement configuration by (a) selecting a set of referencing attributes from the plurality of sets of referencing attributes, (b) selecting a reference point positioning signal from the measured set of positioning signals based on the selected set of referencing attributes, and (c) referencing the measured set of positioning signals based on the selected reference point positioning signal. The set of positioning signals may include a set of PRSs or a set of SRSs. The apparatus 2204 may include a UE, a base station, or a TRP. The apparatus 2204 may include means for outputting the referenced measured set of positioning signals to the positioning model by transmitting the referenced measured set of positioning signals to a wireless device for the positioning model. The apparatus 2204 may include means for selecting a referencing method from a plurality of referencing methods based on the measured set of positioning signals. The measurement configuration may include an indicator of the plurality of referencing methods. The apparatus 2204 may include means for outputting the referenced measured set of positioning signals to the positioning model by transmitting a referencing indicator associated with the selected referencing method. The apparatus 2204 may include means for transmitting an indicator of supported referencing attributes before the reception of the measurement configuration. The means may be the component 198 of the apparatus 2204 configured to perform the functions recited by the means. As described supra, the apparatus 2204 may include the TX processor 368, the RX processor 356, and the controller/processor 359. As such, in one configuration, the means may be the TX processor 368, the RX processor 356, and/or the controller/processor 359 configured to perform the functions recited by the means.

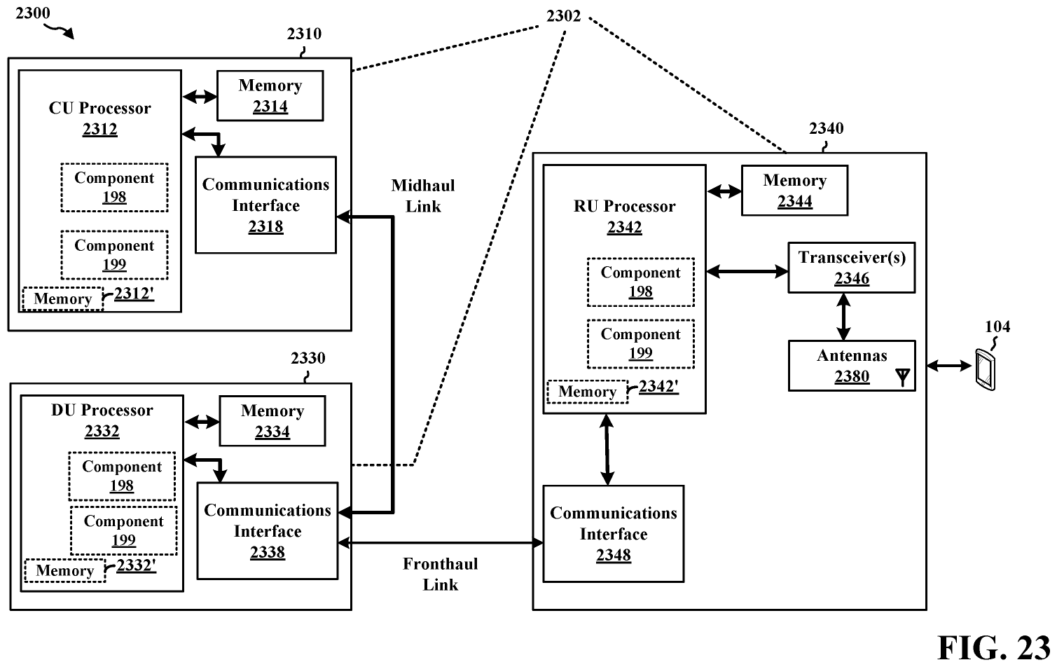

FIG. 23 is a diagram 2300 illustrating an example of a hardware implementation for a network entity 2302. The network entity 2302 may be a BS, a component of a BS, or may implement BS functionality. The network entity 2302 may include at least one of a CU 2310, a DU 2330, or an RU 2340. For example, depending on the layer functionality handled by the component 199, the network entity 2302 may include the CU 2310; both the CU 2310 and the DU 2330; each of the CU 2310, the DU 2330, and the RU 2340; the DU 2330; both the DU 2330 and the RU 2340; or the RU 2340. The CU 2310 may include at least one CU processor 2312. The CU processor(s) 2312 may include on-chip memory 2312′. In some aspects, the CU 2310 may further include additional memory modules 2314 and a communications interface 2318. The CU 2310 communicates with the DU 2330 through a midhaul link, such as an F1 interface. The DU 2330 may include at least one DU processor 2332. The DU processor(s) 2332 may include on-chip memory 2332′. In some aspects, the DU 2330 may further include additional memory modules 2334 and a communications interface 2338. The DU 2330 communicates with the RU 2340 through a fronthaul link. The RU 2340 may include at least one RU processor 2342. The RU processor(s) 2342 may include on-chip memory 2342′. In some aspects, the RU 2340 may further include additional memory modules 2344, one or more transceivers 2346, antennas 2380, and a communications interface 2348. The RU 2340 communicates with the UE 104. The on-chip memory 2312′, 2332′, 2342′ and the additional memory modules 2314, 2334, 2344 may each be considered a computer-readable medium/memory. Each computer-readable medium/memory may be non-transitory. Each of the processors 2312, 2332, 2342 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 198 may be configured to receive a measurement configuration. The component 198 may be configured to receive a set of positioning signals (e.g., PRSs, SRSs). The component 198 may be configured to measure the set of positioning signals. The component 198 may be configured to reference the measured set of positioning signals based on the measurement configuration. The component 198 may be configured to output the referenced measured set of positioning signals to a positioning model. The component 198 may be configured to output the referenced measured set of positioning signals to a positioning model by transmitting the referenced measured set of positioning signals to a wireless device including the positioning model, by training the positioning model based on the referenced measured set of positioning signals and a set of labels, or by calculating a positioning output using the positioning model based on the referenced measured set of positioning signals. The component 198 may be within one or more processors of one or more of the CU 2310, DU 2330, and the RU 2340. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 2302 may include a variety of components configured for various functions. In one configuration, the network entity 2302 may include means for receiving a measurement configuration. The network entity 2302 may include means for receiving a set of positioning signals. The network entity 2302 may include means for measuring the set of positioning signals. The network entity 2302 may include means for referencing the measured set of positioning signals based on the measurement configuration. The network entity 2302 may include means for outputting the referenced measured set of positioning signals to a positioning model. The network entity 2302 may include means for outputting the referenced measured set of positioning signals to the positioning model by transmitting the referenced measured set of positioning signals to a wireless device that uses the positioning model. The network entity 2302 may include means for selecting a referencing method from a plurality of referencing methods based on the measured set of positioning signals. The measurement configuration may include an indicator of the plurality of referencing methods. The network entity 2302 may include means for transmitting a referencing indicator associated with the selected referencing method. The referencing indicator may include at least one of (a) a referencing method ID associated with the selected referencing method, (b) a condition range ID associated with the selected referencing method, (c) an adaptation decision ID associated with the selected referencing method, (d) a positioning model ID associated with the selected referencing method, or (e) a positioning model input layer ID associated with the selected referencing method. The network entity 2302 may include means for outputting the referenced measured set of positioning signals to the positioning model by training the positioning model based on the referenced measured set of positioning signals and a set of labels. The network entity 2302 may include means for outputting the referenced measured set of positioning signals to the positioning model by calculating a positioning output using the positioning model based on the referenced measured set of positioning signals. The measurement configuration may include a referencing indicator. The network entity 2302 may include means for selecting the positioning model from a plurality of positioning models based on the referencing indicator. The network entity 2302 may include means for selecting at least one of (a) a condition range from a plurality of condition ranges for a reference point positioning signal of the measured set of positioning signals or (b) an adaptation decision from a plurality of adaptation decisions for the reference point positioning signal of the measured set of positioning signals based on the referencing indicator. The network entity 2302 may include means for referencing the measured set of positioning signals based on the measurement configuration by (a) selecting a reference point positioning signal from the measured set of positioning signals based on at least one of the selected condition range or the selected adaptation decision, and (b) referencing the measured set of positioning signals based on the selected reference point positioning signal. The network entity 2302 may include means for transmitting the calculated positioning output. The network entity 2302 may include means for referencing the measured set of positioning signals based on the measurement configuration by (a) selecting a reference point positioning signal from the measured set of positioning signals based on the measurement configuration, and (b) referencing the measured set of positioning signals based on the selected reference point positioning signal. The network entity 2302 may include means for selecting the reference point positioning signal from the measured set of positioning signals based on the measurement configuration by selecting the reference point positioning signal from the measured set of positioning signals in response to the reference point positioning signal satisfying a condition range. The network entity 2302 may include means for selecting the reference point positioning signal from the measured set of positioning signals based on the measurement configuration by selecting the reference point positioning signal from the measured set of positioning signals in response to the reference point positioning signal satisfying an adaptation decision. The network entity 2302 may include means for selecting the reference point positioning signal from the measured set of positioning signals based on the measurement configuration by selecting the reference point positioning signal from the measured set of positioning signals in response to the reference point positioning signal satisfying both the condition range and the adaptation decision. The condition range may include a first range of LOS probabilities. The measurement configuration may include a first indicator to select the first range of LOS probabilities. The condition range may include a second range of delay spread values. The measurement configuration may include a second indicator to select the second range of delay spread values. The condition range may include a third range of SINRs. The measurement configuration may include a third indicator to select the third range of SINRs. The condition range may include a fourth range of RSRPs. The measurement configuration may include a fourth indicator to select the fourth range of RSRPs. The condition range may include a fifth range of path timing measurements. The measurement configuration may include a fifth indicator to select the fifth range of path timing measurements. The adaptation decision may include a largest LOS probability. The measurement configuration may include a first indicator to select the largest LOS probability. The adaptation decision may include a smallest delay spread. The measurement configuration may include a second indicator to select the smallest delay spread. The adaptation decision may include a smallest peak width. The measurement configuration may include a third indicator to select the smallest peak width. The adaptation decision may include a largest calculated SINR. The measurement configuration may include a fourth indicator to select the largest SINR. The adaptation decision may include a largest RSRP. The measurement configuration may include a fifth indicator to select the largest RSRP. The adaptation decision may include an earliest arrival. The measurement configuration may include a sixth indicator to select the earliest arrival. The adaptation decision may include a largest power. The measurement configuration may include a seventh indicator to select the largest power. The adaptation decision may include a largest magnitude. The measurement configuration may include an eighth indicator to select the largest magnitude. The network entity 2302 may include means for selecting the reference point positioning signal from the measured set of positioning signals based on the measurement configuration by selecting the adaptation decision from a plurality of adaptation decisions in response to the reference point positioning signal satisfying the condition range. The measurement configuration may include an indicator of the plurality of adaptation decisions. The network entity 2302 may include means for transmitting an indicator of supported referencing attributes. The measurement configuration may be based on the supported referencing attributes. The supported referencing attributes may include at least one of (a) a timing reference type, (b) a power referencing type, or (c) a phase referencing type. The measurement configuration may include a plurality of sets of referencing attributes. The network entity 2302 may include means for referencing the measured set of positioning signals based on the measurement configuration by (a) selecting a set of referencing attributes from the plurality of sets of referencing attributes, (b) selecting a reference point positioning signal from the measured set of positioning signals based on the selected set of referencing attributes, and (c) referencing the measured set of positioning signals based on the selected reference point positioning signal. The set of positioning signals may include a set of PRSs or a set of SRSs. The network entity 2302 may include at least one of a UE, a base station, or a TRP. The network entity 2302 may include means for outputting the referenced measured set of positioning signals to the positioning model by transmitting the referenced measured set of positioning signals to a wireless device for the positioning model. The network entity 2302 may include means for selecting a referencing method from a plurality of referencing methods based on the measured set of positioning signals. The measurement configuration may include an indicator of the plurality of referencing methods. The network entity 2302 may include means for outputting the referenced measured set of positioning signals to the positioning model by transmitting a referencing indicator associated with the selected referencing method. The network entity 2302 may include means for transmitting an indicator of supported referencing attributes before the reception of the measurement configuration. The means may be the component 198 of the network entity 2302 configured to perform the functions recited by the means. As described supra, the network entity 2302 may include the TX processor 316, the RX processor 370, and the controller/processor 375. As such, in one configuration, the means may be the TX processor 316, the RX processor 370, and/or the controller/processor 375 configured to perform the functions recited by the means.

As discussed supra, the component 199 may be configured to configure a measurement configuration for a set of positioning signals and a set of positioning models at a wireless positioning device. The component 199 may be configured to transmit the measurement configuration. The component 199 may be configured to receive a calculated position of a wireless device, or an intermediary measurement that may be used to calculate a position of the wireless device, based on measurements of the set of positioning signals that are referenced based on the measurement configuration. The component 199 may be configured to receive a set of positioning signal measurements that are referenced based on the measurement configuration. The component 199 may be within one or more processors of one or more of the CU 2310, DU 2330, and the RU 2340. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 2302 may include a variety of components configured for various functions. In one configuration, the network entity 2302 may include means for configuring a measurement configuration for a set of positioning signals and a set of positioning models at a wireless positioning device. The network entity 2302 may include means for transmitting the measurement configuration. The network entity 2302 may include means for receiving a set of positioning signal measurements referenced based on the measurement configuration. The network entity 2302 may include means for receiving a referencing indicator associated with the set of positioning signal measurements. The network entity 2302 may include means for calculating a positioning output using a positioning model based on the received set of positioning signal measurements and the referencing indicator. The set of positioning models may include the positioning model. The referencing indicator may include at least one of (a) a method ID associated with the set of positioning signal measurements, (b) a condition range ID associated with the set of positioning signal measurements, (c) an adaptation decision ID associated with the set of positioning signal measurements, (d) a positioning model ID associated with the set of positioning signal measurements, or (e) a positioning model input layer ID associated with the set of positioning signal measurements. The measurement configuration may include a referencing indicator of a plurality of referencing methods associated with the set of positioning signals and the set of positioning models. The referencing indicator may include at least one of (a) a method ID, (b) a condition range ID, (c) an adaptation decision ID, (d) a positioning model ID, or (e) a positioning model input layer ID. The measurement configuration may include a referencing indicator. The referencing indicator may include at least one of (a) a method ID, (b) a condition range ID, (c) an adaptation decision ID, (d) a positioning model ID, or (e) a positioning model input layer ID. The measurement configuration may include at least one of (a) a first indicator to select a first range of line-of-sight (LOS) probabilities, (b) a second indicator to select a second range of delay spread values, (c) a third indicator to select a third range of SINRs, (d) a fourth indicator to select a fourth range of reference RSRPs, (e) a fifth indicator to select a fifth range of path timing measurements, (f) a sixth indicator to select a largest LOS probability, (g) a seventh indicator to select a smallest delay spread, (h) an eighth indicator to select a smallest peak width, (i) a ninth indicator to select a largest SINR, (j) a tenth indicator to select a largest RSRP, (k) an eleventh indicator to select an earliest arrival, (l) a twelfth indicator to select a largest power, or (m) a thirteenth indicator to select a largest magnitude. The network entity 2302 may include means for receiving an indicator of supported referencing attributes. The network entity 2302 may include means for configuring the measurement configuration for the set of positioning signals and the set of positioning models at the wireless positioning device by (a) selecting a set of referencing attributes from the supported referencing attributes, and (b) configuring the measurement configuration based on the selected set of referencing attributes. The supported referencing attributes may include at least one of (a) a timing reference type, (b) a power referencing type, or (c) a phase referencing type. The set of positioning signals may include a set of PRSs or a set of SRSs. The network entity 2302 may include an LMF. The means may be the component 199 of the network entity 2302 configured to perform the functions recited by the means. As described supra, the network entity 2302 may include the TX processor 316, the RX processor 370, and the controller/processor 375. As such, in one configuration, the means may be the TX processor 316, the RX processor 370, and/or the controller/processor 375 configured to perform the functions recited by the means.

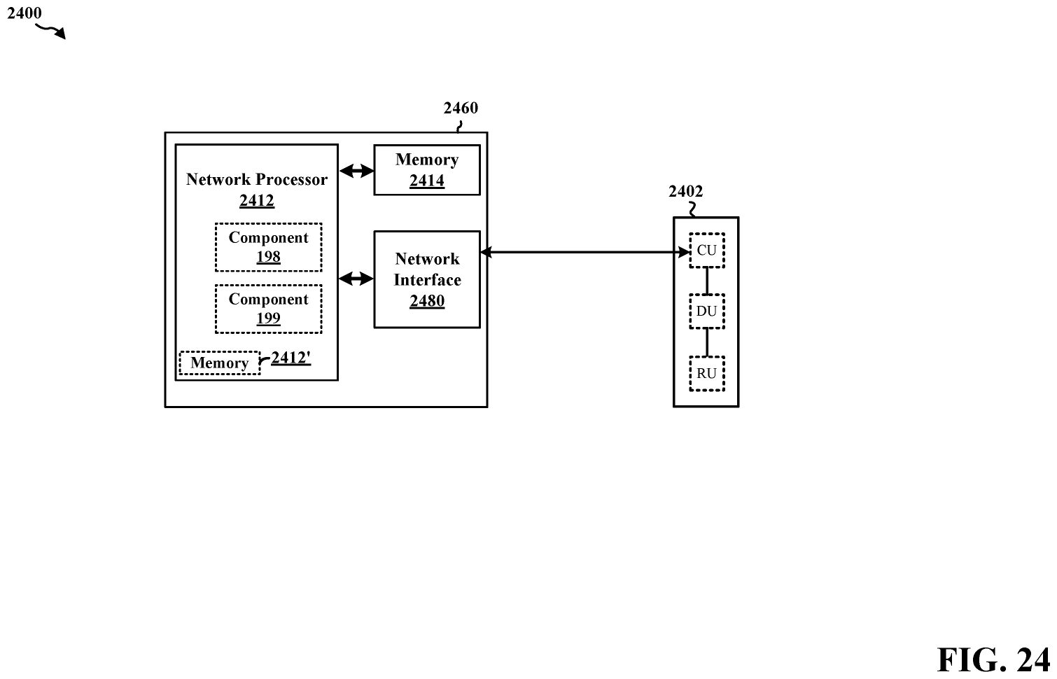

FIG. 24 is a diagram 2400 illustrating an example of a hardware implementation for a network entity 2460. In one example, the network entity 2460 may be within the core network 120. The network entity 2460 may include at least one network processor 2412. The network processor(s) 2412 may include on-chip memory 2412′. In some aspects, the network entity 2460 may further include additional memory modules 2414. The network entity 2460 communicates via the network interface 2480 directly (e.g., backhaul link) or indirectly (e.g., through a RIC) with the CU 2402. The on-chip memory 2412′ and the additional memory modules 2414 may each be considered a computer-readable medium/memory. Each computer-readable medium/memory may be non-transitory. The network processor(s) 2412 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 198 may be configured to receive a measurement configuration. The component 198 may be configured to receive a set of positioning signals (e.g., PRSs, SRSs). The component 198 may be configured to measure the set of positioning signals. The component 198 may be configured to reference the measured set of positioning signals based on the measurement configuration. The component 198 may be configured to output the referenced measured set of positioning signals to a positioning model. The component 198 may be configured to output the referenced measured set of positioning signals to a positioning model by transmitting the referenced measured set of positioning signals to a wireless device that includes the positioning model, by training the positioning model based on the referenced measured set of positioning signals and a set of labels, or by calculating a positioning output using the positioning model based on the referenced measured set of positioning signals. The component 198 may be within the network processor(s) 2412. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 2460 may include a variety of components configured for various functions. In one configuration, the network entity 2460 may include means for receiving a measurement configuration. The network entity 2460 may include means for receiving a set of positioning signals. The network entity 2460 may include means for measuring the set of positioning signals. The network entity 2460 may include means for referencing the measured set of positioning signals based on the measurement configuration. The network entity 2460 may include means for outputting the referenced measured set of positioning signals to a positioning model. The network entity 2460 may include means for outputting the referenced measured set of positioning signals to the positioning model by transmitting the referenced measured set of positioning signals to a wireless device that uses the positioning model. The network entity 2460 may include means for selecting a referencing method from a plurality of referencing methods based on the measured set of positioning signals. The measurement configuration may include an indicator of the plurality of referencing methods. The network entity 2460 may include means for transmitting a referencing indicator associated with the selected referencing method.

The referencing indicator may include at least one of (a) a referencing method ID associated with the selected referencing method, (b) a condition range ID associated with the selected referencing method, (c) an adaptation decision ID associated with the selected referencing method, (d) a positioning model ID associated with the selected referencing method, or (e) a positioning model input layer ID associated with the selected referencing method. The network entity 2460 may include means for outputting the referenced measured set of positioning signals to the positioning model by training the positioning model based on the referenced measured set of positioning signals and a set of labels. The network entity 2460 may include means for outputting the referenced measured set of positioning signals to the positioning model by calculating a positioning output using the positioning model based on the referenced measured set of positioning signals. The measurement configuration may include a referencing indicator. The network entity 2460 may include means for selecting the positioning model from a plurality of positioning models based on the referencing indicator. The network entity 2460 may include means for selecting at least one of (a) a condition range from a plurality of condition ranges for a reference point positioning signal of the measured set of positioning signals or (b) an adaptation decision from a plurality of adaptation decisions for the reference point positioning signal of the measured set of positioning signals based on the referencing indicator. The network entity 2460 may include means for referencing the measured set of positioning signals based on the measurement configuration by (a) selecting a reference point positioning signal from the measured set of positioning signals based on at least one of the selected condition range or the selected adaptation decision, and (b) referencing the measured set of positioning signals based on the selected reference point positioning signal. The network entity 2460 may include means for transmitting the calculated positioning output. The network entity 2460 may include means for referencing the measured set of positioning signals based on the measurement configuration by (a) selecting a reference point positioning signal from the measured set of positioning signals based on the measurement configuration, and (b) referencing the measured set of positioning signals based on the selected reference point positioning signal. The network entity 2460 may include means for selecting the reference point positioning signal from the measured set of positioning signals based on the measurement configuration by selecting the reference point positioning signal from the measured set of positioning signals in response to the reference point positioning signal satisfying a condition range. The network entity 2460 may include means for selecting the reference point positioning signal from the measured set of positioning signals based on the measurement configuration by selecting the reference point positioning signal from the measured set of positioning signals in response to the reference point positioning signal satisfying an adaptation decision. The network entity 2460 may include means for selecting the reference point positioning signal from the measured set of positioning signals based on the measurement configuration by selecting the reference point positioning signal from the measured set of positioning signals in response to the reference point positioning signal satisfying both the condition range and the adaptation decision. The condition range may include a first range of LOS probabilities. The measurement configuration may include a first indicator to select the first range of LOS probabilities. The condition range may include a second range of delay spread values. The measurement configuration may include a second indicator to select the second range of delay spread values. The condition range may include a third range of SINRs. The measurement configuration may include a third indicator to select the third range of SINRs. The condition range may include a fourth range of RSRPs. The measurement configuration may include a fourth indicator to select the fourth range of RSRPs. The condition range may include a fifth range of path timing measurements. The measurement configuration may include a fifth indicator to select the fifth range of path timing measurements. The adaptation decision may include a largest LOS probability. The measurement configuration may include a first indicator to select the largest LOS probability. The adaptation decision may include a smallest delay spread. The measurement configuration may include a second indicator to select the smallest delay spread. The adaptation decision may include a smallest peak width. The measurement configuration may include a third indicator to select the smallest peak width. The adaptation decision may include a largest calculated SINR. The measurement configuration may include a fourth indicator to select the largest SINR. The adaptation decision may include a largest RSRP. The measurement configuration may include a fifth indicator to select the largest RSRP. The adaptation decision may include an earliest arrival. The measurement configuration may include a sixth indicator to select the earliest arrival. The adaptation decision may include a largest power. The measurement configuration may include a seventh indicator to select the largest power. The adaptation decision may include a largest magnitude. The measurement configuration may include an eighth indicator to select the largest magnitude. The network entity 2460 may include means for selecting the reference point positioning signal from the measured set of positioning signals based on the measurement configuration by selecting the adaptation decision from a plurality of adaptation decisions in response to the reference point positioning signal satisfying the condition range. The measurement configuration may include an indicator of the plurality of adaptation decisions. The network entity 2460 may include means for transmitting an indicator of supported referencing attributes. The measurement configuration may be based on the supported referencing attributes. The supported referencing attributes may include at least one of (a) a timing reference type, (b) a power referencing type, or (c) a phase referencing type. The measurement configuration may include a plurality of sets of referencing attributes. The network entity 2460 may include means for referencing the measured set of positioning signals based on the measurement configuration by (a) selecting a set of referencing attributes from the plurality of sets of referencing attributes, (b) selecting a reference point positioning signal from the measured set of positioning signals based on the selected set of referencing attributes, and (c) referencing the measured set of positioning signals based on the selected reference point positioning signal. The set of positioning signals may include a set of PRSs or a set of SRSs. The network entity 2460 may include at least one of a UE, a base station, or a TRP. The network entity 2460 may include means for outputting the referenced measured set of positioning signals to the positioning model by transmitting the referenced measured set of positioning signals to a wireless device for the positioning model. The network entity 2460 may include means for selecting a referencing method from a plurality of referencing methods based on the measured set of positioning signals. The measurement configuration may include an indicator of the plurality of referencing methods. The network entity 2460 may include means for outputting the referenced measured set of positioning signals to the positioning model by transmitting a referencing indicator associated with the selected referencing method. The network entity 2460 may include means for transmitting an indicator of supported referencing attributes before the reception of the measurement configuration. The means may be the component 198 of the network entity 2460 configured to perform the functions recited by the means.

As discussed supra, the component 199 may be configured to configure a measurement configuration for a set of positioning signals and a set of positioning models at a wireless positioning device. The component 199 may be configured to transmit the measurement configuration. The component 199 may be configured to receive a calculated position of a wireless device, or an intermediary measurement that may be used to calculate a position of the wireless device, based on measurements of the set of positioning signals that are referenced based on the measurement configuration. The component 199 may be configured to receive a set of positioning signal measurements that are referenced based on the measurement configuration. The component 199 may be within the network processor(s) 2412. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 2460 may include a variety of components configured for various functions. In one configuration, the network entity 2460 may include means for configuring a measurement configuration for a set of positioning signals and a set of positioning models at a wireless positioning device. The network entity 2460 may include means for transmitting the measurement configuration. The network entity 2460 may include means for receiving a set of positioning signal measurements referenced based on the measurement configuration. The network entity 2460 may include means for receiving a referencing indicator associated with the set of positioning signal measurements. The network entity 2460 may include means for calculating a positioning output using a positioning model based on the received set of positioning signal measurements and the referencing indicator. The set of positioning models may include the positioning model. The referencing indicator may include at least one of (a) a method ID associated with the set of positioning signal measurements, (b) a condition range ID associated with the set of positioning signal measurements, (c) an adaptation decision ID associated with the set of positioning signal measurements, (d) a positioning model ID associated with the set of positioning signal measurements, or (e) a positioning model input layer ID associated with the set of positioning signal measurements. The measurement configuration may include a referencing indicator of a plurality of referencing methods associated with the set of positioning signals and the set of positioning models. The referencing indicator may include at least one of (a) a method ID, (b) a condition range ID, (c) an adaptation decision ID, (d) a positioning model ID, or (e) a positioning model input layer ID. The measurement configuration may include a referencing indicator. The referencing indicator may include at least one of (a) a method ID, (b) a condition range ID, (c) an adaptation decision ID, (d) a positioning model ID, or (e) a positioning model input layer ID. The measurement configuration may include at least one of (a) a first indicator to select a first range of line-of-sight (LOS) probabilities, (b) a second indicator to select a second range of delay spread values, (c) a third indicator to select a third range of SINRs, (d) a fourth indicator to select a fourth range of reference RSRPs, (e) a fifth indicator to select a fifth range of path timing measurements, (f) a sixth indicator to select a largest LOS probability, (g) a seventh indicator to select a smallest delay spread, (h) an eighth indicator to select a smallest peak width, (i) a ninth indicator to select a largest SINR, (j) a tenth indicator to select a largest RSRP, (k) an eleventh indicator to select an earliest arrival, (l) a twelfth indicator to select a largest power, or (m) a thirteenth indicator to select a largest magnitude. The network entity 2460 may include means for receiving an indicator of supported referencing attributes. The network entity 2460 may include means for configuring the measurement configuration for the set of positioning signals and the set of positioning models at the wireless positioning device by (a) selecting a set of referencing attributes from the supported referencing attributes, and (b) configuring the measurement configuration based on the selected set of referencing attributes. The supported referencing attributes may include at least one of (a) a timing reference type, (b) a power referencing type, or (c) a phase referencing type. The set of positioning signals may include a set of PRSs or a set of SRSs. The network entity 2460 may include a location management function (LMF). The means may be the component 199 of the network entity 2460 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, may send the data to a component of the device that transmits the data, or may send the data to a component of the device. A device configured to “obtain” data, such as a transmission, signal, or message, may receive, for example with a transceiver, may obtain the data from a component of the device that receives the data, or may obtain the data from a component of the device. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is a method of wireless communication at a wireless positioning device, comprising: receiving a measurement configuration; receiving a set of positioning signals; measuring the set of positioning signals; referencing the measured set of positioning signals based on the measurement configuration; and outputting the referenced measured set of positioning signals to a positioning model.
Aspect 2 is the method of aspect 1, wherein outputting the referenced measured set of positioning signals to the positioning model comprises transmitting the referenced measured set of positioning signals to a wireless device for the positioning model.
Aspect 3 is the method of aspect 2, further comprising: selecting a referencing method from a plurality of referencing methods based on the measured set of positioning signals, wherein the measurement configuration comprises an indicator of the plurality of referencing methods, wherein outputting the referenced measured set of positioning signals to the positioning model comprises transmitting a referencing indicator associated with the selected referencing method.
Aspect 4 is the method of aspect 3, wherein the referencing indicator comprises at least one of: a referencing method identifier (ID) associated with the selected referencing method; a condition range ID associated with the selected referencing method; an adaptation decision ID associated with the selected referencing method; a positioning model ID associated with the selected referencing method; or a positioning model input layer ID associated with the selected referencing method.
Aspect 5 is the method of any of aspects 1 to 4, wherein outputting the referenced measured set of positioning signals to the positioning model comprises at least one of: training the positioning model based on the referenced measured set of positioning signals and a set of labels; or calculating a positioning output using the positioning model based on the referenced measured set of positioning signals.
Aspect 6 is the method of aspect 5, wherein the measurement configuration comprises a referencing indicator, further comprising selecting the positioning model from a plurality of positioning models based on the referencing indicator.
Aspect 7 is the method of either of aspects 5 or 6, wherein the measurement configuration comprises a referencing indicator, further comprising: selecting at least one of (a) a condition range from a plurality of condition ranges for a reference point positioning signal of the measured set of positioning signals or (b) an adaptation decision from a plurality of adaptation decisions for the reference point positioning signal of the measured set of positioning signals based on the referencing indicator, wherein referencing the measured set of positioning signals based on the measurement configuration comprises: selecting a reference point positioning signal from the measured set of positioning signals based on at least one of the selected condition range or the selected adaptation decision; and referencing the measured set of positioning signals based on the selected reference point positioning signal.
Aspect 8 is the method of any of aspects 5 to 7, further comprising transmitting the calculated positioning output.
Aspect 9 is the method of any of aspects 1 to 8, wherein referencing the measured set of positioning signals based on the measurement configuration comprises: selecting a reference point positioning signal from the measured set of positioning signals based on the measurement configuration; and referencing the measured set of positioning signals based on the selected reference point positioning signal.
Aspect 10 is the method of aspect 9, wherein selecting the reference point positioning signal from the measured set of positioning signals based on the measurement configuration comprises at least one of: selecting the reference point positioning signal from the measured set of positioning signals in response to the reference point positioning signal satisfying a condition range; selecting the reference point positioning signal from the measured set of positioning signals in response to the reference point positioning signal satisfying an adaptation decision; or selecting the reference point positioning signal from the measured set of positioning signals in response to the reference point positioning signal satisfying both the condition range and the adaptation decision.
Aspect 11 is the method of aspect 10, wherein the condition range comprises at least one of: a first range of line-of-sight (LOS) probabilities, wherein the measurement configuration comprises a first indicator to select the first range of LOS probabilities; a second range of delay spread values, wherein the measurement configuration comprises a second indicator to select the second range of delay spread values; a third range of signal-to-interference plus noise ratios (SINRs), wherein the measurement configuration comprises a third indicator to select the third range of SINRs; a fourth range of reference signal received powers (RSRPs), wherein the measurement configuration comprises a fourth indicator to select the fourth range of RSRPs; or a fifth range of path timing measurements, wherein the measurement configuration comprises a fifth indicator to select the fifth range of path timing measurements.
Aspect 12 is the method of either of aspects 10 or 11, wherein the adaptation decision comprises at least one of: a largest line-of-sight (LOS) probability, wherein the measurement configuration comprises a first indicator to select the largest LOS probability; a smallest delay spread, wherein the measurement configuration comprises a second indicator to select the smallest delay spread; a smallest peak width, wherein the measurement configuration comprises a third indicator to select the smallest peak width; a largest calculated signal-to-interference plus noise ratio (SINR), wherein the measurement configuration comprises a fourth indicator to select the largest SINR; a largest reference signal received power (RSRP), wherein the measurement configuration comprises a fifth indicator to select the largest RSRP; an earliest arrival, wherein the measurement configuration comprises a sixth indicator to select the earliest arrival; a largest power, wherein the measurement configuration comprises a seventh indicator to select the largest power; or a largest magnitude, wherein the measurement configuration comprises an eighth indicator to select the largest magnitude.
Aspect 13 is the method of any of aspects 10 to 12, wherein selecting the reference point positioning signal from the measured set of positioning signals based on the measurement configuration further comprises: selecting the adaptation decision from a plurality of adaptation decisions in response to the reference point positioning signal satisfying the condition range, wherein the measurement configuration comprises an indicator of the plurality of adaptation decisions.
Aspect 14 is the method of any of aspects 1 to 13, further comprising transmitting an indicator of supported referencing attributes before the reception of the measurement configuration.
Aspect 15 is the method of aspect 14, wherein the supported referencing attributes comprise at least one of a timing reference type, a power referencing type, or a phase referencing type.
Aspect 16 is the method of any of aspects 1 to 15, wherein the measurement configuration comprises a plurality of sets of referencing attributes, wherein referencing the measured set of positioning signals based on the measurement configuration comprises: selecting a set of referencing attributes from the plurality of sets of referencing attributes; selecting a reference point positioning signal from the measured set of positioning signals based on the selected set of referencing attributes; and referencing the measured set of positioning signals based on the selected reference point positioning signal.
Aspect 17 is the method of any of aspects 1 to 16, wherein the set of positioning signals comprises a set of positioning reference signals (PRSs) or a set of sounding reference signals (SRSs).
Aspect 18 is the method of any of aspects 1 to 17, wherein the wireless positioning device comprises at least one of a user equipment (UE), a base station, or a transmission reception point (TRP).
Aspect 19 is a method of wireless communication at a network entity, comprising: configuring a measurement configuration for a set of positioning signals and a set of positioning models at a wireless positioning device; and transmitting the measurement configuration.
Aspect 20 is the method of aspect 19, further comprising receiving a set of positioning signal measurements referenced based on the measurement configuration.
Aspect 21 is the method of aspect 20, further comprising: receiving a referencing indicator associated with the set of positioning signal measurements; and calculating a positioning output using a positioning model based on the received set of positioning signal measurements and the referencing indicator, wherein the set of positioning models comprises the positioning model.
Aspect 22 is the method of aspect 21, wherein the referencing indicator comprises at least one of: a method identifier (ID) associated with the set of positioning signal measurements; a condition range ID associated with the set of positioning signal measurements; an adaptation decision ID associated with the set of positioning signal measurements; a positioning model ID associated with the set of positioning signal measurements; or a positioning model input layer ID associated with the set of positioning signal measurements.
Aspect 23 is the method of any of aspects 19 to 22, wherein the measurement configuration comprises a referencing indicator of a plurality of referencing methods associated with the set of positioning signals and the set of positioning models.
Aspect 24 is the method of aspect 23, wherein the referencing indicator comprises at least one of: a method identifier (ID); a condition range ID; an adaptation decision ID; a positioning model ID; or a positioning model input layer ID.
Aspect 25 is the method of any of aspects 19 to 24, wherein the measurement configuration comprises a referencing indicator, wherein the referencing indicator comprises at least one of: a method identifier (ID); a condition range ID; an adaptation decision ID; a positioning model ID; or a positioning model input layer ID.
Aspect 26 is the method of any of aspects 19 to 25, wherein the measurement configuration comprises at least one of: a first indicator to select a first range of line-of-sight (LOS) probabilities; a second indicator to select a second range of delay spread values; a third indicator to select a third range of signal-to-interference plus noise ratios (SINRs); a fourth indicator to select a fourth range of reference signal received powers (RSRPs); a fifth indicator to select a fifth range of path timing measurements; a sixth indicator to select a largest LOS probability; a seventh indicator to select a smallest delay spread; an eighth indicator to select a smallest peak width; a ninth indicator to select a largest SINR; a tenth indicator to select a largest RSRP; an eleventh indicator to select an earliest arrival; a twelfth indicator to select a largest power; or a thirteenth indicator to select a largest magnitude.
Aspect 27 is the method of any of aspects 19 to 26, further comprising: receiving an indicator of supported referencing attributes, wherein configuring the measurement configuration for the set of positioning signals and the set of positioning models at the wireless positioning device comprises: selecting a set of referencing attributes from the supported referencing attributes; and configuring the measurement configuration based on the selected set of referencing attributes.
Aspect 28 is the method of aspect 27, wherein the supported referencing attributes comprise at least one of a timing reference type, a power referencing type, or a phase referencing type.
Aspect 29 is the method of any of aspects 19 to 28, wherein the set of positioning signals comprises a set of positioning reference signals (PRSs) or a set of sounding reference signals (SRSs).
Aspect 30 is the method of any of aspects 19 to 29, wherein the network entity comprises a location management function (LMF).
Aspect 31 is the method of aspect 20, further comprising: receiving a referencing indicator associated with the set of positioning signal measurements; and training a positioning model based on the received set of positioning signal measurements and the referencing indicator, wherein the set of positioning models comprises the positioning model.
Aspect 32 is an apparatus for wireless communication, comprising: at least one memory; and at least one processor coupled to the at least one memory and, based at least in part on information stored in the at least one memory, the at least one processor, individually or in any combination, is configured to perform the method of any of aspects 1 to 31.
Aspect 33 is an apparatus for wireless communication, comprising means for performing each step in the method of any of aspects 1 to 31.
Aspect 34 is the apparatus of any of aspects 1 to 31, further comprising a transceiver configured to receive or to transmit in association with the method of any of aspects 1 to 31.
Aspect 35 is a computer-readable medium (e.g., a non-transitory computer-readable medium) storing computer executable code, the code when executed by at least one processor causes the at least one processor, individually or in any combination, to perform the method of any of aspects 1 to 31.

What is claimed is:

1. An apparatus for wireless communication at a wireless positioning device, comprising:
at least one memory; and
at least one processor coupled to the at least one memory and, based at least in part on information stored in the at least one memory, the at least one processor, individually or in any combination, is configured to:
receive a measurement configuration;
receive a set of positioning signals;
measure the set of positioning signals;
reference the measured set of positioning signals based on the measurement configuration; and
output the referenced measured set of positioning signals to a positioning model.

2. The apparatus of claim 1, wherein, to output the referenced measured set of positioning signals to the positioning model, the at least one processor, individually or in any combination, is configured to:
transmit the referenced measured set of positioning signals to a wireless device for the positioning model.

3. The apparatus of claim 2, wherein the at least one processor, individually or in any combination, is further configured to:
select a referencing method from a plurality of referencing methods based on the measured set of positioning signals, wherein the measurement configuration comprises an indicator of the plurality of referencing methods, wherein, to output the referenced measured set of positioning signals to the positioning model, the at least one processor, individually or in any combination, is configured to:
transmit a referencing indicator associated with the selected referencing method.

4. The apparatus of claim 3, wherein the referencing indicator comprises at least one of:
a referencing method identifier (ID) associated with the selected referencing method;
a condition range ID associated with the selected referencing method;
an adaptation decision ID associated with the selected referencing method;
a positioning model ID associated with the selected referencing method; or
a positioning model input layer ID associated with the selected referencing method.

5. The apparatus of claim 1, wherein, to output the referenced measured set of positioning signals to the positioning model, the at least one processor, individually or in any combination, is configured to:
train the positioning model based on the referenced measured set of positioning signals and a set of labels; or
calculate a positioning output using the positioning model based on the referenced measured set of positioning signals.

6. The apparatus of claim 5, wherein the measurement configuration comprises a referencing indicator, wherein the at least one processor, individually or in any combination, is further configured to:
select the positioning model from a plurality of positioning models based on the referencing indicator.

7. The apparatus of claim 5, wherein the measurement configuration comprises a referencing indicator, wherein the at least one processor, individually or in any combination, is further configured to:
select at least one of (a) a condition range from a plurality of condition ranges for a reference point positioning signal of the measured set of positioning signals or (b) an adaptation decision from a plurality of adaptation decisions for the reference point positioning signal of the measured set of positioning signals based on the referencing indicator, wherein, to reference the measured set of positioning signals based on the measurement configuration, the at least one processor, individually or in any combination, is configured to:
select a reference point positioning signal from the measured set of positioning signals based on at least one of the selected condition range or the selected adaptation decision; and
reference the measured set of positioning signals based on the selected reference point positioning signal.

8. The apparatus of claim 5, further comprising a transceiver coupled to the at least one processor, wherein the at least one processor, individually or in any combination, is further configured to:
transmit, via the transceiver, the calculated positioning output.

9. The apparatus of claim 1, wherein, to reference the measured set of positioning signals based on the measurement configuration, the at least one processor, individually or in any combination, is configured to:
select a reference point positioning signal from the measured set of positioning signals based on the measurement configuration; and
reference the measured set of positioning signals based on the selected reference point positioning signal.

10. The apparatus of claim 9, wherein, to select the reference point positioning signal from the measured set of positioning signals based on the measurement configuration, the at least one processor, individually or in any combination, is configured to:
select the reference point positioning signal from the measured set of positioning signals in response to the reference point positioning signal satisfying a condition range;
select the reference point positioning signal from the measured set of positioning signals in response to the reference point positioning signal satisfying an adaptation decision; or
select the reference point positioning signal from the measured set of positioning signals in response to the reference point positioning signal satisfying both the condition range and the adaptation decision.

11. The apparatus of claim 10, wherein the condition range comprises at least one of:
a first range of line-of-sight (LOS) probabilities, wherein the measurement configuration comprises a first indicator to select the first range of LOS probabilities;
a second range of delay spread values, wherein the measurement configuration comprises a second indicator to select the second range of delay spread values;
a third range of signal-to-interference plus noise ratios (SINRs), wherein the measurement configuration comprises a third indicator to select the third range of SINRs;
a fourth range of reference signal received powers (RSRPs), wherein the measurement configuration comprises a fourth indicator to select the fourth range of RSRPs; or
a fifth range of path timing measurements, wherein the measurement configuration comprises a fifth indicator to select the fifth range of path timing measurements.

12. The apparatus of claim 10, wherein the adaptation decision comprises at least one of:
a largest line-of-sight (LOS) probability, wherein the measurement configuration comprises a first indicator to select the largest LOS probability;
a smallest delay spread, wherein the measurement configuration comprises a second indicator to select the smallest delay spread;
a smallest peak width, wherein the measurement configuration comprises a third indicator to select the smallest peak width;
a largest calculated signal-to-interference plus noise ratio (SINR), wherein the measurement configuration comprises a fourth indicator to select the largest SINR;
a largest reference signal received power (RSRP), wherein the measurement configuration comprises a fifth indicator to select the largest RSRP;
an earliest arrival, wherein the measurement configuration comprises a sixth indicator to select the earliest arrival;
a largest power, wherein the measurement configuration comprises a seventh indicator to select the largest power; or
a largest magnitude, wherein the measurement configuration comprises an eighth indicator to select the largest magnitude.

13. The apparatus of claim 10, wherein, to select the reference point positioning signal from the measured set of positioning signals based on the measurement configuration, the at least one processor, individually or in any combination, is further configured to:
select the adaptation decision from a plurality of adaptation decisions in response to the reference point positioning signal satisfying the condition range, wherein the measurement configuration comprises an indicator of the plurality of adaptation decisions.

14. The apparatus of claim 1, wherein the at least one processor, individually or in any combination, is further configured to:
transmit an indicator of supported referencing attributes before the reception of the measurement configuration.

15. The apparatus of claim 14, wherein the supported referencing attributes comprise at least one of a timing reference type, a power referencing type, or a phase referencing type.

16. The apparatus of claim 1, wherein the measurement configuration comprises a plurality of sets of referencing attributes, wherein, to reference the measured set of positioning signals based on the measurement configuration, the at least one processor, individually or in any combination, is configured to:
select a set of referencing attributes from the plurality of sets of referencing attributes;
select a reference point positioning signal from the measured set of positioning signals based on the selected set of referencing attributes; and
reference the measured set of positioning signals based on the selected reference point positioning signal.

17. The apparatus of claim 1, wherein the set of positioning signals comprises a set of positioning reference signals (PRSs) or a set of sounding reference signals (SRSs).

18. The apparatus of claim 1, wherein the wireless positioning device comprises at least one of a user equipment (UE), a base station, or a transmission reception point (TRP).

19. An apparatus for wireless communication at a network entity, comprising:
at least one memory; and
at least one processor coupled to the at least one memory and, based at least in part on information stored in the at least one memory, the at least one processor, individually or in any combination, is configured to:
configure a measurement configuration for a set of positioning signals and a set of positioning models at a wireless positioning device; and
transmit the measurement configuration.

20. The apparatus of claim 19, wherein the at least one processor, individually or in any combination, is further configured to:
receive a set of positioning signal measurements referenced based on the measurement configuration.

21. The apparatus of claim 20, further comprising a transceiver coupled to the at least one processor, wherein the at least one processor, individually or in any combination, is further configured to:
receive, via the transceiver, a referencing indicator associated with the set of positioning signal measurements; and
calculate a positioning output using a positioning model based on the received set of positioning signal measurements and the referencing indicator, wherein the set of positioning models comprises the positioning model.

22. The apparatus of claim 21, wherein the referencing indicator comprises at least one of:
a referencing method identifier (ID) associated with the set of positioning signal measurements;
a condition range ID associated with the set of positioning signal measurements;
an adaptation decision ID associated with the set of positioning signal measurements;
a positioning model ID associated with the set of positioning signal measurements; or
a positioning model input layer ID associated with the set of positioning signal measurements.

23. The apparatus of claim 20, wherein the at least one processor, individually or in any combination, is further configured to:
receive a referencing indicator associated with the set of positioning signal measurements; and
train a positioning model based on the received set of positioning signal measurements and the referencing indicator, wherein the set of positioning models comprises the positioning model.

24. The apparatus of claim 19, wherein the measurement configuration comprises a referencing indicator of a plurality of referencing methods associated with the set of positioning signals and the set of positioning models.

25. The apparatus of claim 24, wherein the referencing indicator comprises at least one of:
a referencing method identifier (ID);
a condition range ID;
an adaptation decision ID;
a positioning model ID; or
a positioning model input layer ID.

26. The apparatus of claim 19, wherein the measurement configuration comprises a referencing indicator, wherein the referencing indicator comprises at least one of:
a referencing method identifier (ID);
a condition range ID;
an adaptation decision ID;
a positioning model ID; or
a positioning model input layer ID.

27. The apparatus of claim 19, wherein the measurement configuration comprises at least one of:
a first indicator to select a first range of line-of-sight (LOS) probabilities;
a second indicator to select a second range of delay spread values;
a third indicator to select a third range of signal-to-interference plus noise ratios (SINRs);
a fourth indicator to select a fourth range of reference signal received powers (RSRPs);
a fifth indicator to select a fifth range of path timing measurements;
a sixth indicator to select a largest LOS probability;
a seventh indicator to select a smallest delay spread;
an eighth indicator to select a smallest peak width;
a ninth indicator to select a largest SINR;
a tenth indicator to select a largest RSRP;
an eleventh indicator to select an earliest arrival;
a twelfth indicator to select a largest power; or
a thirteenth indicator to select a largest magnitude.

28. The apparatus of claim 19, wherein the at least one processor, individually or in any combination, is further configured to:
receive an indicator of supported referencing attributes, wherein, to configure the measurement configuration for the set of positioning signals and the set of positioning models at the wireless positioning device, the at least one processor, individually or in any combination, is configured to:
select a set of referencing attributes from the supported referencing attributes, wherein the supported referencing attributes comprise at least one of a timing reference type, a power referencing type, or a phase referencing type; and
configure the measurement configuration based on the selected set of referencing attributes.

29. A method of wireless communication at a wireless positioning device, comprising:
receiving a measurement configuration;
receiving a set of positioning signals;
measuring the set of positioning signals;
referencing the measured set of positioning signals based on the measurement configuration; and
outputting the referenced measured set of positioning signals to a positioning model.

30. A method of wireless communication at a network entity, comprising:
configuring a measurement configuration for a set of positioning signals and a set of positioning models at a wireless positioning device; and
transmitting the measurement configuration.
